(19) United States
(12) Patent Application Publication
(10) Pub. No.: US 2026/0224044 A1
(43) Pub. Date: Aug. 6, 2026

(54) INFANT CARRIER

(71) Applicant: Wonderland Switzerland AG, Steinhausen (CH)

(72) Inventors: Ruyi LI, Dongguan, Guangdong (CN); Zujian LIU, Dongguan, Guangdong (CN); Xiaolong MO, Dongguan, Guangdong (CN); Huan NING, Dongguan, Guangdong (CN)

(73) Assignee: Wonderland Switzerland AG, Steinhausen (CH)

(21) Appl. No.: 19/148,561

(22) PCT Filed: Jan. 18, 2024
(86) PCT No.: PCT/EP2024/051126

§ 371 Date: Jul. 16, 2025

(30) Foreign Application Priority Data
Jan. 18, 2023 (CN) 202310076947.X
Mar. 13, 2023 (CN) 202310240677.1
Jul. 21, 2023 (CN) 202310909956.2

(51) Int. Cl. A47D 13/02; B62B 7/10; B62B 9/08; B62B 9/20

(52) U.S. Cl. CPC A47D 13/02; B62B 7/105; B62B 9/087; B62B 9/20; B62B 2205/003; B62B 2205/24

(57) ABSTRACT

The present disclosure relates to an infant carrier, including a seat assembly, a frame, and a switching mechanism. The frame has an unfolded state and a folded state. The frame is attached to the seat assembly. The switching mechanism is arranged between the seat assembly and the frame and enables the frame to switch between the unfolded state and the folded state. When the frame is in the unfolded state, the infant carrier is suitable for use as a baby stroller, and when the frame is in the folded state, the infant carrier is suitable for use as a safety seat, a carry cot, or a baby rocker.

### CROSS REFERENCE TO RELATED APPLICATIONS

This application is a national phase under 35 U.S.C. § 371 of PCT International Application No. PCT/EP2024/051126, which has an international filing date of Jan. 18, 2024 and claims priority to Chinese Patent Application No. 202310076947.X filed with the China National Intellectual Property Administration on Jan. 18, 2023, Chinese Patent Application No. 202310240677.1 filed with the China National Intellectual Property Administration on Mar. 13, 2023, and Chinese Patent Application No. 202310909956.2 filed with the China National Intellectual Property Administration on Jul. 21, 2023. The entire contents of the above identified PCT international application and Chinese patent applications are incorporated herein by reference for all purposes.

### TECHNICAL FIELD

The present disclosure relates generally to the technical field of carrying devices for infants, and more particularly, to an infant carrier.

### BACKGROUND

Infants generally have a need for both a stroller and a safety seat when traveling, but carrying such two devices at the same time increases inconvenience of the traveling. Although some baby strollers that may be converted into safety seats are currently available on the market, problems of complex structures and inconvenient use often exist.

### SUMMARY

In a first aspect of the present disclosure, an infant carrier is provided. The infant carrier includes a seat assembly, a frame, and a switching mechanism. The frame has an unfolded state and a folded state. The frame is attached to the seat assembly. The switching mechanism is arranged between the seat assembly and the frame and enables the frame to switch between the unfolded state and the folded state. When the frame is in the unfolded state, the infant carrier is suitable for use as a baby stroller, and when the frame is in the folded state, the infant carrier is suitable for use as a safety seat, a carry cot, or a baby rocker.

In the first aspect, the switching mechanism includes: a linkage assembly connected between the frame and the seat assembly; and a locking assembly operable to switch between a locked state and an unlocked state, when the locking assembly is in the locked state, the frame being locked in the unfolded state, and when the locking assembly is in the unlocked state, the frame being linked to switch from the unfolded state to the folded state through the linkage assembly.

In the first aspect, the frame includes a first support frame and a second support frame pivotally connected to each other, and the switching mechanism includes a linkage assembly, the linkage assembly including a first linkage rod and a second linkage rod, two ends of the first linkage rod being pivotally connected to the first support frame and the seat assembly respectively, and two ends of the second linkage rod being pivotally connected to the second support frame and the seat assembly respectively.

In the first aspect, the switching mechanism includes a locking assembly, the locking assembly including: a first locking member movably connected to one of the seat assembly and the frame and configured to lock the frame in the unfolded state; and a fold button connected to the other of the seat assembly and the frame and operable to drive the first locking member to unlock the frame.

In the first aspect, the frame includes: a first support frame including two first support rods; and a second support frame including two second support rods. The two first support rods are pivotally connected to the two second support rods respectively, each of the first support rods is pivotally connected to each of the second support rods at a first pivot point, the first pivot point being slidably connected to the seat assembly, and the fold button is attached to the first pivot point.

In the first aspect, the locking assembly further includes a holder, the holder being fastened to the seat assembly, the holder having a second accommodating cavity and an open groove in communication with the second accommodating cavity, the first locking member has a locking protrusion, the first locking member is at least partially movably arranged in the second accommodating cavity, and the locking protrusion is capable of extending out of the second accommodating cavity through the open groove to be engaged and locked with the fold button to lock the frame in the unfolded state.

In the first aspect, the first locking member is pivotally connected to the holder at a second pivot point, the second pivot point being located in the second accommodating cavity.

In the first aspect, the first locking member further includes an elastic arm, the locking protrusion and the elastic arm are located on two sides of the second pivot point respectively, and the elastic arm constantly causes the locking protrusion to pivot in a direction of extension out of the open groove.

In the first aspect, the fold button includes: a connecting portion fixedly connected to the frame and slidably connected to the seat assembly; and an operating portion operable to unlock the first locking member from the frame.

In the first aspect, the fold button further includes: a locking recess, the locking recess being located between the connecting portion and the operating portion. The first locking member has a locking protrusion, the locking protrusion being capable of being engaged and locked with the locking recess to lock the frame in the unfolded state, and the locking protrusion being capable of being disengaged from the locking recess to unlock the frame from the unfolded state.

In the first aspect, a side of the operating portion facing the first locking member is provided with a push protrusion, and when the operating portion is pressed, the push protrusion is capable of pushing against the first locking member to cause the first locking member to unlock the frame.

In the first aspect, the frame includes: a first support frame including two first support rods; and a second support frame including two second support rods. The two first support rods are pivotally connected to the two second support rods respectively.

In the first aspect, the first support frame and the second support frame are both made of aluminum tubing.

In the first aspect, the infant carrier further includes: a wheel body, the wheel body being rotatably attached to the first support frame and the second support frame respectively. Each of the first support rods is pivotally connected to each of the second support rods at a first pivot point, and when the frame is in the folded state, a line connecting a center of the wheel body and the first pivot point is parallel to a horizontal reference plane, the horizontal reference plane being an imaginary horizontal section at the bottom of the seat assembly.

In the first aspect, each of the first support rods is pivotally connected to each of the second support rods at a first pivot point, the first pivot point being slidably connected to the seat assembly.

In the first aspect, a sliding path of the first pivot point is inclined upwards in a direction from front to back.

In the first aspect, each of the first support rods is pivotally connected to each of the second support rods at a first pivot point, when the frame is in the unfolded state, the first pivot point is at a first position of the seat assembly, and when the frame is in the folded state, the first pivot point is at a second position of the seat assembly.

In the first aspect, the first position is closer to a horizontal reference plane than the second position, the horizontal reference plane being an imaginary horizontal section at the bottom of the seat assembly.

In the first aspect, the first position is closer to a vertical reference plane than the second position, the vertical reference plane being an imaginary vertical section at the front of the seat assembly.

In the first aspect, the infant carrier further includes: wheel bodies, the wheel bodies being rotatably attached to the first support frame and the second support frame respectively; and when the frame is in the folded state, the wheel body attached to the first support frame and the wheel body attached to the second support frame overlapping with each other.

In the first aspect, each of the first support rods is pivotally connected to each of the second support rods at a first pivot point, the infant carrier further includes a movable assembly, the movable assembly being mounted on the seat assembly, and one end of the movable assembly is pivotally connected to the seat assembly at a third pivot point, the third pivot point being spaced apart from the first pivot point.

In the first aspect, the seat assembly has a fold limiting part, and when the frame is in the folded state, the fold limiting part is engaged with the frame to lock the frame in the folded state.

In the first aspect, the infant carrier further includes a movable assembly, the movable assembly being mounted on the seat assembly, when the frame is in the unfolded state, the movable assembly serving as a handlebar, and when the frame is in the folded state, the movable assembly serving as a carrying handle.

In the first aspect, the movable assembly has a roughly U-shaped structure, and includes a movable body and a movable rod connected to two ends of the movable body.

In the first aspect, a length of the movable rod is adjustable.

In the first aspect, the movable rod includes a first rod part, a second rod part, and a length adjustment mechanism, the first rod part being partially inserted into the second rod part, the length adjustment mechanism being arranged between the first rod part and the second rod part, and a length of the first rod part inserted into the second rod part is adjustable through the length adjustment mechanism.

In the first aspect, the length adjustment mechanism includes: a locking pin movably arranged on one of the first rod part and the second rod part; and a plurality of locking holes arranged in the other of the first rod part and the second rod part and arranged along a length direction of the other of the first rod part and the second rod part. The locking pin has a first lock position and a first unlock position, the locking pin, when located at the first lock position, is capable of being inserted into and engaged with one of the plurality of locking holes, and the locking pin, when located at the first unlock position, is capable of being disengaged from the one of the plurality of locking holes.

In the first aspect, the length adjustment mechanism further includes: an operating assembly arranged on the other of the first rod part and the second rod part, the operating assembly being operable to drive the locking pin to move in a direction of disengagement from the one of the plurality of locking holes.

In the first aspect, the operating assembly and at least part of the locking pin are both arranged in the first rod part, and the operating assembly includes: a pull rod; a length adjustment operating member arranged at one end of the pull rod; and a driving plug fastened to an end of the pull rod away from the length adjustment operating member, the driving plug having a driving chute. The locking pin is provided with a driving post, the driving post being inserted into the driving chute and movable along the driving chute, and the length adjustment operating member is operable to move along a length direction of the first rod part, so that the driving pin moves from the first lock position to the first unlock position under the action of the driving post and the driving chute.

In the first aspect, the length adjustment mechanism further includes: a fixed plug fixed in the first rod part and having a first through hole and a second through hole that are in communication with each other and have intersecting extension directions. The locking pin is movably arranged in the first through hole, and the driving post passes through the second through hole and is inserted into the driving chute.

In the first aspect, the fixed plug is further provided with a first sliding groove, the first sliding groove being in communication with the first through hole and the second through hole, whose extension directions intersect with each other, and a part of the driving plug provided with the driving chute is inserted into the first sliding groove and is slidable relative to the driving plug along the first rod part.

In the first aspect, the length adjustment mechanism further includes a first reset member, the first reset member constantly causing the driving plug to move in a direction where the locking pin is driven to move to the first lock position.

In the first aspect, the infant carrier further includes an angle adjustment mechanism, the angle adjustment mechanism being arranged between the seat assembly and the movable assembly, and the angle adjustment mechanism being configured to adjust an inclination angle of the movable assembly relative to the seat assembly.

In the first aspect, the angle adjustment mechanism includes: a movable connecting base fixedly connected to the movable assembly and having a first locking part; a seat connecting base fixedly connected to the seat assembly and having a second locking part; and a third locking part movably arranged between the movable connecting base and the seat connecting base, and the third locking part having a second lock position and a second unlock position. The movable connecting base and the seat connecting base are pivotally connected to each other, when the third locking part is at the second lock position, the third locking part is locked and engaged with both the first locking part and the second locking part, so that the movable connecting base and the seat connecting base are fixed relative to each other; and when the third locking part is at the second unlock position, the third locking part is disengaged from one of the first locking part and the second locking part, so that the movable connecting base is rotatable relative to the seat connecting base.

In the first aspect, the third locking part is a locking gear, and both the first locking part and the second locking part are gear grooves capable of being engaged with the locking gear.

In the first aspect, the angle adjustment mechanism further includes an angle adjustment operating member, the angle adjustment operating member being drivingly connected to the third locking part, and the angle adjustment operating member being operable to drive the third locking part to move towards the second unlock position.

In the first aspect, the angle adjustment mechanism further includes a second reset member, two ends of the second reset member abutting against the third locking part and the seat connecting base respectively, and the second rest member constantly causing the angle adjustment operating member to move in a direction where the third locking part is driven to move towards the second lock position.

In the first aspect, the infant carrier further includes: a wheel assembly including a wheel mounting frame and a wheel body, the wheel mounting frame being connected to the frame, and the wheel body being rotatably mounted on the wheel mounting frame; and a braking mechanism arranged between the frame and the wheel assembly and having a braking state where rotation of the wheel assembly is prevented and an unbraking state where rotation of the wheel assembly is allowed.

In the first aspect, the braking mechanism includes: a brake rod movably arranged on the frame and having a third lock position and a third unlock position; The wheel body is circumferentially provided with a plurality of first brake holes, when the brake rod is at the third lock position, the brake rod is capable of being inserted into and engaged with one of the plurality of first brake holes, and when the brake rod is at the third unlock position, the brake rod is disengaged from the one of the plurality of first brake holes.

In the first aspect, the braking mechanism further includes: a brake operating member movably arranged on the frame; and a brake pushing member movably arranged on the frame and fixedly connected to the brake rod. The brake operating member is operable to drive the brake pushing member to drive the brake rod to move to the third unlock position.

In the first aspect, the frame includes a first connecting assembly, the first connecting assembly being connected to the wheel mounting frame, the brake operating member being rotatably arranged on the first connecting assembly, and the brake pushing member is movably arranged on the first connecting assembly.

In the first aspect, the brake operating member is provided with a first engaging portion, the brake pushing member is provided with a second engaging portion and a third engaging portion, the brake operating member has a first rotate position and a second rotate position, when the brake operating member rotates to the first rotate position, the first engaging portion is engaged with the second engaging portion, and the brake pushing member moves to position the brake rod at the third lock position, and when the brake operating member rotates to the second rotate position, the first engaging portion is engaged with the third engaging portion, and the brake pushing member moves to position the brake rod at the third unlock position.

In the first aspect, the brake operating member is provided with a pushing rib, the brake pushing member is provided with a positioning groove and a braking groove, a base of the braking groove is away from the wheel body relative to a base of the positioning groove, the brake operating member has a first rotate position and a second rotate position, when the brake operating member rotates to the first rotate position, the pushing rib is engaged with the positioning groove, and the brake pushing member moves to position the brake rod at the third lock position, and when the brake operating member rotates to the second rotate position, the pushing rib is engaged with the braking groove, and the brake pushing member moves to position the brake rod at the third unlock position.

In the first aspect, the brake operating member has a mounting cavity provided with the pushing rib in the mounting cavity, and the brake pushing member is movably arranged in the mounting cavity.

In the first aspect, the brake pushing member is provided with a first identifier and a second identifier, the brake operating member is provided with a display window in communication with the mounting cavity, when the brake rod is at the third lock position, the first identifier is aligned with the display window, and when the brake rod is at the third unlock position, the second identifier is aligned with the display window.

In the first aspect, the braking mechanism further includes a third reset member, the third reset member constantly causing the brake rod to move towards the third lock position.

In the first aspect, the first connecting assembly includes: a connecting sleeve fastened to the wheel mounting frame and in communication with one of the first brake holes through a communication hole in the wheel mounting frame; and a connecting rod partially inserted into the connecting sleeve, the brake operating member is rotatably arranged on the connecting rod, and the brake pushing member is movably arranged on the connecting rod.

In the first aspect, the braking mechanism further includes a third reset member, the third reset member being arranged in the connecting rod and abutting against the brake pushing member, and the third reset member constantly causing the brake rod to move towards the third lock position.

In the first aspect, two wheel assemblies are provided and respectively fastened to two ends of the first connecting assembly, the brake operating member is rotatably arranged on the first connecting assembly, two brake pushing members are correspondingly provided and movably arranged on the first connecting assembly, the brake operating member is correspondingly provided with two pushing ribs, each of the brake pushing members is provided with a positioning groove and a braking groove, a base of the braking groove is away from the wheel body on the corresponding side relative to a base of the positioning groove, two brake rods are correspondingly provided, the two brake rods are selectively inserted into and engaged with the first brake holes of the two wheel assemblies respectively, the brake operating member has a first rotate position and a second rotate position, when the brake operating member rotates to the first rotate position, the two pushing ribs fit the positioning grooves of the two brake pushing members respectively, and the two brake pushing members respectively move until the two brake rods are located at the third lock position respectively, and when the brake operating member rotates to the second rotate position, the two pushing rib fit the braking grooves of the two brake pushing members respectively, and the two brake pushing members respectively move until the two brake rods are located at the third unlock position respectively.

In the first aspect, the first connecting assembly includes: two connecting sleeves respectively fastened to two wheel mounting frames and respectively in communication with one of the plurality of first brake holes on the corresponding wheel bodies through the communication holes on the two wheel mounting frames; and a connecting rod having two ends respectively inserted into the connecting sleeve, the brake operating member is rotatably arranged on the connecting rod, and the two brake pushing members are both movably arranged on the connecting rod.

In the first aspect, the braking mechanism further includes a third reset member, the third reset member being arranged in the connecting rod and having two ends respectively abutting against the two brake pushing members.

In the first aspect, the brake operating member includes a first pedal and a second pedal connected to each other.

In the first aspect, the first pedal has an elastic finger, and the second pedal has a fixed hole, the elastic finger detachably fitting the fixed hole.

In a second aspect of the present disclosure, an infant carrier is provided. The infant carrier includes a carrying body, a movable assembly, a length adjustment mechanism, an angle adjustment mechanism, and at least one of a first limiting mechanism and a second limiting mechanism. The movable assembly is pivotally connected to the carrying body and is telescopic. The length adjustment mechanism is arranged on the movable assembly, and the length adjustment mechanism is configured to adjust extension and contraction of the movable assembly, so that the movable assembly is switchable between an extended state and a contracted state. The angle adjustment mechanism is arranged between the movable assembly and the carrying body, and the angle adjustment mechanism is configured to adjust pivoting of the movable assembly relative to the carrying body. When the movable assembly is in the contracted state and is rotatable relative to the carrying body, the first limiting mechanism locks the length adjustment mechanism to limit extension and contraction of the movable assembly, and when the movable assembly rotates to a preset angle, the first limiting mechanism unlocks the length adjustment mechanism, so that the movable assembly is switchable between the extended state and the contracted state. When the movable assembly is switched to the extended state, the second limiting mechanism locks the angle adjustment mechanism to limit the pivoting of the movable assembly, and when the movable assembly is switched to the contracted state, the second limiting mechanism unlocks the angle adjustment mechanism, and the movable assembly is pivotable.

In the second aspect, the first limiting mechanism includes: a second locking member arranged on the movable assembly; and a first driving member arranged on the carrying body and having a limitation releasing portion. At least part of the first driving member is capable of driving the second locking member to move and lock the length adjustment mechanism adjustment mechanism, and the second locking member is capable of cooperating with the limitation releasing portion to unlock the length adjustment mechanism.

In the second aspect, when the movable assembly rotates relative to the carrying body, the first driving member drives the second locking member to move in a transverse direction of the carrying body and lock the length adjustment mechanism.

In the second aspect, the first driving member is a pushing rib arranged on the carrying body and protruding towards one side of the movable assembly.

In the second aspect, the pushing rib is an arc-shaped rib, and an arc-shaped direction of the arc-shaped rib is consistent with an arc-shaped direction in which the movable assembly pivots.

In the second aspect, the second locking member is a limiting post, the limiting post being provided with a locking end and an abutting end, and when the movable assembly rotates, the pushing rib pushes against the abutting end to drive the locking end to move towards the length adjustment mechanism to lock the length adjustment mechanism.

In the second aspect, the limitation releasing portion is a releasing groove arranged on the first driving member, and when the movable assembly rotates to the preset angle, the abutting end is located in the releasing groove, the locking end is disengaged from the length adjustment mechanism, and the movable assembly is switchable between the contracted state and the extended state.

In the second aspect, the first limiting mechanism further includes a first elastic member, and when the movable assembly rotates to the preset angle, an elastic restoring force of the first elastic member drives the locking end to move away from the length adjustment mechanism to drive the abutting end to be accommodated in the releasing groove.

In the second aspect, the first elastic member has one end abutting against the limiting post and the other end abutting against a side wall of the movable assembly.

In the second aspect, the abutting end is provided with a stroke groove, and a limiting pin is arranged in the stroke groove, at least one end of the limiting pin being fastened to the movable assembly, and the stroke groove cooperating with the limiting pin to limit a movement stroke of the limiting post.

In the second aspect, the second limiting mechanism includes: a second driving member selectively abutting against or separated from the length adjustment mechanism; and a fifth locking member provided with a catching end catching the second driving member and a stop end preventing pivoting of the angle adjustment mechanism.

In the second aspect, the second driving member is provided with a fastening hole, the catching end is provided with a hook, and the hook catches on the fastening hole.

In the second aspect, the second driving member pivots in the movable assembly, and the second driving member is provided with the catching end on a side of a pivot point and abuts against a fourth reset member on another side of the pivot point.

In the second aspect, a holder is arranged in the movable assembly, an end of the fourth reset member away from the second driving member is fastened to the holder, the holder is provided with a through hole, and the stop end passes through the through hole.

In the second aspect, the angle adjustment mechanism includes a pivot button, and when the first limiting mechanism locks the length adjustment mechanism, the stop end moves to a pressing path of the pivot button, blocks pressing of the pivot button, and locks angle adjustment of the movable assembly by the angle adjustment mechanism.

In the second aspect, the length adjustment mechanism includes: a driving block selectively pressing against or separated from the second driving member; and a length adjustment pull handle connected to the driving block. When the first limiting mechanism locks the length adjustment mechanism, the length adjustment pull handle drives the driving block to be separated from the second driving member, and the second driving member drives the stop end to block movement of the angle adjustment mechanism; and when the first limiting mechanism unlocks the length adjustment mechanism, the driving block presses against the second driving member, and the second driving member drives the stop end to be disengaged from the angle adjustment mechanism.

In the second aspect, the length adjustment mechanism further includes: a positioning block movably arranged on the driving block, the positioning block being configured to position the movable assembly in an extended state or a contracted state.

In the second aspect, the length adjustment pull handle is provided with a second sliding groove, the positioning block is provided with a sliding pin, and the driving block is provided with a through groove, when the length adjustment pull handle moves, the sliding pin sliding in the second sliding groove to drive the positioning block to extend out of the through groove to position the movable assembly in the extended state or the contracted state or drive the positioning block to retract into the through groove to release the positioning of the movable assembly.

In the second aspect, the movable assembly includes a first handle and a second handle sleeving the first handle, one of the first handle and the second handle being provided with at least one first locating hole, and the other of the first handle and the second handle being provided with at least two second locating holes, the positioning block is capable of extending out of the through groove to be held in one of the at least one first locating hole and one of the second locating holes to position relative positions of the first handle and the second handle, or exiting the locating holes and retracting into the through groove to release the positioning of the relative positions of the first handle and the second handle.

In the second aspect, the first handle is provided with an adjustment sliding member slidable along the first handle, the adjustment sliding member being connected to the length adjustment pull handle.

In the second aspect, at least part of the first handle is located above the second handle, a lower end of the second handle is connected to a handle joint configured to be pivotally connected to the carrying body, and the first limiting mechanism includes a second locking member, the second locking member selectively locking the length adjustment mechanism or unlocking the length adjustment mechanism, and the second locking member being arranged on the handle joint.

In the second aspect, the infant carrier further includes a frame, the frame being movably pivotally connected to the carrying body, the frame being switchable between an unfolded state and a folded state, when the frame is in the unfolded state, the infant carrier is in a stroller mode, and when the frame is in the folded state, the infant carrier is in a baby rocker mode, a carry cot mode, or a safety seat mode.

In a third aspect of the present disclosure, an infant carrier is provided. The infant carrier includes a seat assembly, a frame, and a base. The frame is switchable between an unfolded state and a folded state, and the frame is connected to the seat assembly. The base is connected to the frame. When the frame is in the unfolded state, the infant carrier is suitable for use as a stroller, and when the frame is in the folded state, the infant carrier is suitable for use as a safety seat; and when the frame is switched from the unfolded state to the folded state, the base moves towards the seat assembly.

In the third aspect, the frame includes: a rear bracket including an upper rear leg and a lower rear leg, the upper rear leg being pivotably connected to the lower rear leg, and the upper rear leg being pivotably connected to the seat assembly; and a front bracket including an upper front leg and a lower front leg, the upper front leg being pivotably connected to the lower front leg, and the upper front leg being pivotably connected to the upper rear leg. The rear bracket and the front bracket are pivotably connected to the base respectively.

In the third aspect, the lower rear leg includes a first lower rear leg and a second lower rear leg, the rear bracket further includes a first connecting rod, two ends of the first connecting rod being connected to the first lower rear leg and the second lower rear leg respectively, and the base is pivotably connected to the first connecting rod.

In the third aspect, at least part of the base is located between the first lower rear leg and the second lower rear leg, and the first connecting rod is arranged to pass through the part of the base.

In the third aspect, the lower front leg includes a first lower front leg and a second lower front leg, the front bracket further includes a second connecting rod, two ends of the second connecting rod being connected to the first lower front leg and the second lower front leg respectively, and the base is pivotably connected to the second connecting rod.

In the third aspect, the infant carrier further includes an unfold locking mechanism, the unfold locking mechanism including: a second sliding pin slidably arranged on the seat assembly and fixedly connected to the frame; and a first stopper pivotably connected to the seat assembly, the first stopper having a first stopper hook portion, the first stopper hook portion being adapted to be engaged with the second sliding pin to prevent sliding of the second sliding pin relative to the seat assembly, so that pivoting of the frame relative to the seat assembly is inhibited and the frame is locked in the unfolded state.

In the third aspect, the unfold locking mechanism further includes a first connecting member, and the second sliding pin is connected to the frame through the first connecting member.

In the third aspect, the unfold locking mechanism further includes an unfold locking mechanism elastic member, the unfold locking mechanism elastic member being arranged between the first stopper and the seat assembly, and the unfold locking mechanism elastic member being adapted to bias the first stopper to pivot towards the second sliding pin, so that the first stopper hook portion is engaged with the second sliding pin.

In the third aspect, the seat assembly includes a seat, the seat being provided with a strip groove, and the second sliding pin is inserted into the strip groove and is slidable along the strip groove.

In the third aspect, the seat assembly includes a seat and a connecting sheet connected to the seat, the connecting sheet being provided with a strip groove, and the second sliding pin is inserted into the strip groove and is slidable along the strip groove.

In the third aspect, the infant carrier further includes an unfold unlocking mechanism, the unfold unlocking mechanism being adapted to drive the first stopper to pivot in a direction away from the second sliding pin to disengage the first stopper hook portion from the second sliding pin.

In the third aspect, the unfold unlocking mechanism includes a first operating member, the first operating member being connected to the first stopper, the first operating member being operably arranged on the seat assembly, and the first operating member being adapted to drive the first stopper to pivot in a direction away from the second sliding pin when operated, to disengage the first stopper hook portion from the second sliding pin.

In the third aspect, the unfold unlocking mechanism further includes a first traction member, the first traction member having one end connected to the first operating member and the other end connected to the first stopper.

In the third aspect, the seat assembly includes a seat, the seat including a seat body and a seat housing, the seat body and the seat housing defining a first accommodating cavity, the seat housing is provided with a first opening, the first opening being arranged through the seat housing. The first operating member includes a first connecting portion and a first operating portion connected to the first connecting portion, the first connecting portion being inserted into the first accommodating cavity and connected to the first stopper, and at least part of the first operating portion passing through the first opening and being movable along the first opening.

In the third aspect, the seat assembly includes a seat, the seat including a seat body and a seat housing, the seat body and the seat housing defining a first accommodating cavity, and at least part of the unfold locking mechanism is accommodated in the first accommodating cavity.

In the third aspect, the infant carrier further includes a fold locking mechanism, the fold locking mechanism including: a fixed rod connected to the seat assembly; and a locking member pivotably connected to the base, the locking member being adapted to be engaged with the fixed rod to lock the frame in the folded state.

In the third aspect, the fold locking mechanism further includes a fold locking mechanism elastic member, the fold locking mechanism elastic member being adapted to bias the locking member to pivot towards the fixed rod, so that the locking member is engaged with the fixed rod.

In the third aspect, the base includes a base body and a locking member pivot shaft arranged on the base body, and the locking member is pivotably connected to the base body through the locking member pivot shaft.

In the third aspect, the base body includes a first housing and a second housing, the first housing and the second housing defining a fourth accommodating cavity, the second housing being provided with a second opening, the second opening being arranged through the second housing, and the locking member pivot shaft is located in the fourth accommodating cavity and is fixedly connected to the first housing. The locking member further includes a locking member connecting portion and a locking member hook portion, the locking member connecting portion being connected to the locking member hook portion, the locking member connecting portion being pivotably connected to the locking member pivot shaft, the locking member hook portion passing through the second opening and extending out of the fourth accommodating cavity, and the locking member is engaged with the fixed rod through the locking member hook portion.

In the third aspect, the fold locking mechanism further includes a fold locking mechanism elastic member and a fixed member, the fixed member being fixedly connected to the locking member pivot shaft, the fold locking mechanism elastic member being arranged between the fixed member and the locking member, and the fold locking mechanism elastic member being adapted to bias the locking member to pivot towards the fixed rod, so that the locking member hook portion is engaged with the fixed rod.

In the third aspect, the infant carrier further includes a fold unlocking mechanism, the fold unlocking mechanism being adapted to drive the locking member to pivot in a direction away from the fixed rod to disengage the locking member from the fixed rod.

In the third aspect, the fold unlocking mechanism includes a second operating member, the second operating member being connected to the locking member, the second operating member being operably arranged on the base, and the second operating member being adapted to, when operated, drive the locking member to pivot in the direction away from the fixed rod, to disengage the locking member from the fixed rod.

In the third aspect, the locking member includes a fourth locking member, a fifth locking member, and a second connecting member between the fourth locking member and the fifth locking member, two ends of the second connecting member being connected to the fourth locking member and the fifth locking member respectively, and the second operating member is connected to the second connecting member.

In the third aspect, the base includes a base bracket and an ISOFIX connector connected to the base bracket, the ISOFIX connector being adapted to be attached to an ISOFIX interface in a vehicle.

In the third aspect, the base further includes a sliding rod, the sliding rod having one end connected to the ISOFIX connector and the other end slidably connected to the base bracket. The infant carrier further includes an adjustment device, the adjustment device being adapted to releasably lock the sliding rod to the base bracket.

In the third aspect, the sliding rod is provided with a plurality of adjustment holes. The adjustment device includes a second stopper, the second stopper being movably arranged on the base and adapted to lock the sliding rod to the base bracket. The base bracket is provided with a stop hole corresponding to the second stopper, and one end of the second stopper is adapted to pass through the stop hole and be inserted into one of the adjustment holes in the sliding rod, to releasably lock the sliding rod to the base bracket.

In the third aspect, the base further includes a first housing and a second housing, the first housing and the second housing defining a fourth accommodating cavity, the base bracket and the adjustment device are both accommodated in the fourth accommodating cavity and connected to the first housing, and part of the sliding rod is accommodated in the fourth accommodating cavity and slidably connected to the base bracket.

In the third aspect, the base bracket further includes a sliding sleeve connected to the base bracket, the sliding sleeve being provided with a third through hole, and one end of the sliding rod passes through the third through hole and is slidably connected to the base bracket.

In the third aspect, the adjustment device further includes a third operating member, the third operating member being operably arranged on the base and being connected to the second stopper, and the third operating member being adapted to drive the second stopper to move synchronously to lock the sliding rod to the base bracket or release the sliding rod from the base bracket.

In the third aspect, the third operating member is provided with a first driving groove, and the other end of the second stopper is provided with a first driving pin, the first driving pin being inserted into and engaged with the corresponding first driving groove and movable along the first driving groove.

In the third aspect, the first driving groove has a first position and a second position, when the first driving pin is at the first position in the first driving groove, the sliding rod is locked to the base bracket, and when the first driving pin is at the second position in the first driving groove, the sliding rod is released from the base bracket.

In the third aspect, the adjustment device further includes a holder, the holder being connected to the base, the holder being provided with a third guide groove, the third guide groove being configured to guide movement of the second stopper, and the first driving pin is inserted into and engaged with the third guide groove and is movable along the third guide groove.

In the third aspect, the adjustment device further includes an adjustment device elastic member, the adjustment device elastic member being adapted to bias the third operating member to cause the third operating member to be at an initial position when not operated.

In the third aspect, the seat assembly includes a seat belt positioning device, the seat belt positioning device having a seat belt slot, and when the infant carriers is in a form of a safety seat, a seat belt at a vehicle seat is adapted to pass through the seat belt slot to fix the infant carrier to the seat.

In the third aspect, the infant carrier further includes: a plurality of wheel assemblies connected to the frame. Each of the wheel assemblies includes a wheel, and when the frame is in the folded state, the lowest point of the wheel is higher than a bottom surface of the base.

In the third aspect, each of the wheel assemblies further includes a mudguard, when the frame is in the folded state, the mudguard being located below the wheel, and the lowest point of the mudguard being as high as or higher than the bottom surface of the base.

In the third aspect, the infant carrier further includes: a plurality of wheels, when the frame is in the unfolded state, the infant carrier in a form of a stroller being adapted to move through rotation of the plurality of wheels; and a braking mechanism switchable between a locked state and an unlocked state, when the braking mechanism is in the locked state, at least one predetermined wheel in the plurality of wheels is incapable of rotating, and when the braking mechanism is in the unlocked state, at least one predetermined wheel is rotatable.

In the third aspect, the predetermined wheel is circumferentially provided with a plurality of second brake holes along a hub thereof, and the braking mechanism includes a locking pin, the locking pin being movably arranged on the frame, the locking pin being movable between an unlock position and a lock position, the locking pin having a locking end, when the locking pin is at the lock position, the locking end of the locking pin extending out of the frame and being engaged with one of the plurality of second brake holes, and when the locking pin is at the unlock position, the locking end of the locking pin being disengaged from the one of the plurality of second brake holes.

In the third aspect, the hub of the predetermined wheel is provided with a plurality of posts, and an end of each of the posts facing the frame is provided with the second brake hole.

In the third aspect, the braking mechanism further includes a pedal member, the pedal member being pivotably arranged on the base, the pedal member being pivotable between a travel position and a stop position, when the pedal member pivots from the travel position to the stop position, the pedal member being adapted to drive the locking pin to move from the unlock position to the lock position, and when the pedal member pivots from the stop position to the travel position, the pedal member being adapted to drive the locking pin to move from the lock position to the unlock position.

In the third aspect, the braking mechanism further includes a third driving member, the third driving member being movably arranged in the frame to drive the locking pin to move, and the pedal member is connected to the third driving member to drive the third driving member to move.

In the third aspect, the third driving member has a driving surface, and the locking pin has a second connecting end, the second connecting end of the locking pin being provided with a second driving pin, the second driving pin abutting against the driving surface, and the driving surface is configured such that when the third driving member moves, the driving surface causes the second driving pin to move, to drive the locking pin to move between the unlock position and the lock position.

In the third aspect, the braking mechanism further includes a second traction member, one end of the second traction member being connected to the pedal member, and the other end of the second traction member being connected to the third driving member.

In the third aspect, the braking mechanism further includes: a first braking mechanism elastic member arranged between the third driving member and the frame and adapted to bias the third driving member, to enable the locking pin to move towards the lock position; and a second braking mechanism elastic member arranged between the frame and the locking pin and adapted to bias the locking pin to move towards the lock position.

In the third aspect, the base includes a base body and a brake connecting portion connected to the base body, the brake connecting portion being provided with an engaging protrusion. The pedal member is pivotably connected to the brake connecting portion, the pedal member is provided with at least two engaging recesses in communication with each other, the engaging protrusion being capable of being engaged with any one of the engaging recesses, an elastic sheet capable of locking the engaging protrusion in the required engaging recess is arranged between two adjacent engaging recesses, so that the pedal member is locked at the travel position or the stop position, and the pedal member is operable to overcome an elastic force of the elastic sheet, so that the engaging protrusion is engaged with the different engaging recesses.

In the third aspect, the infant carrier further includes a movable assembly, the movable assembly being connected to the seat assembly and rotatable relative to the seat assembly.

In the third aspect, the infant carrier further includes a movable assembly pivotally connected to the seat assembly, the movable assembly including: two connecting arms pivotably connected to the seat assembly on two opposite sides of the seat assembly; a U-shaped handle body, two ends of the handle body having adjustment portions respectively, and the two adjustment portions being respectively connected to the two connecting arms and slidable relative to the two connecting arms; and a length adjustment mechanism switchable between a locked state and an unlocked state, when the length adjustment mechanism is in the unlocked state, the adjustment portions being slidable relative to the connecting arms, and when the length adjustment mechanism is in the locked state, the adjustment portions and the connecting arms being relatively fixed.

In the third aspect, the length adjustment mechanism includes: a positioning member movably arranged in the adjustment portions and switchable between an extend position and a retract position; and a plurality of positioning holes arranged in the connecting arms, when the positioning member is at the extend position, the positioning member being engaged with at least one of the plurality of positioning holes, and when the positioning member is at the retract position, the positioning member being disengaged from the at least one of the plurality of positioning holes.

In the third aspect, the length adjustment mechanism further includes a pull handle, the pull handle being connected to the positioning member, and the pull handle being operable to drive the positioning member to switch between the extend position and the retract position.

In the third aspect, the length adjustment mechanism further includes a pull rod, one end of the pull rod being connected to the pull handle, and the other end of the pull rod being connected to the positioning member. One of the pull rod and the positioning member is provided with a second driving groove, the other of the pull rod and the positioning member is provided with a third driving pin, the third driving pin being inserted into and engaged with the second driving groove and movable along the second driving groove, an extension direction of the second driving groove intersects with and is not perpendicular to a movement direction of the positioning member, and the extension direction of the second driving groove intersects with and is not perpendicular to a movement direction of the pull rod.

In the third aspect, the connecting arms each are provided with a first hollow cavity for accommodating the corresponding adjustment portion, the adjustment portion is provided with a second hollow cavity, the adjustment portion is provided with a third strip hole, the third strip hole being arranged through a side wall of the second hollow cavity, the pull handle is arranged around at least part of a periphery of the adjustment portion and is movable along the adjustment portion, the pull rod is arranged in the second hollow cavity, and at least part of the pull rod passes through the third strip hole and is connected to the pull handle.

In the third aspect, the length adjustment mechanism further includes a guide base, the guide base being at least partially arranged in the adjustment portions and provided with a fourth strip hole, and the second driving pin is connected to the positioning member, passes through the fourth strip hole, and is inserted into the second driving groove.

In the third aspect, the guide base is provided with a third sliding groove in communication with the fourth strip hole, and the positioning member is movably arranged in the third sliding groove.

In the third aspect, the length adjustment mechanism further includes a length adjustment mechanism elastic member, the length adjustment mechanism elastic member being arranged between the guide base and the pull rod, and the length adjustment mechanism elastic member being adapted to bias the pull rod to hold the positioning member at the extend position.

In the third aspect, the pull rod includes a driving connecting portion, an operating connecting portion, and a connecting rod portion connected between the driving connecting portion and the operating connecting portion, the driving connecting portion being provided with the second driving groove and an abutting portion, the guide base is provided with an accommodating groove, at least part of the abutting portion being located in the accommodating groove, and the length adjustment mechanism elastic member is arranged in the accommodating groove and abuts against the abutting portion.

In the third aspect, the adjustment portions are provided with limiting members, the limiting members being configured to prevent complete removal of the handle body from the connecting arms.

In the third aspect, the connecting arms are provided with first hollow cavities for accommodating the adjustment portions, the movable assembly further includes a handle holder, the handle holder being fixedly connected to tail ends of the connecting arms, and at least part of the handle holder being inserted into the first hollow cavities, and the adjustment portions pass through the handle holder and are slidably connected to the connecting arms.

### BRIEF DESCRIPTION OF THE DRAWINGS

FIG. 1 is a schematic structural diagram of an infant carrier according to an embodiment of the present disclosure, with a braking mechanism in a braking state.

FIG. 2 is an enlarged view of a portion A in FIG. 1.

FIG. 3 is a partial exploded view of the infant carrier shown in FIG. 1.

FIG. 4 is an enlarged view of a portion B in FIG. 3.

FIG. 5 is a schematic structural diagram of a holder shown in FIG. 4.

FIG. 6 is a schematic structural diagram of a fold button shown in FIG. 4.

FIG. 7 is a schematic structural diagram of the fold button shown in FIG. 6 from another perspective.

FIG. 8 is a partial sectional view of the infant carrier shown in FIG. 1, with a locking assembly in a locked state and a frame in an unfolded state.

FIG. 9 is another partial sectional view of the infant carrier shown in FIG. 1, with the locking assembly in an unlocked state and the frame in a process of being folded.

FIG. 10 is a yet another partial sectional view of the infant carrier shown in FIG. 1, with the locking assembly in the unlocked state and the frame in a folded state.

FIG. 11 is a side view of the infant carrier shown in FIG. 1, with the frame in the unfolded state.

FIG. 12 is a side view of the infant carrier shown in FIG. 1, with the frame in the process of being folded.

FIG. 13 is a side view of further folding of the infant carrier shown in FIG. 12.

FIG. 14 is a side view of furthermore folding of the infant carrier shown in FIG. 13.

FIG. 15 is a side view of the infant carrier shown in FIG. 1, with the frame in the folded state.

FIG. 16 is a perspective view of the infant carrier shown in FIG. 15 from another perspective.

FIG. 17 is an enlarged view of a portion C in FIG. 16.

FIG. 18 is a schematic structural diagram of a movable assembly in FIG. 11 in a sectional state.

FIG. 19 is an enlarged view of a portion D in FIG. 18.

FIG. 20 is an enlarged view of a portion E in FIG. 18.

FIG. 21 is a schematic structural diagram of a length adjustment mechanism in FIG. 18.

FIG. 22 is an enlarged view of a portion F in FIG. 21.

FIG. 23 is a perspective view of the portion F in FIG. 21 from another perspective.

FIG. 24 is a sectional view of the portion F in FIG. 21 with a first housing portion being hidden.

FIG. 25 is another sectional view of the portion F in FIG. 21.

FIG. 26 is a schematic structural diagram of the infant carrier shown in FIG. 1 in a baby rocker mode.

FIG. 27 is a schematic structural diagram of the infant carrier shown in FIG. 1 in a carry cot mode.

FIG. 28 is a sectional view of the infant carrier shown in FIG. 1.

FIG. 29 is an enlarged view of a portion G in FIG. 28.

FIG. 30 is an enlarged view of a portion H in FIG. 28.

FIG. 31 is an enlarged view of a portion I in FIG. 1.

FIG. 32 is another schematic structural diagram of the infant carrier shown in FIG. 1, with the braking mechanism in an unbraking state.

FIG. 33 is an enlarged view of a portion J in FIG. 32.

FIG. 34 is an exploded view of a first connecting assembly and the braking mechanism of the infant carrier shown in FIG. 1.

FIG. 35 is a schematic structural diagram of a brake operating member in the infant carrier shown in FIG. 34.

FIG. 36 is a schematic structural diagram of the brake operating member shown in FIG. 35 from another perspective.

FIG. 37 is an exploded view of the brake operating member shown in FIG. 36.

FIG. 38 is a schematic structural diagram of the brake operating member according to another embodiment of the present disclosure.

FIG. 39 is a schematic structural diagram of the brake operating member shown in FIG. 38 from another perspective.

FIG. 40 is a sectional view of the infant carrier in FIG. 1 along a line K1-K1.

FIG. 41 is a sectional view of the infant carrier in FIG. 32 along a line K2-K2.

FIG. 42 is a schematic structural diagram of a first pedal in the infant carrier shown in FIG. 34.

FIG. 43 is a schematic structural diagram of a brake pushing member in the infant carrier shown in FIG. 34.

FIG. 44 is a schematic structural diagram of the infant carrier in the baby rocker mode according to an embodiment of the present disclosure.

FIG. 45 is a schematic structural diagram of the infant carrier shown in FIG. 44 in a carry cot mode.

FIG. 46 is a schematic structural diagram of the infant carrier shown in FIG. 44 in a safety seat mode.

FIG. 47 is a schematic structural diagram of the infant carrier shown in FIG. 44 in a stroller mode.

FIG. 48 is a schematic structural diagram of the infant carrier shown in FIG. 47 from another perspective.

FIG. 49 shows a partial perspective view of a handle in the infant carrier shown in FIG. 48 in a state between an extended state and a contracted state, and an enlarged view of a dotted box part thereof.

FIG. 50 shows a schematic structural diagram of the handle in the infant carrier shown in FIG. 45 after handle joints on two sides and a handle lever on one side are hidden, and an enlarged view of a dotted box part thereof.

FIG. 51 shows a schematic structural diagram of the handle in the infant carrier shown in FIG. 50 after the handle joints on two sides and the handle lever on one side are hidden, and an enlarged view of the dotted box part thereof from another perspective.

FIG. 52 shows a sectional view of the infant carrier shown in FIG. 45 along a line T1-T1, and an enlarged view of a dotted box part thereof.

FIG. 53 shows a schematic structural diagram of the handle in the infant carrier shown in FIG. 45, and an enlarged view of a dotted box part thereof.

FIG. 54 shows a sectional view of the handle shown in FIG. 53 alone a line T3-T3, and an enlarged view of a dotted box part thereof.

FIG. 55 is a schematic structural diagram of the handle in the infant carrier shown in FIG. 45 from another perspective.

FIG. 56 shows a sectional view of the handle shown in FIG. 55 alone a line T2-T2, and an enlarged view of a dotted box part thereof.

FIG. 57 shows a sectional view of the infant carrier in FIG. 47 alone a line T4-T4, and an enlarged view of a dotted box part thereof.

FIG. 58 shows a sectional view of the infant carrier in FIG. 47 alone a line T5-T5, and an enlarged view of a dotted box part thereof.

FIG. 59 is an exploded view of a pivot joint, a handle joint, and an angle adjustment mechanism of the infant carrier shown in FIG. 58.

FIG. 60 is an exploded view of the pivot joint, the handle joint, and the angle adjustment mechanism of the infant carrier shown in FIG. 58 from another perspective.

FIG. 61 is a sectional view of the handle in the infant carrier shown in FIG. 47 and an enlarged view of a dotted box part thereof.

FIG. 62 is a schematic structural diagram of a second limiting mechanism, a holder, and a pivot button in the infant carrier shown in FIG. 47.

FIG. 63 is a schematic structural diagram of the second limiting mechanism, the holder, and the pivot button in the infant carrier shown in FIG. 62 from another perspective.

FIG. 64 is a schematic structural diagram of an infant carrier according to an embodiment of the present disclosure, with a frame in an unfolded state and a handle assembly in an extended state.

FIG. 65 is a schematic structural diagram of the infant carrier shown in FIG. 64 from another perspective.

FIG. 66 is a schematic structural diagram of the infant carrier shown in FIG. 65 with the frame in a semi-folded state.

FIG. 67 is a schematic structural diagram of the infant carrier shown in FIG. 65 with the frame in a folded state.

FIG. 68 is a schematic structural diagram of the infant carrier shown in FIG. 64 from another perspective, with a second seat housing being removed and an unfold locking mechanism in a locked state.

FIG. 69 is an enlarged view of a portion O in FIG. 68.

FIG. 70 is a schematic structural diagram of the infant carrier shown in FIG. 68 with the unfold locking mechanism in an unlocked state.

FIG. 71 is an enlarged view of a portion P in FIG. 70.

FIG. 72 is an enlarged view of a portion L in FIG. 64.

FIG. 73 is a schematic structural diagram of the infant carrier shown in FIG. 64 from another perspective, with the frame in an unfolded state.

FIG. 74 is a schematic structural diagram of the infant carrier shown in FIG. 64 from another perspective, in which the frame is in the folded state.

FIG. 75 is a schematic structural diagram of a base of the infant carrier according to an embodiment of the present disclosure.

FIG. 76 is a schematic structural diagram of the base shown in FIG. 75 from another perspective.

FIG. 77 is a schematic structural diagram of the base in FIG. 75 after removal of a second housing.

FIG. 78 is a schematic structural diagram of the base shown in FIG. 77 from another perspective.

FIG. 79 is a transverse cross-sectional view of the base in FIG. 75.

FIG. 80 is a longitudinal cross-sectional view of the base in FIG. 75, with a second operating member being not pressed to move.

FIG. 81 is a longitudinal cross-sectional view of the base in FIG. 75, with the second operating member being pressed to move.

FIG. 82 is a partial exploded view of the infant carrier shown in FIG. 64 from another perspective.

FIG. 83 is an enlarged view of a portion Q in FIG. 82.

FIG. 84 is a partial sectional view of a wheel and a rear leg of the infant carrier according to an embodiment of the present disclosure, with a braking mechanism in a locked state.

FIG. 85 is a schematic structural diagram of the wheel and the rear leg in FIG. 84, with the braking mechanism in an unlocked state.

FIG. 86 is a partial exploded view of the infant carrier shown in FIG. 64 from another perspective.

FIG. 87 is an enlarged view of R in FIG. 86.

FIG. 88 is a schematic structural diagram of a pedal of the infant carrier according to an embodiment of the present disclosure.

FIG. 89 is a schematic structural diagram of a handle assembly of the infant carrier according to an embodiment of the present disclosure, with a handle in a contracted state.

FIG. 90 is an exploded view of the handle assembly in FIG. 89.

FIG. 91 is an exploded view of a length adjustment mechanism in FIG. 90.

FIG. 92 is a sectional view of the handle assembly in FIG. 89.

FIG. 93 is an enlarged view of a portion S in FIG. 92.

### REFERENCE SIGNS

100: seat assembly, 110: seat, 112: seat housing, 1121: first seat housing, 1122: second seat housing, 1123: first concave portion, 1125: second concave portion, 111: seat body, 113: first accommodating cavity, 114: carrying cavity, 115: headrest portion, 116: legrest portion, 117: pivot joint, 1171: second receiving groove, 11711: first pivot limiting groove, 11712: second pivot limiting groove, 1172: second pivot shaft, 11721: pivot groove, 120: fold limiting part, 121: strip groove, 130: seat belt positioning device, 131: seat belt slot,
360: ISOFIX connector,
200: frame,
210: rear bracket, 211: upper rear leg, 211a: first upper rear leg, 211b: second upper rear leg, 212: lower rear leg, 212a: first lower rear leg, 212b: second lower rear leg, 2121: first leg housing, 2122: second leg housing, 2123: third accommodating cavity, 2124: guide portion, 2125: second guide hole, 2126a: first movement limiting portion, 2126b: second movement limiting portion, 2127: abutting portion, 213: first connecting rod,
220: front bracket, 221: upper front leg, 221a: first upper front leg, 2212b: second upper front leg, 222: lower front leg, 222a: first lower front leg, 222b: second lower front leg, 2221: first connecting section, 2222: second connecting section, 223: second connecting rod,
230: first support frame, 231: first support rod, 232: first connecting assembly, 233: first connecting base, 240: second support frame, 241: second support rod, 242: second connecting assembly, 2421: connecting rod, 2421a: second strip hole, 2422: connecting sleeve, 243: second connecting base,
300: base, 310: base body, 311: first housing, 312: second housing, 313: second opening, 314: third concave portion, 315: third opening, 316: stop hole, 317: second projection, 318: fourth accommodating cavity, 320: base bracket, 321: sliding sleeve, 3211: third through hole, 322: first guide hole, 330: brake connecting portion, 331: engaging protrusion, 340: locking member pivot shaft, 350: sliding rod, 351: adjustment hole, 360: ISOFIX connector, 370: linkage rod,
400: wheel assembly, 410: rear wheel assembly, 411: rear wheel, 411a: first rear wheel, 411b: second rear wheel, 412: mudguard, 413: baffle connecting member,
420: front wheel assembly, 421: front wheel,
600: switching mechanism, 610: linkage assembly, 611: first linkage rod, 612: second linkage rod, 620: locking assembly, 621: holder, 6211: second accommodating cavity, 6212: open groove, 6213: first opening portion, 6214: second opening portion, 622: first locking member, 6221: locking body, 6222: locking protrusion, 6222a: inclined surface, 6223: elastic arm, 623: fold button, 6231: connecting portion, 6232: operation portion, 6233: connecting groove, 6234: push protrusion, 6235: locking recess, 6236: limiting step,
900: movable assembly,
910: connecting arm, 911: first hollow cavity, 912: positioning hole,
920: handle body, 921: adjustment portion, 923: first perforation, 924: third strip hole, 925: second hollow cavity,
931: handle holder, 932: limiting member,
940: pivot base, 941: disc-shaped portion, 942: connecting portion, 943: second receiving cavity, 944: third guide groove,
950: pivot adjustment assembly, 951: pivot fixing member, 952: pivot operating member, 9521: pivot engaging protrusion, 9522: operation limiting portion,
960: length adjustment mechanism, 961: positioning portion, 9611: movable connecting portion, 9612: positioning portion,
962: pull handle, 963: pull rod, 9631: driving connecting portion, 9632: operation connecting portion, 9633: connecting rod portion, 9634: second driving groove, 9635: second side plate, 9636: second connecting plate, 9637: abutting portion, 9641: length adjustment mechanism elastic member, 9642: third driving pin, 965: guide base, 9651: third sliding groove, 9653: fourth strip hole, 9654: fixed hole, 9655: accommodating groove, 9656: third protrusion, 966: length adjustment pull handle, 9661: sliding block, 9661a: second sliding groove, 9661b: second sleeving column, 967: driving block, 9671: mounting groove, 9672: through groove, 9673: first guide groove, 9674: limiting groove, 9675: reset groove, 9676: first sleeving column, 968: positioning block, 9681: positioning end, 9682: first sliding pin, 969: length reset member,
970: movable rod, 971: first rod part, 972: second rod part, 9721: locking hole, 973: length adjustment mechanism, 9731: fixed plug, 9731a: first through hole, 9731b: second through hole, 9731c: first sliding groove, 9731d: first side, 9731e: second side, 9731f: third side, 9731i: first pushing portion, 9732: locking pin, 9732a: driving post, 9733: operating assembly, 9733a: pull rod, 9733b: length adjustment operating member, 9733c: driving plug, 9733d: first housing portion, 9733e: second housing portion, 9733f: connecting housing portion, 9733g: driving chute, 9733h: second pushing portion, 9734: first reset member,
980: movable body,
990: handle lever, 991: first handle, 9911: first locating hole, 992: second handle, 9921: second locating hole, 993: adjustment sliding member, 994: handle joint, 9941: joint body, 9941a: button mounting groove, 9941b: penetrating hole, 9941c: first receiving groove, 9941d: first pivot shaft, 9941e: angle limiting groove, 9941f: first angle adjustment groove, 9941g: second angle adjustment groove, 9942: mounting member, 9943: connecting sleeve, 995: holder, 9951: through hole,
500: angle adjustment mechanism, 510: movable connecting base, 511: first locking part, 512: first fitting groove, 520: seat connecting base, 521: second locking part, 522: second fitting groove, 530: third locking part, 540: angle adjustment operating member, 550: second reset member, 560: pivot button, 561: button body, 562: button projection, 5621: limiting hook portion, 570: angle locking member, 571: pivot hole, 572: first angle adjustment protrusion, 573: angle limiting protrusion, 574: second angle adjustment protrusion, 580: angle reset member,
400: wheel assembly, 430: wheel mounting frame, 431: communication hole, 440: wheel body, 441: first brake hole,
700: adjustment device, 710: second stopper, 720: third operating member, 721: first driving groove, 722: operating hook portion, 724: receiving groove, 725: first projection, 730: holder, 731: third guide groove, 740: adjustment device elastic member, 750: first driving pin,
800: braking mechanism, 810: predetermined wheel, 811: hub, 812: post, 813: second brake hole, 820: locking pin, 821: second connecting end, 822: locking end, 823: convex portion, 830: pedal member, 831: footrest portion, 832: lug portion, 833a: first engaging recess, 833b: second engaging recess, 834: traction connecting portion, 835: elastic sheet, 836: skidproof stripe, 840: third driving member, 841: driving surface, 842: first side plate, 843: first connecting plate, 851: first braking mechanism elastic member, 852: second driving pin, 853: second braking mechanism elastic member, 860: brake rod, 861: first strip hole, 870: brake operating member, 871: first pedal, 8711: fixed hole, 8712: sleeving portion, 8712a: mounting cavity, 8712b: pushing rib, 8712c: display window, 8713: treading portion, 872: second pedal, 8721: elastic finger, 880: brake pushing member, 881: engaging end, 882: braking groove, 883: positioning groove, 884: first identifier, 885: second identifier, 890: third reset member,
A10: fastener, A20: first pin, A30: second pin, B10: first pivot shaft, B20: second pivot shaft, P1: first pivot point, P2: second pivot point, P3: third pivot point, P4: fourth pivot point, P5: fifth pivot contact, P6: sixth pivot point, P7: seventh pivot point, P8: eighth pivot point, P9: ninth pivot point,
C00: first limiting mechanism, C10: second locking member, C11: locking end, C12: abutting end: C121: stroke groove, C20: first driving member, C21: limitation releasing portion, C30: first elastic member, C40: limiting pin,
D00: second limiting mechanism, D10: second driving member, D11: first connecting end, D111: fastening hole, D12: sleeving protrusion, D20: third locking member, D21: catching end, D211: hook, D22: stop end, D30: fourth reset member,
101: first receiving cavity,
M: first position, N: second position,
5A: unfold locking mechanism, 5A1: second sliding pin, 5A2: first stopper, 5A21: first stopper hook portion, 5A22: first wedge surface, 5A3: first connecting member, 5A4: unfold locking mechanism elastic member,
5B: unfold unlocking mechanism, 5B1: first operating member, 5B11: first operating portion,
6A: fold locking mechanism, 6A1: fixed rod, 6A2: locking member, 6A2a: fourth locking member, 6A2b: fifth locking member, 6A21: second connecting member, 6A22: locking member connecting portion, 6A23: locking member hook portion, 6A24: second wedge surface, 6A3: fold locking mechanism elastic member, 6A31: spring portion, 6A32: U-shaped connecting portion, 6A4: fixed member, 6A41: spring mounting portion,
6B: fold unlocking mechanism, 6B1: second operating member,
10: horizontal reference plane, 20: vertical reference plane.

### DETAILED DESCRIPTION OF THE EMBODIMENTS

In order to make the objectives, technical solutions, and advantages of the present disclosure clearer, the present disclosure will be further described in detail below with reference to the accompanying drawings and embodiments. It should be understood that specific embodiments described herein are intended only to explain the present disclosure and are not intended to limit the protection scope of the present disclosure.

It is to be noted that, when one component is considered to be “fastened to” another component, it may be directly arranged on the another component or an intermediate component may exist. When one component is considered to be “connected” to another component, it may be directly connected to the another component or an intermediate component may co-exist. The terms “vertical”, “horizontal”, “left”, “right”, and similar expressions used herein are for illustrative purposes only, and do not indicate unique implementations.

Unless defined otherwise, all technical and scientific terms used herein have the same meanings as would generally understood by those skilled in the technical field of the present disclosure. The terms used herein in the specification of the present disclosure are for the purpose of describing specific embodiments only, and are not intended to limit the present disclosure. The term “and/or” used herein includes any and all combinations of one or more related listed items.

An embodiment of the present disclosure provides an infant carrier. The infant carrier can switch multiple usage modes such as a baby stroller, a safety seat, a carry cot, and a baby rocker, which is simple in structure and easy to use.

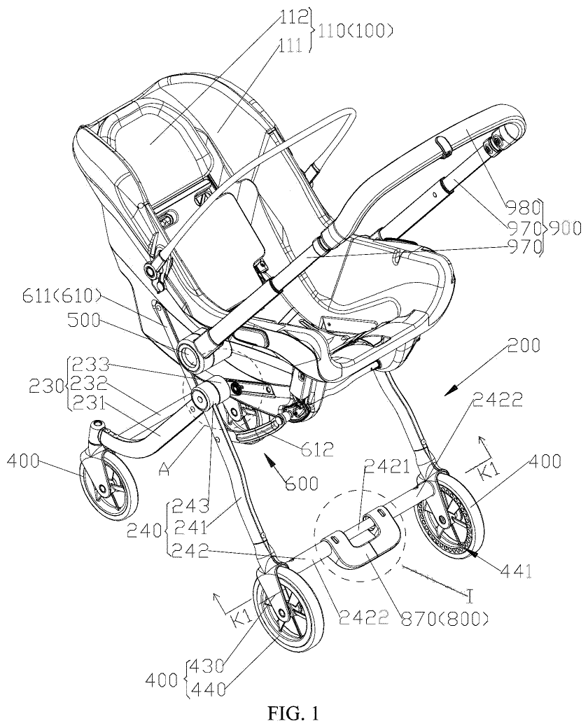

Specifically, as shown in FIG. 1, the infant carrier includes a seat assembly 100, a frame 200, a switching mechanism 600, a movable assembly 900, an angle adjustment mechanism 500, a wheel assembly 400, and a braking mechanism 800.

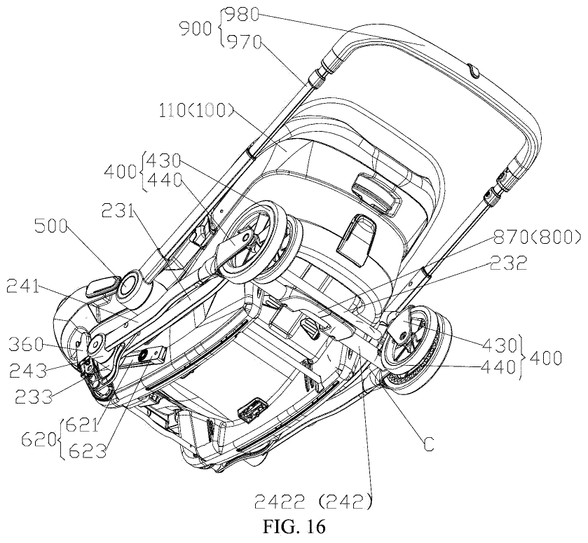

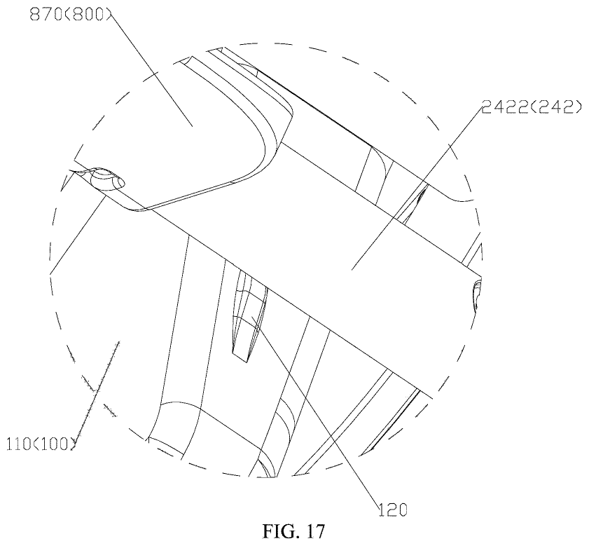

Specifically, as shown in FIG. 1, the seat assembly 100 includes a seat 110 for an infant to sit and lie on, and a fold limiting part 120 (see FIG. 16 and FIG. 17) arranged on the seat 110. In this embodiment, the fold limiting part 120 is a fold limiting protrusion arranged at the bottom of the seat 110. Certainly, in other embodiments, the fold limiting part 120 may alternatively be arranged on a front side, a rear side, or at other positions of the seat 110. The fold limiting part 120 may alternatively be a limiting groove, a limiting hook, or the like.

Specifically, the seat 110 includes a seat housing 112 made of a hard plastic material and a seat body 111 made of a foam material (such as EPP, EPS, EPO, or EPE). The seat 110 formed by splicing the seat housing 112 and the seat body 111 together ensures support strength and may also be lighter and easier to move. The fold limiting part 120 is configured to lock the frame 200 in a folded state (see details below).

Further, the frame 200 has an unfolded state and a folded state. The frame 200 is attached to the seat assembly 100. That is, the frame 200 can support the seat assembly 100. When the frame 200 is in the unfolded state, the infant carrier is suitable for use as a baby stroller. When the frame 200 is in the folded state, the infant carrier is suitable for use as a safety seat, a carry cot, a baby rocker, or the like. Specifically, as shown in FIG. 1, the frame 200 includes a first support frame 230 and a second support frame 220 pivotally connected to each other. The first support frame 230 and the second support frame 220 are both made of aluminum tubing, so that the frame 200 is relatively lightweight as a whole and is easy to carry.

Specifically, as shown in FIG. 1, the first support frame 230 and the second support frame 220 both have a roughly U-shaped structure, the first support frame 230 includes two first support rods 231 and a first connecting assembly 222 connected between the two first support rods 231, and the second support frame 220 includes two second support rods 221 and a second connecting assembly 222 connected between the two second support rods 221. The two first support rods 231 are respective pivotally connected to the two second support rods 221 on left and right sides of the seat assembly 100. Each of the first support rods 231 is pivotally connected to each of the second support rods 221 at a first pivot point P1. The first pivot point P1 is slidably connected to the seat assembly 100. In this embodiment, when the frame 200 is in the unfolded state, the first pivot point is at a first position of the seat assembly 100, and when the frame 200 is in the folded state, the first pivot point is at a second position of the seat assembly 100. An imaginary horizontal section at the bottom of the seat assembly 100 is taken as a horizontal reference plane 10, and the first position is closer to the horizontal reference plane 10 than the second position. An imaginary vertical section at the front of the seat assembly 100 is taken as a vertical reference plane 20, and the first position is closer to the vertical reference plane 20 than the second position. In other words, a sliding path of the first pivot point is inclined upwards in a direction from front to back.

Specifically, as shown in FIG. 1, the first connecting assembly 232 is in a shape of a straight rod. The second connecting assembly 222 includes a connecting rod 2421 and two connecting sleeves 2422. The connecting rod 2421 has a hollow rod structure, and two ends of the connecting rod 2421 are at least partially inserted into the two connecting sleeves 2422. Taking the frame 200 on one side of the seat assembly 100 as an example, one end of the first support rod 231 is provided with a first connecting base 213, and one end of the second support rod 221 is provided with a second connecting base 243. The first connecting base 213 and the second connecting base 243 are pivotally connected through a first pivot shaft B10 (see FIG. 8). The first support frame 230 and the second support frame 220 are respectively attached to the seat assembly 100 through the first connecting base 213 and the second connecting base 243. For example, in this embodiment, the first support frame 230 and the second support frame 220 are respectively attached to a seat body 111 of the seat 110 through the first connecting base 213 and the second connecting base 243. The first support frame 230 and the second support frame 220 are pivotally connected to each other through the first connecting base 213 and the second connecting base 243, and are rotatable relative to the seat assembly 100. The first connecting base 213 can support the seat assembly 100, and the second connecting base 243 can directly or indirectly support the seat assembly 100. In this embodiment, when the frame 200 is in the unfolded state, the first support frame 230 and the second support frame 220 are pivotally connected to each other through the first connecting base 213 and the second connecting base 243 to form a triangular support structure, thereby providing stable support for the seat assembly 100.

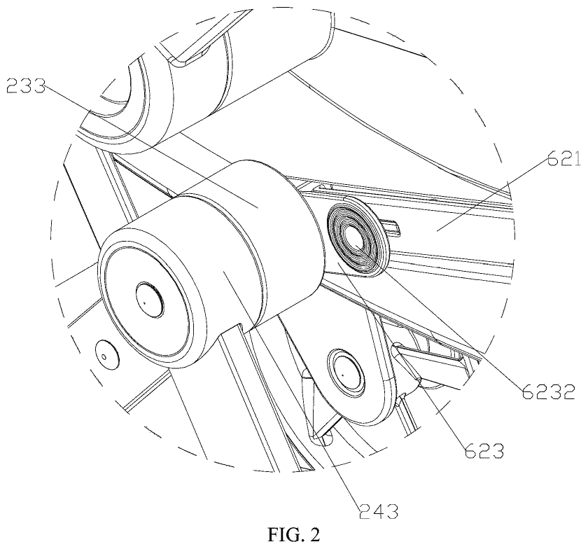

Further, as shown in FIG. 1 and FIG. 2, a switching mechanism 600 is arranged between the seat assembly 100 and the frame 200 and enables the frame 200 to switch between the unfolded state and the folded state. Specifically, the switching mechanism 600 includes a linkage assembly 610 and a locking assembly 620. The linkage assembly 610 is connected between the frame 200 and the seat assembly 100. The locking assembly 620 is operable to switch between a locked state and an unlocked state, when the locking assembly 620 is in the locked state, the frame 200 can be locked in the unfolded state, and when the locking assembly 620 is in the unlocked state, the frame 200 is linked to switch from the unfolded state to the folded state or switch from the folded state to the unfolded state through the linkage assembly 610. In this embodiment, two switching mechanisms 600 are provided, which are respectively arranged between left and right sides of the seat assembly 100 and left and right sides of the frame 200. Certainly, in other embodiments, the number of the switching mechanism 600 may alternatively be more than two or less than two.

One of the switching mechanisms 600 is taken as an example to describe a structure and a connection relationship thereof in detail.

As shown in FIG. 1, the linkage assembly 610 includes a first linkage rod 611 and a second linkage rod 612. Two ends of the first linkage rod 611 are pivotally connected to the first support frame 230 and the seat assembly 100 respectively, and two ends of the second linkage rod 612 are pivotally connected to the second support frame 220 and the seat assembly 100 respectively.

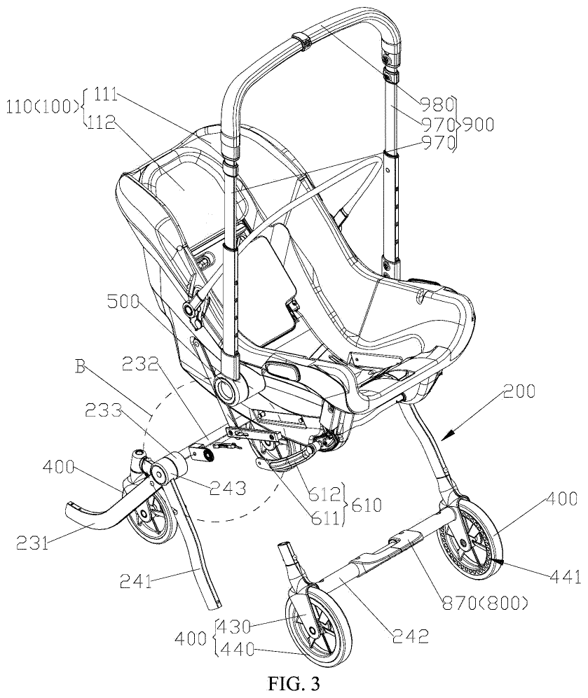

Specifically, as shown in FIG. 2 to FIG. 4, the locking assembly 620 includes a holder 621, a first locking member 622, and a fold button 623.

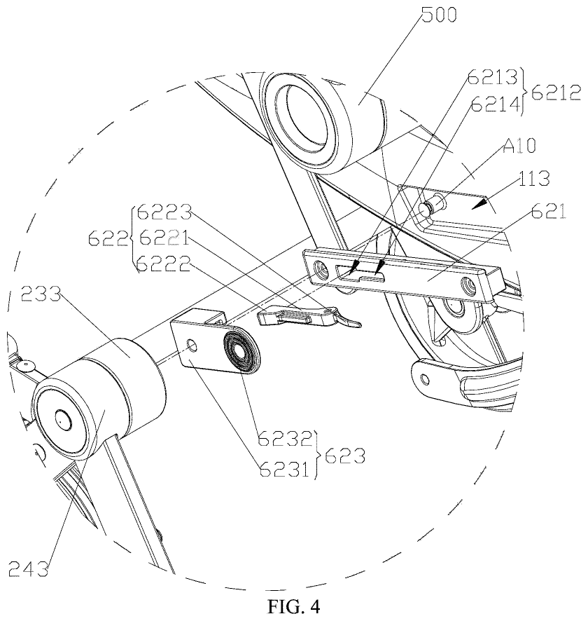

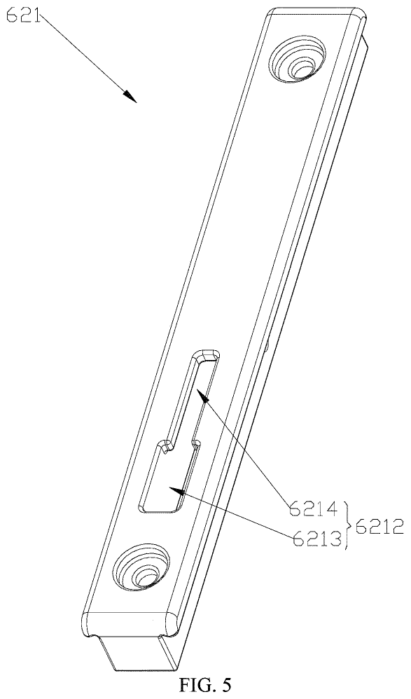

As shown in FIG. 4 and FIG. 5, the holder 621 is fastened to one side of the seat 110. The holder 621 is configured to provide a sliding track for pivot points of the first support rod 231, the second support rod 221, and the seat assembly 100 when the frame 200 is switched from the unfolded state to the folded state or from the folded state to the unfolded state. In this embodiment, the sliding track and the holder 621 both have a strip structure. In other embodiments, the holder 621 may alternatively have a structure other than the strip structure, as long as the sliding track has a strip structure. Certainly, in other embodiments, the sliding track is not required to have a strict straight-line structure. For example, the sliding track may have an arc-shaped structure with a radian, or the like.

Specifically, as shown in FIG. 4 and FIG. 5, one side of the seat 110 is provided with a first accommodating cavity 113, and the holder 621 is mounted and fixed in the first accommodating cavity 113 through a fastener A10. The holder 621 has a second accommodating cavity 6211 (see FIG. 8) and an open groove 6212 in communication with the second accommodating cavity 6211. The open groove 6212 has a first opening portion 6213 with a relatively large diameter and a second opening portion 6214 with a relatively small diameter.

As shown in FIG. 4 and FIG. 8, the first locking member 622 is rotatably arranged in the second accommodating cavity 6211, and at least part of the first locking member 622 can extend out of the second accommodating cavity 6211 through the open groove 6212. Specifically, the first locking member 622 is pivotally connected to the holder 621 at a second pivot point P2, and the second pivot point P2 is located in the second accommodating cavity 6211. The first locking member 622 specifically includes a locking body 6221 and a locking protrusion 6222 and an elastic arm 6223 respectively connected to two ends of a body of the first locking member 622. In this embodiment, the first locking member 622 has an integrally formed structure. Certainly, in other embodiments, the first locking member 622 may alternatively be formed by connecting a locking body 6221, the locking protrusion 6222, and the elastic arm 6223 independent of each other by welding or the like. The locking protrusion 6222 can extend out of the second accommodating cavity 6211 through the first opening portion 6213. At least part of the locking body 6221 is opposite to the second opening portion 6214 or can extend out of the second accommodating cavity 6211 through the second opening portion 6214. The locking body 6221 and the locking protrusion 6222 are located on one side of the second pivot point P2, and the elastic arm 6223 is located on the other side of the second pivot point P2. A free end of the elastic arm 6223 abuts against a cavity wall of the second accommodating cavity 6211, and the elastic arm 6223 constantly causes the locking protrusion 6222 to pivot in a direction of extension out of the open groove 6212.

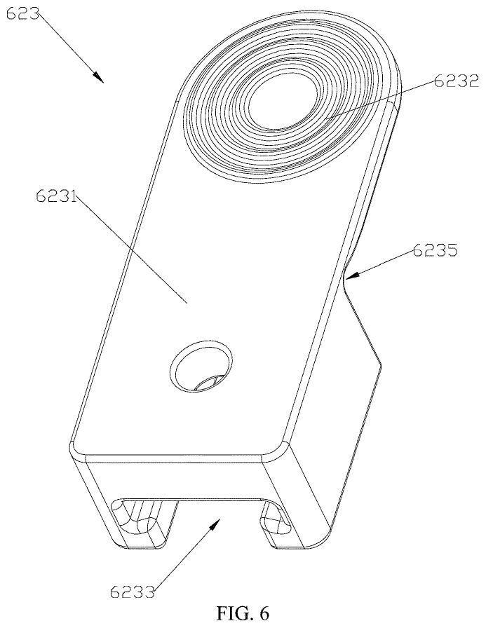

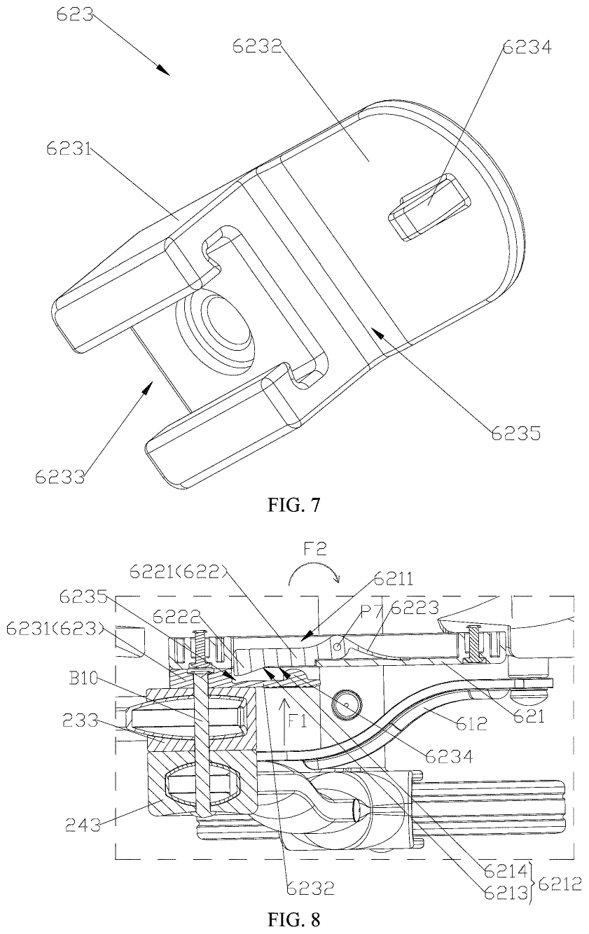

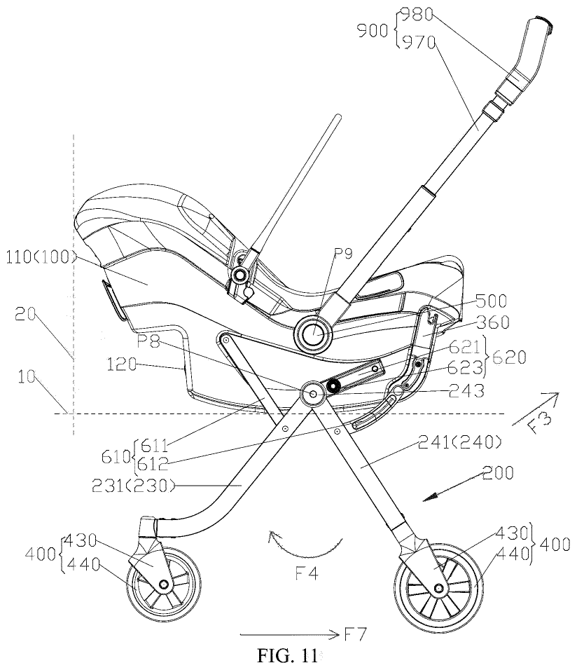

Further, as shown in FIG. 6 to FIG. 8, the fold button 623 is connected to the frame 200. Specifically, as shown in FIG. 11, the fold button 623 is attached to the first pivot point P1. Therefore, a sliding path of the fold button 623 is a sliding path of the first pivot point P1. In this embodiment, the sliding path is inclined upwards in a direction from front to back. The fold button 623 is operable to drive the first locking member 622 to unlock the frame 200. Specifically, the fold button 623 includes a connecting portion 6231 and an operating portion 6232 connected to each other. In this embodiment, the fold button 623 has an integrally formed structure. In other embodiments, the fold button 623 may alternatively be formed by connecting the connecting portion 6231 and the operating portion 6232 independent of each other by welding or the like. The fold button 623 is slidably connected to the seat assembly 100. Specifically, the connecting portion 6231 is attached to the first connecting base 233 or the second connecting base 243 through the first pivot shaft B10. A connecting groove 6233 is formed on a side of the connecting portion 6231 facing away from the frame 200. The holder 621 is at least partially engaged with the connecting groove 6233 so that the fold button 623 can slide relative to the holder 621. That is, in this embodiment, the holder 621 is equivalent to the sliding track. The connecting groove 6233 forms a limiting step 6236 protruding towards the holder 621. A side of the operating portion 6232 facing the holder 621 is provided with a push protrusion 6234, and the operating portion 6232 can be pressed to cause the push protrusion 6234 to push against the locking body 6221 through the second opening portion 6214. In other embodiments, if at least part of the locking body 6221 extends out of the second accommodating cavity 6211 through the second opening portion 6214, the push protrusion 6234 is not required to extend into the second accommodating cavity 6211 through the second opening portion 6214. That is, the push protrusion 6234 can directly push against the locking body 6221. In this embodiment, as shown in FIG. 11, the first linkage rod 611 is inclined downwards along a direction F7 (that is, a direction from front to back), the second linkage rod 612 is inclined upwards along the direction F7, and the sliding track is inclined upwards along the direction F7.

Further, the fold button 623 is provided with a locking recess 6235, and the locking recess 6235 is located between the connecting portion 6231 and the operating portion 6232. When the locking assembly 620 is in the locked state, the locking protrusion 6222 and the locking recess 6235 are engaged and locked, thereby preventing sliding of the frame 200 and the linkage assembly 610 relative to the seat assembly 100. In this way, when the frame 200 is in the unfolded state as shown in FIG. 11, based on a triangular support structure formed between the first support frame 230 and the second support frame 240 of the frame 200 pivotally connected to each other, a triangular support structure formed between the first linkage rod 611 and the first support frame 230, and a triangular support structure formed between the second linkage rod 612 and the second support frame 240, the linkage assembly 610 cannot drive the frame 200 to fold, so that the frame 200 is maintained in the unfolded state. When the operating portion 6232 of the fold button 623 is pressed, the push protrusion 6234 pushes against the locking body 6221 through the second opening portion 6214, causing the first locking member 622 to rotate as a whole around the second pivot point P2, so that the locking protrusion 6222 is disengaged from the locking recess 6235, the locking assembly 620 is in the unlocked state, the fold button 623 and the holder 621 are slidable relative to each other, and the frame 200 can be folded. When the fold button 623 slides relative to the holder 621, the locking recess 6235 first moves to a position where the locking recess is no longer opposite to the locking protrusion 6222. In this case, the limiting step 6236 abuts against the locking protrusion 6222, and the locking protrusion 6222 is pushed into the second accommodating cavity 6211. In this case, the elastic arm 6223 is elastically deformed. When the limiting step 6236 moves to cross the locking protrusion 6222, the locking protrusion 6222 is reset under an elastic restoring force of the elastic arm 6223 and extends out of the second accommodating cavity 6211. In this case, the fold button 623 moves to a position away from the locking protrusion 6222, so that the locking protrusion 6222 and the locking recess 6235 no longer engage with each other.

Certainly, in other embodiments, reversely, the holder 621 and the first locking member 622 are fastened to the frame 200, and the fold button 623 is fastened to the seat assembly 100. Alternatively, the locking assembly 620 in other forms may be used.

A structure on one side of the seat assembly 100 is taken as an example below to describe a specific process of switching the infant carrier between the unfolded state and the folded state.

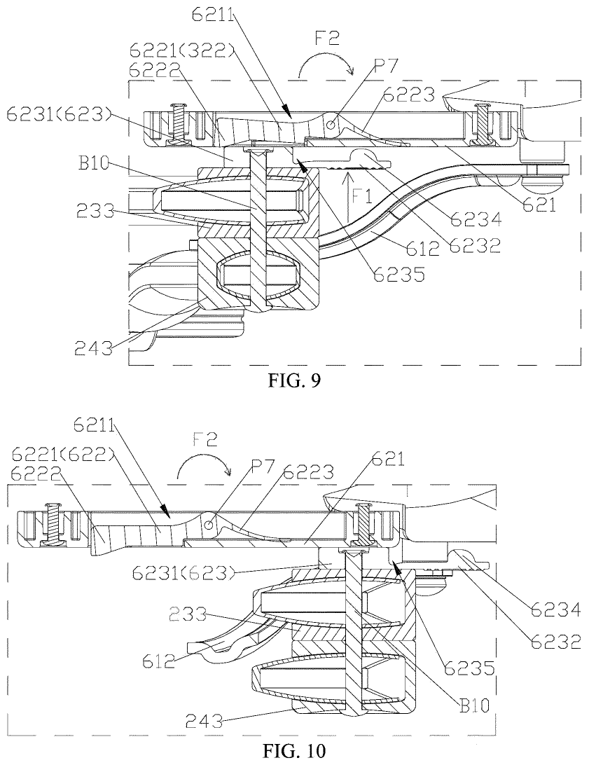

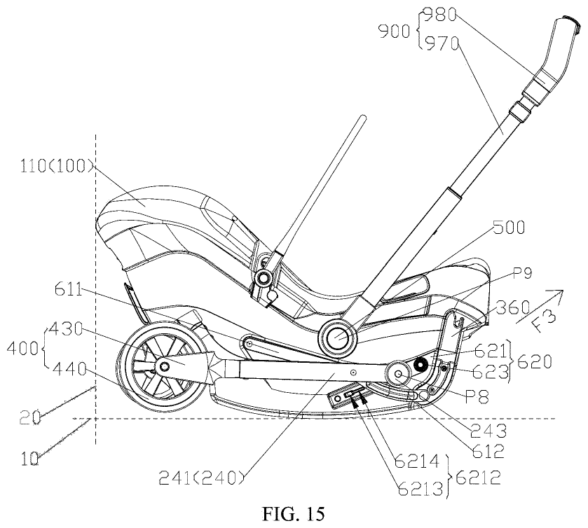

When there is a need to switch the frame 200 from the unfolded state to the folded state to switch the infant carrier from a usage mode of a baby stroller to a usage mode of a safety seat, a carry cot, or a baby rocker, as shown in FIG. 8, the operating portion 6232 of the fold button 623 may be first pressed along a direction F1, so that the push protrusion 6234 pushes against the locking body 6221 through the second opening portion 6214, the first locking member 622 rotates in a direction F2 as a whole around the second pivot point P2, the locking protrusion 6222 is disengaged from the locking recess 6235, and the locking assembly 620 is in the unlocked state. As shown in FIG. 9 and FIG. 10, in this case, since the locking protrusion 6222 exits the sliding path, the fold button 623 and the holder 621 are slidable relative to each other, and then the first connecting base 233 and the seat assembly 100 are also slidable relative to each other. In this case, the elastic arm 6223 is elastically deformed. As shown in FIG. 11 to FIG. 14, in this case, the fold button 623 slides along a direction F3 relative to the holder 621. At the same time, since the first connecting base 233 and the second connecting base 243 are both attached to the fold button 623, the first support rod 231 and the second support rod 241 (i.e., the first support frame 230 and the second support frame 240) can be driven to rotate in a direction F4 at the same time through linkage of the first linkage rod 611 and the second linkage rod 612. At the same time, the first support rod 231 and the second support rod 241 also slide in the direction F3 relative to the holder 621. As shown in FIG. 15, when the first support rod 231 and the second support rod 241 are rotated and folded in place, the first support rod 231 and the second support rod 241 are in a parallel and substantially overlapping state, and at the same time, a wheel assembly 400 (denoted as a front wheel assembly 400) connected to the first support frame 230 and a wheel assembly 400 (denoted as a rear wheel assembly 400) connected to the second support frame 240 are also in a parallel and substantially overlapping state. Each wheel assembly 400 includes a wheel mounting frame 430 and a wheel body 440. It is to be noted that the overlapping referred to herein may include a case where centers of the front wheel body 430 and the rear wheel body 430 overlap, or a case where an axial projection of the front wheel body 430 is within a range of an axial projection of the rear wheel body 430 or the axial projection of the rear wheel body 430 is within a range of the axial projection of the front wheel body 430, or include a case where the center of the front wheel body 430 is within the axial projection of the rear wheel body 430 or the center of the rear wheel body 430 is within the axial projection of the front wheel body 430. Specifically, a length of the second connecting assembly 242 is greater than that of the first connecting assembly 232, so that a distance between the two second support rods 241 is greater than that between the two first support rods 231. Therefore, when the frame 200 is in the folded state, the first support rod 231 and the second support rod 241, the front wheel assembly 400, and the rear wheel assembly 400 can all be in a substantially overlapping state. Moreover, during the folding, the frame 200 also moves backwards as a whole relative to the seat assembly 100, and the pivot point of the frame 200 and the seat assembly 100, that is, the first pivot point P1, moves upwards relatively. The center of the front wheel body 430 (or the center of the rear wheel body 430) is substantially on a same horizontal plane as the pivot point of the frame 200 and the seat assembly 100, and a line connecting the center of the front wheel body 430 (or the center of the rear wheel body 430) and the pivot point of the frame 200 and the seat assembly 100 is parallel to the horizontal reference plane 10. In this way, a rotation angle range of the first support frame 230 and the second support frame 240 during the unfolding and the folding is smaller, and an overall volume of the folded infant carrier is smaller, thereby reducing transportation costs, facilitating carrying in the mode of the carrier, and being conducive to use in the baby rocker mode or the safety seat mode. At the same time, as shown in FIG. 16, the second connecting assembly 242 of the second support frame 240 is engaged with the fold limiting part 120 at the bottom of the seat 110, thereby locking the frame 200 in the folded state to prevent automatic unfolding of the frame 200 under unexpected circumstances.

As shown in FIG. 15, since the folded frame 200 is at a relatively lower position on an outer side of the seat assembly 100 and an ISOFIX connector 360 rotatably arranged on the outer side of the seat assembly 100 is at a relatively upper position, the folded frame 200 may not interfere with unfolding and folding of the ISOFIX connector 360 and engagement with a car seat.

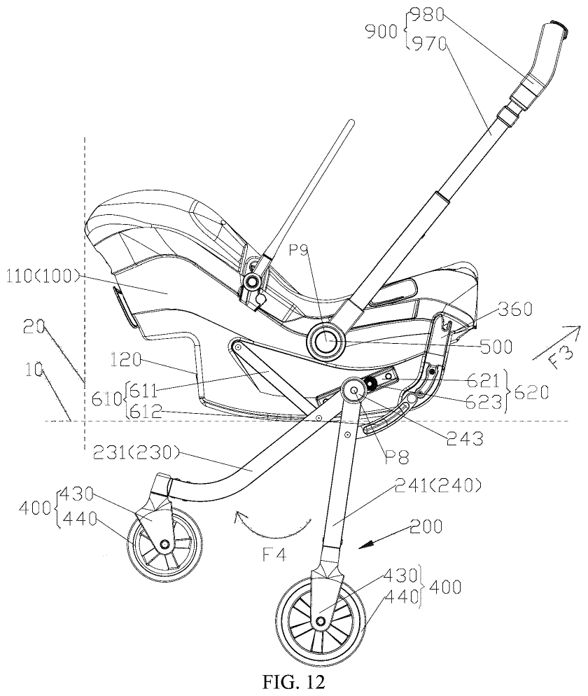

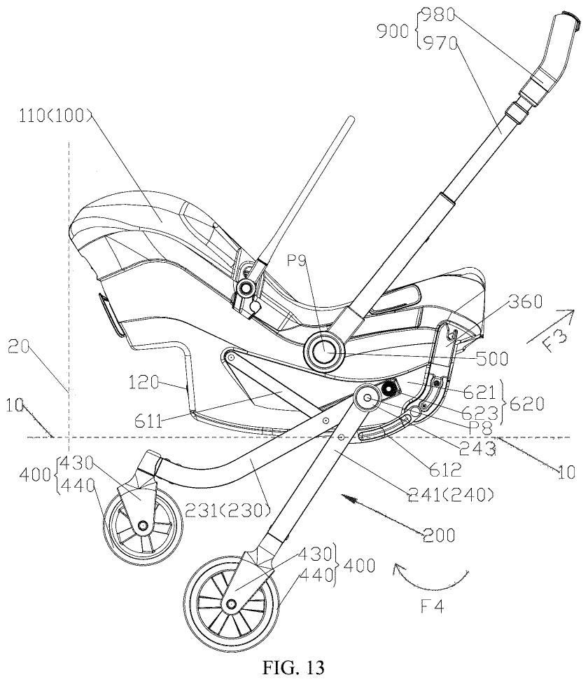

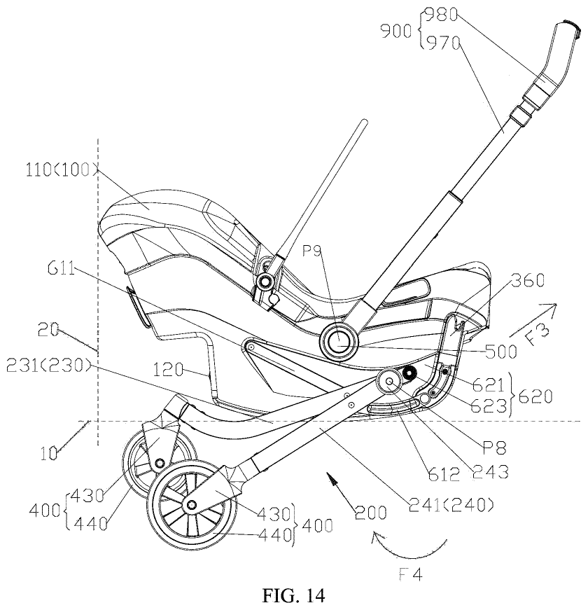

When there is a need to switch the frame 200 from the folded state to the unfolded state to switch the infant carrier from the usage mode of the safety seat, the carry cot, or the baby rocker to the usage mode of the baby stroller, as shown in FIG. 16, the second connecting assembly 242 may be manually pulled, so that the second connecting assembly 242 deforms to be detached from limiting and fixation of the fold limiting part 120. As shown in FIG. 15 and FIG. 14, both the first support frame 230 and the second support frame 240 rotate in a direction opposite to F4. As shown in FIG. 13 and FIG. 12, during the unfolding, the first support frame 230 and the second support frame 240 also drive the fold button 623 to move in a direction opposite to the direction F3 relative to the holder 621. As shown in FIG. 10, FIG. 9, and FIG. 8, during the sliding of the fold button 623, the connecting portion 6231 may move across the locking protrusion 6222 to a left side of the locking protrusion 6222, and the locking protrusion 6222 of the third locking member 622 may be re-engaged with the locking recess 6235 of the fold button 623, thereby locking the frame 200 in the unfolded state, to prevent unlocking of the frame 200 under unexpected circumstances after unfolding. Specifically, prior to the folding, the locking protrusion 6222 is on the sliding path of the fold button 623, and during the folding, the limiting step 6236 of the fold button 623 (through an inclined surface 6222a on the locking protrusion 6222) pushes the locking protrusion 6222, so that the third locking member 622 can pivot and the locking protrusion 6222 can cross the limiting step 6236.

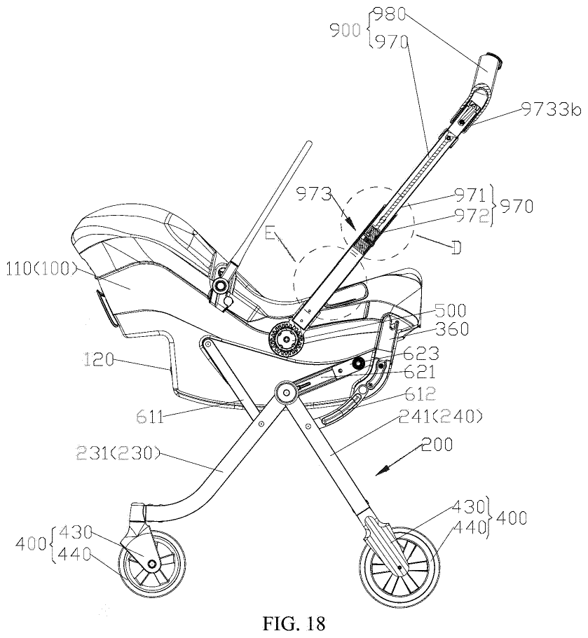

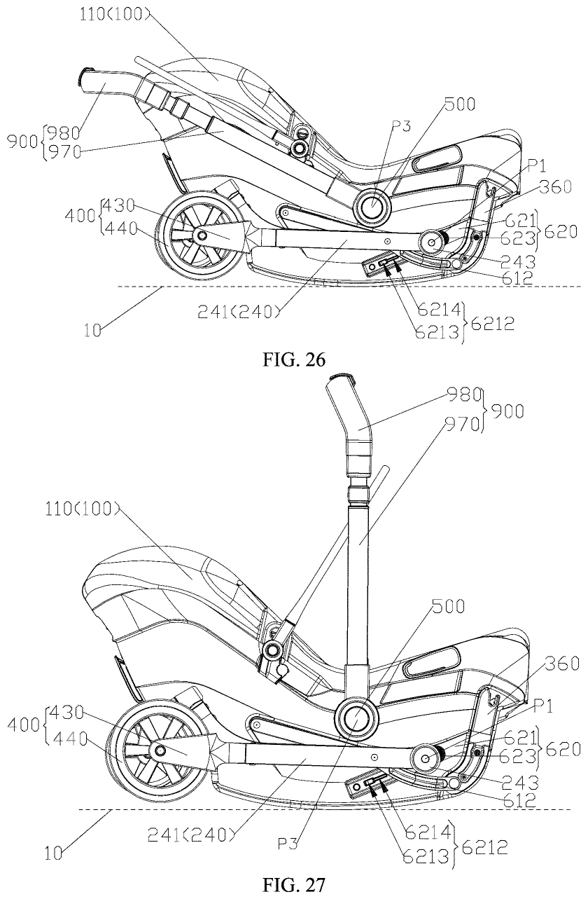

Further, as shown in FIG. 18, the movable assembly 900 is mounted on the seat assembly 100 to facilitate a user to move the infant carrier. When the frame is in the unfolded state and the infant carrier is in the usage mode of the baby stroller, the movable assembly 900 may be used as a handlebar of the infant carrier. When the frame is in the folded state as shown in FIG. 15, FIG. 26, and FIG. 27 and the infant carrier is in the usage mode of the safety seat, the carry cot, or the baby rocker, the movable assembly 900 is used as a push rod of the safety seat or a handle of the carry cot, or is folded behind the baby rocker.

As shown in FIG. 1, the movable assembly 900 has a roughly U-shaped rod structure, including a movable body 980 and a movable rod 970 connected to two ends of the movable body 980. In order to adapt to usage habits in different situations, lengths of the two movable rods 970 are adjustable. One of the movable rods 970 is taken as an example below to illustrate a specific structure thereof.

As shown in FIG. 18, the movable rod 970 includes a first rod part 971, a second rod part 972, and a length adjustment mechanism 973. The first rod part 971 is partially inserted into the second rod part 972, the length adjustment mechanism 973 is arranged between the first rod part 971 and the second rod part 972, and a length of the first rod part 971 inserted into the second rod part 972 may be adjusted through the length adjustment mechanism 973. In this embodiment, the first rod part 971 and the second rod part 972 both have a hollow rod structure. Certainly, in other embodiments, the first rod part 971 and the second rod part 972 may alternatively have a partially hollow rod structure. In this embodiment, the first rod part 971 is connected to the movable body 980, and an end of the second rod part 972 away from the first rod part 971 is pivotally connected to the seat body 111 of the seat 110 at a third pivot point P3. In other embodiments, positions of the first rod part 971 and the second rod part 972 are also interchangeable. The third pivot point P3 and the first pivot point P1 are not at a same position. That is, the third pivot point P3 and the first pivot point P1 are spaced apart.

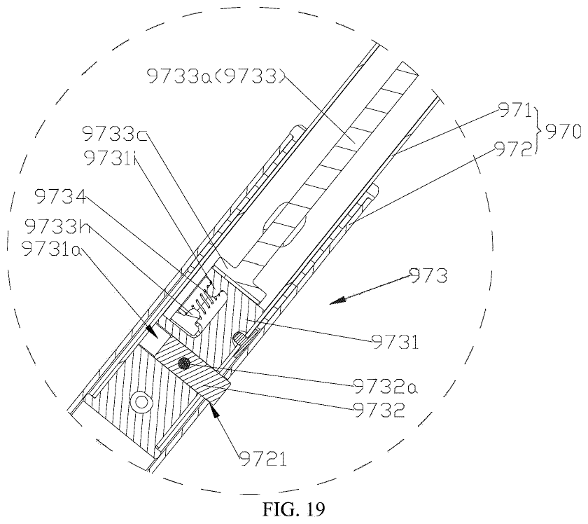

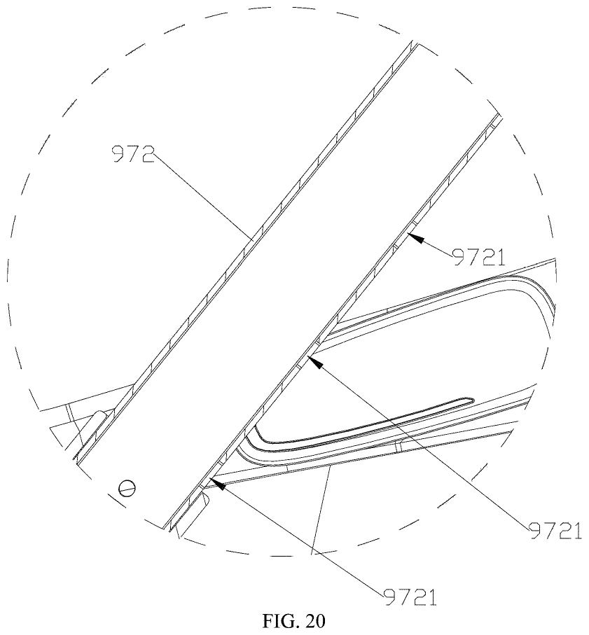

Specifically, as shown in FIG. 19 and FIG. 20, the length adjustment mechanism 973 includes a fixed plug 9731, a locking pin 9732, an operating assembly 9733, and a first reset member 9734. The fixed plug 9731, at least part of the locking pin 9732, the operating assembly 9733, and the first reset member 9734 are all arranged on the first rod part 971, and the second rod part 972 is sequentially provided with a plurality of locking holes 4241 along a length direction thereof. The locking pin 9732 has a first lock position and a first unlock position. The locking pin 9732, when located at the first lock position, can be inserted into and engaged with one of the plurality of locking holes 4241, and the locking pin 9732, when located at the first unlock position, can be disengaged from the one of the plurality of locking holes 4241, thereby realizing relative fixing or relative sliding between the first rod part 971 and the second rod part 972.

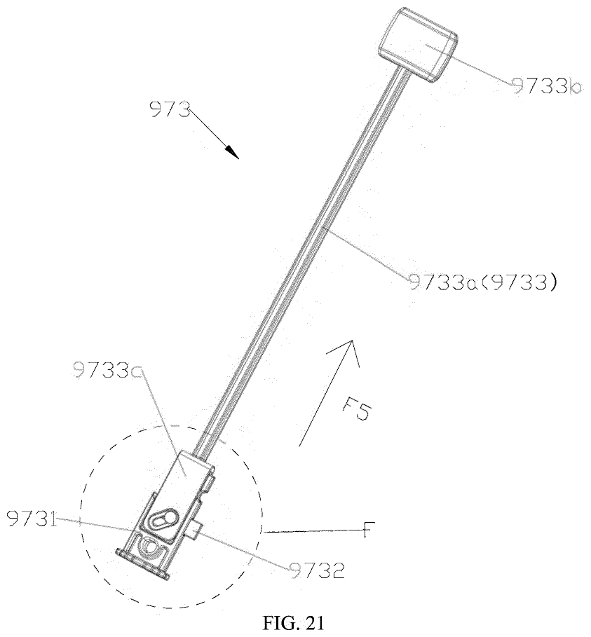

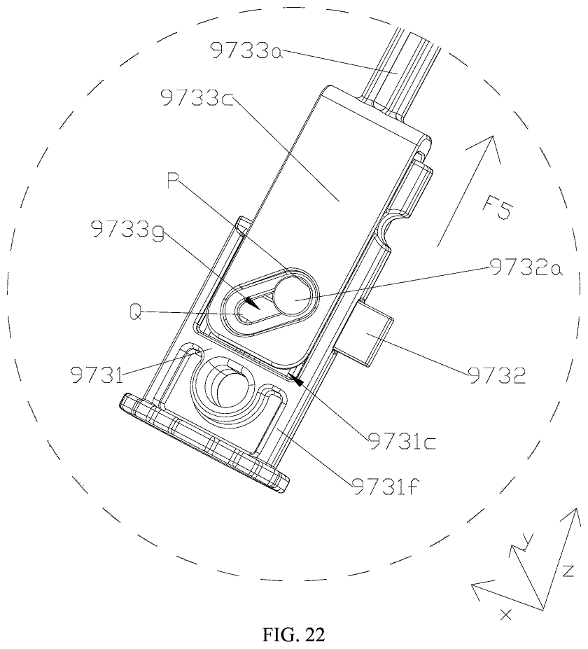

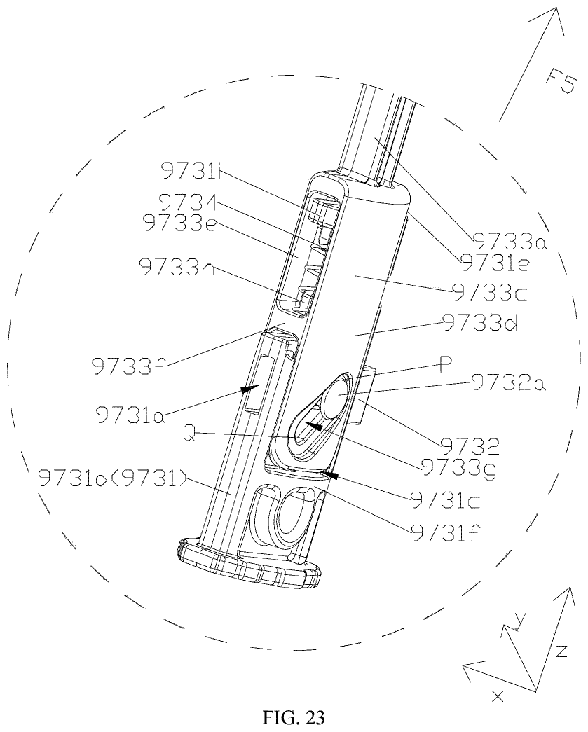

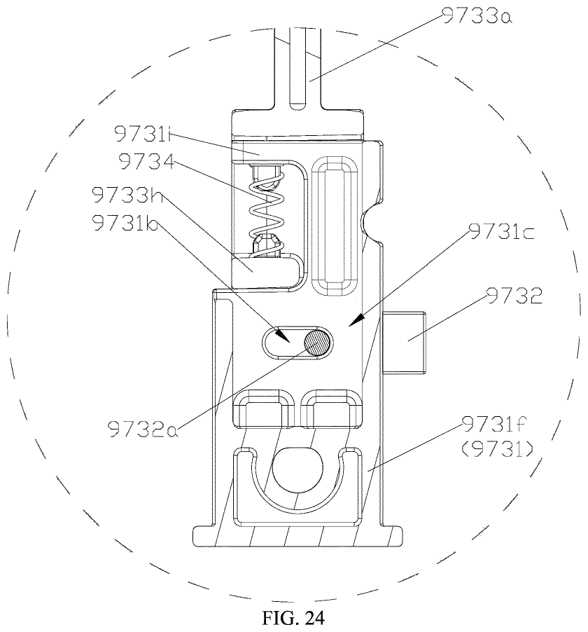

Specifically, as shown in FIG. 21 to FIG. 24, the fixed plug 9731 is fixedly arranged in the first rod part 971 and close to a lower end of the first rod part 971. The fixed plug 9731 has a roughly cuboid structure. For the convenience of description, a structure of the fixed plug 9731 is described below in a Cartesian coordinate system. The fixed plug 9731 is provided with a first through hole 9731a, a second through hole 9731b, and a third sliding groove 9731c. As shown in FIG. 23, the first through hole 9731a passes through a first side 9731d and a second side 9731e of the fixed plug 9731 along an x-axis direction, the locking pin 9732 is movably arranged in the first through hole 9731a, and at least part of the locking pin 9732 can extend out of the first through hole 9731a and engage with one of the plurality of locking holes 4241. Certainly, in other embodiments, the first through hole 9731amay alternatively pass through only the first side 9731d or the second side 9731e of the fixed plug 9731. As shown in FIG. 24, the second through hole 9731b passes through a third side 9731f and a fourth side of the fixed plug 9731 along a y-axis direction, and the second through hole 9731b is in communication with the first through hole 9731a. A cross-sectional shape of the second through hole 9731b on the third side 9731f and the fourth side is along the x-axis direction. The locking pin 9732 is provided with a driving post 9732a, the driving post 9732a is inserted into the second through hole 9731b, and at least part of the driving post 9732a can extend out of the second through hole 9731b. The third side 9731f and the fourth side (not shown) of the fixed plug 9731 that are opposite to each other are each provided with a third sliding groove 9731c extending along a z-axis direction, and two ends of the second through hole 9731b pass through groove walls of the two third sliding grooves 9731c respectively. That is, the third sliding groove 9731c is in communication with the first through hole 9731a and the second through hole 9731b respectively. To sum up, the third sliding groove 9731c, the first through hole 9731a, and the second through hole 9731b are all in communication and have intersecting extension directions.

Further, as shown in FIG. 18 and FIG. 21, the operating assembly 9733 is operable to drive the locking pin 9732 to move in a direction of disengagement from the one of the plurality of locking holes 4241. The operating assembly 9733 includes a pull rod 9733a and a length adjustment operating member 9733b and a driving plug 9733c respectively arranged at two ends of the pull rod 9733a. In this embodiment, the length adjustment operating member 9733b is an adjustment slider slidable along the first rod part 971, and the length adjustment operating member 9733b is at least partially located outside the first rod part 971 for operation.

As shown in FIG. 23, the driving plug 9733c has a roughly cuboid shell structure, and includes a first housing portion 9733d and a second housing portion 9733e arranged opposite to each other, and a connecting housing portion 9733f connected between the first housing portion 9733d and the second housing portion 9733e. The first housing portion 9733d and the second housing portion 9733e are both provided with opposite and overlapping driving chutes 9733g. The first housing portion 9733d and the second housing portion 9733e may be respectively inserted into the third sliding grooves 9731c on the third side 9731f and the fourth side and move back and forth along the z-axis direction. At least part of the driving post 9732a can extend out of the second through hole 9731b and be inserted into the driving chute 9733g. The driving post 9732a can move along the driving chute 9733g.

As shown in FIG. 23, when the driving post 9732a moves to a position P along the driving chute 9733g, the locking pin 9732 moves to the first lock position, the locking pin 9732 can be inserted into one of the plurality of locking holes 4241, and the first rod part 971 and the second rod part 972 are relatively fixed. When the length adjustment operating member 9733b is moved parallel to the z-axis in a direction F5 and the length adjustment operating member 9733b drives, through the pull rod 9733a, the driving plug 9733c to move together along the direction F5, the driving post 9732a moves along the driving chute 9733g to a position Q. In this case, the locking pin 9732 moves to the first unlock position, the locking pin 9732 is disengaged from the corresponding locking hole 4241, and the first rod part 971 and the second rod part 972 can move relative to each other.

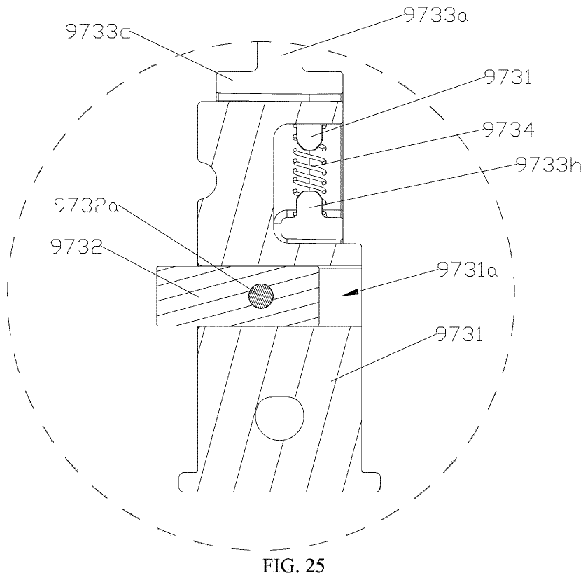

Further, as shown in FIG. 23 and FIG. 25, two ends of the first reset member 9734 abut against the fixed plug 9731 and the driving plug 9733c respectively, and the first reset member 9734 constantly causes the driving plug 9733c to move along a direction opposite to F5. That is, the first reset member 9734 constantly causes the driving plug 9733c to move in a direction where the locking pin 9732 is driven to move to the first lock position. Specifically, a first pushing portion 9731i may be arranged on the fixed plug 9731, a second pushing portion 9733h may be arranged on the driving plug 9733c, and the first pushing portion 9731i is closer to the length adjustment operating member 9733b than the second pushing portion 9733h. The two ends of the first reset member 9734 abut against the first pushing portion 9731i and the second pushing portion 9733h respectively. In this embodiment, the first reset member 9734 is a spring.

A length adjustment process of the movable rod 970 is explained in detail below.

Firstly, as shown in FIG. 18 to FIG. 21, the length adjustment operating member 9733b is moved along the direction F5, the length adjustment operating member 9733b drives, through the pull rod 9733a, the driving plug 9733c to move together along the direction F5, the driving post 9732a moves from the position P to the position Q under the action of the driving chute 9733g, and simultaneously drives the locking pin 9732 to move from the first lock position to the first unlock position, and the locking pin 9732 originally inserted into one locking hole 4241 exits the locking hole 4241. The first rod part 971 and the second rod part 972 are relatively movable. In this case, the first reset member 9734 is compressed. Then, the first rod part 971 may be moved relative to the second rod part 972 to adjust the movable rod 970 to an appropriate length. In this case, an external force applied to the length adjustment operating member 9733b can be canceled, and the driving plug 9733c may be reset in the direction opposite to F5 under an elastic force of the first reset member 9734. Then, the driving post 9732a moves from the position Q to the position P again under the action of the driving chute 9733g, and simultaneously drives the locking pin 9732 to move from the first unlock position to the first lock position, the locking pin 9732 is re-inserted into another locking hole 4241, and the first rod part 971 and the second rod part 972 are relatively fixed. In this way, the length adjustment process of the movable rod 970 is completed. The length adjustment process of the other movable rod 970 is the same. Overall length adjustment of the movable assembly 900 can be realized by operating the length adjustment operating members 9733b on the two movable rods 970 at the same time.

Certainly, in other embodiments, reversely, the fixed plug 9731, at least part of the locking pin 9732, the operating assembly 9733, and the first reset member 9734 are all arranged on the second rod part 972, and the first rod part 971 is sequentially provided with a plurality of locking holes 4241 along a length direction thereof. In short, it is feasible as long as relative movement and relative fixation of the first rod part 971 and the second rod part 972 can be realized.

Further, an angle adjustment mechanism 500 is further arranged between the seat assembly 100 and the movable assembly 900. The angle adjustment mechanism 500 is configured to adjust an inclination angle of the movable assembly 900 relative to the seat assembly 100. As shown in FIG. 15, when the infant carrier is used as a safety seat, the movable assembly 900 may rotate to a relative front side of the seat 110 to serve as a push rod of the safety seat. As shown in FIG. 26, when the infant carrier is used as a baby rocker, the movable assembly 900 may rotate to a relative rear side of the seat 110. As shown in FIG. 27, when the infant carrier is used as a carry cot, the movable assembly 900 may rotate to a relative middle portion of the seat 110 to serve as a carrying handle of the carrier.

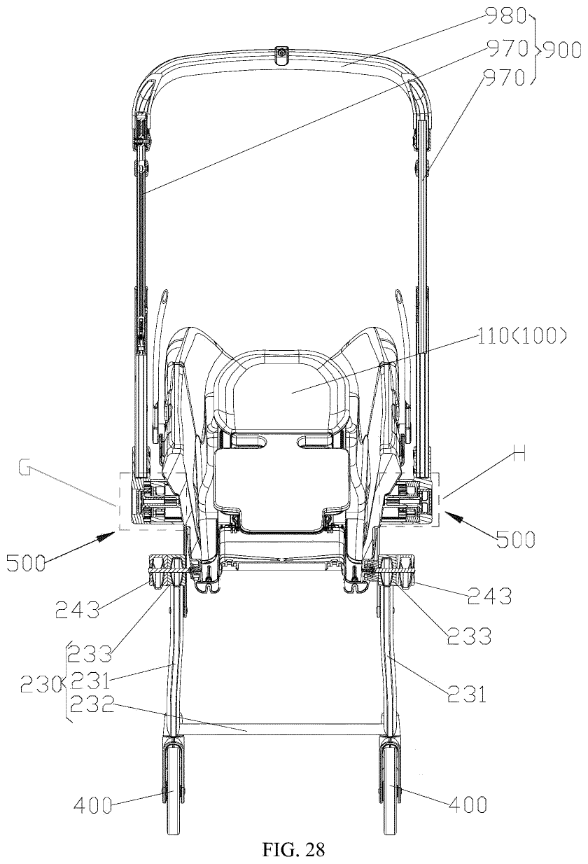

Specifically, as shown in FIG. 28 to FIG. 30, the angle adjustment mechanism 500 includes a movable connecting base 510, a seat connecting base 520, a third locking part 530, an angle adjustment operating member 540, and a second reset member 550. The movable connecting base 510 is fixedly connected to the movable assembly 900, and has a first locking part 511. Specifically, the movable connecting base 510 is roughly in a shape of a disk, a first fitting groove 512 is arranged in a substantially middle portion of the movable connecting base 510, and at least part of the first fitting groove 512 is a gear groove. The part of the first fitting groove 512 is the first locking part 511. The seat connecting base 520 is fixedly connected to the seat assembly 100, and has a second locking part 521. Specifically, the seat connecting base 520 is roughly in a shape of a disk having a same size as the movable connecting base 510, and a second fitting groove 522 is arranged in a substantially middle portion of the seat connecting base 520. The second fitting groove 522 is a non-penetrating groove and is in communication with the first fitting groove 512. In this embodiment, at least part of the second fitting groove 522 is a gear groove, and the part of the second fitting groove 522 is the second locking part 521. The movable connecting base 510 and the seat connecting base 520 are pivotally connected to each other through a second pivot shaft B20.

Further, a third locking part 530 is movably arranged between the movable connecting base 510 and the seat connecting base 520, and the third locking part 530 has a second lock position and a second unlock position. When the third locking part 530 is at the second lock position, the third locking part 530 is locked and engaged with the first locking part 511 and the second locking part 521 at the same time, so that the movable connecting base 510 and the seat connecting base 520 are relatively fixed. When the third locking part 530 is at the second unlock position, the third locking part 530 may be disengaged from one of the first locking part 511 and the second locking part 521, so that the movable connecting base 510 is rotatable relative to the seat connecting base 520. In this embodiment, the third locking part 530 is a locking gear, the locking gear is movable between first fitting groove 512 and the second fitting groove 522, and the locking gear can be engaged with a gear groove of the first fitting groove 512 and a gear groove of the second fitting groove 522 separately or engaged with both the gear groove of the first fitting groove 512 and the gear groove of the second fitting groove 522.

Further, the angle adjustment operating member 540 is drivingly connected to the third locking part 530, and the angle adjustment operating member 540 is operable to drive the third locking part 530 to move towards the second unlock position. Specifically, the angle adjustment operating member 540 is an adjustment button. The adjustment button is movably arranged in the first fitting groove 512 and abuts against the third locking part 530. In this way, when the user puts a hand into the first fitting groove 512 and presses an end of the angle adjustment operating member 540 away from the third locking part 530, the third locking part 530 may be driven to move towards the second unlock position.

Further, two ends of the second reset member 550 respectively abut against the third locking part 530 and the seat connecting base 520, and the second reset member 550 constantly causes the third locking part 530 to move in a direction where the third locking part moves towards the second lock position. Specifically, the second reset member 550 is a spring and sleeves the second pivot shaft B20. At least part of the second reset member 550 is located in the first fitting groove 512. The second reset member 550 has one end abutting against the bottom of the second fitting groove 522 and the other end abutting against the third locking part 530.

An angle adjustment process of the movable assembly 900 is described below.

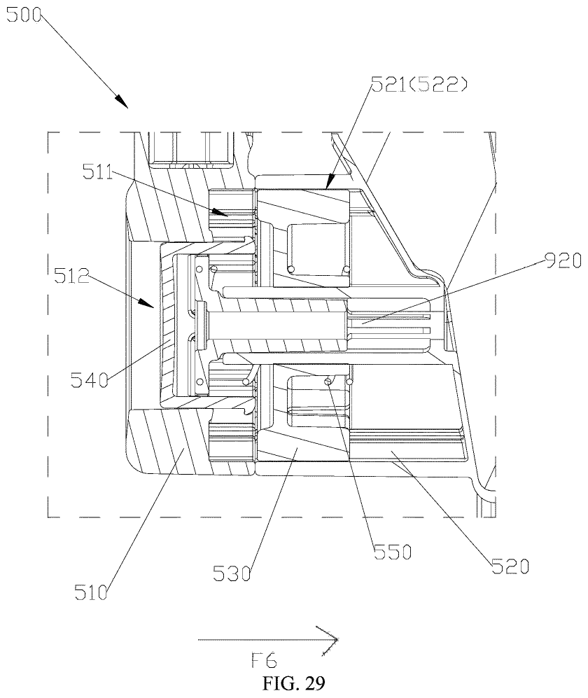

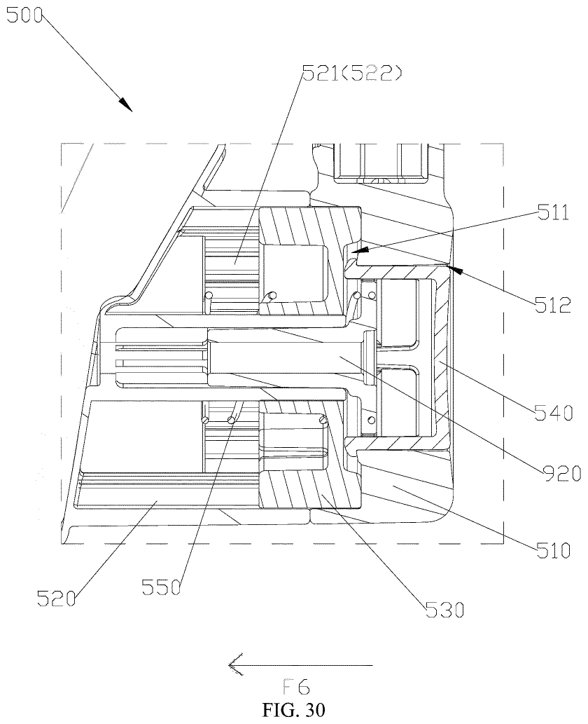

Firstly, as shown in FIG. 29, the angle adjustment operating member 540 is pressed in a direction F6, and the angle adjustment operating member 540 pushes against the third locking part 530 to move from the second lock position to the second unlock position, causing the second reset member 550 to deform. As shown in FIG. 30, at the same time, the third locking part 530 is only engaged with the second locking part 521, and the movable connecting base 510 can rotate relative to the seat connecting base 520. In this case, the movable connecting base 510 can be rotated to adjust the movable assembly 900 to an appropriate inclination angle. After completion of the adjustment, an external force applied to the angle adjustment operating member 540 can be canceled, and the third locking part 530 can be reset from the second unlock position to the second lock position in a direction opposite to F6 under an elastic force of the second reset member 550, as shown in FIG. 29. That is, the third locking part 530 is re-engaged with both the first locking part 511 and the second locking part 521, the movable connecting base 510 and the seat connecting base 520 are relatively fixed, and the movable assembly 900 is fixed at a new inclination angle. At the same time, the third locking part 530 pushes against the angle adjustment operating member 540 to reset. In this way, the angle adjustment of the movable assembly 900 can be realized through a simple structure, which is easy to operate.

Further, as shown in FIG. 1, the first support frame 230 and the second support frame 240 are both provided with a wheel assembly 400 at one end away from the seat assembly 100. In this embodiment, four wheel assemblies 400 are provided. Two of the wheel assemblies 400 are respectively connected to bottom ends of the two first support rods 231, both of which are front wheel assemblies 400. The other two of the wheel assemblies 400 are respectively connected to bottom ends of the two second support rods 241, both of which are rear wheel assemblies 400. Each wheel assembly 400 includes a wheel mounting frame 430 and a wheel body 440. The wheel mounting frame 430 is connected to the frame 200. Specifically, the wheel mounting frames 430 of the two front wheel assemblies 400 are connected through the first connecting assembly 232. The wheel mounting frames 430 of the two rear wheel assemblies 400 are connected through the second connecting assembly 242. The wheel body 440 is rotatably mounted on the wheel mounting frame 430.

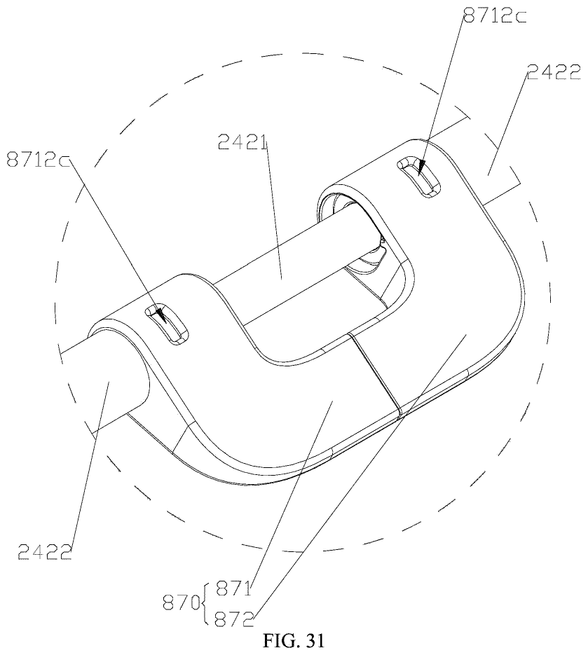

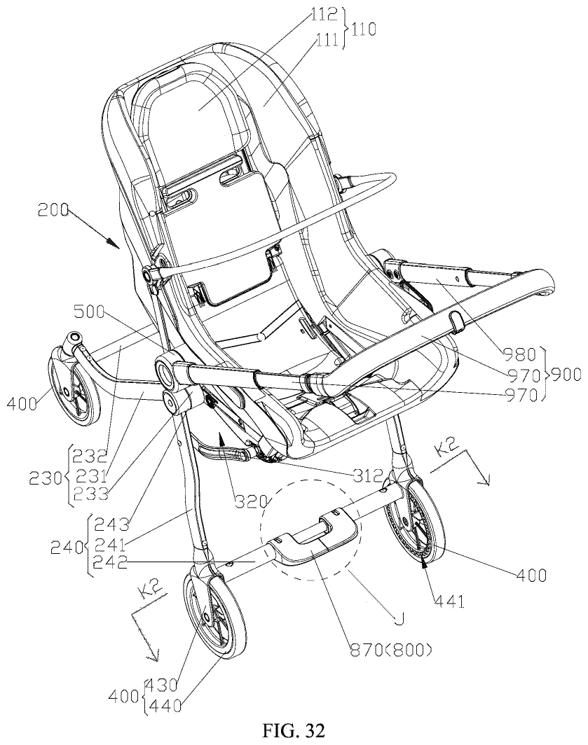

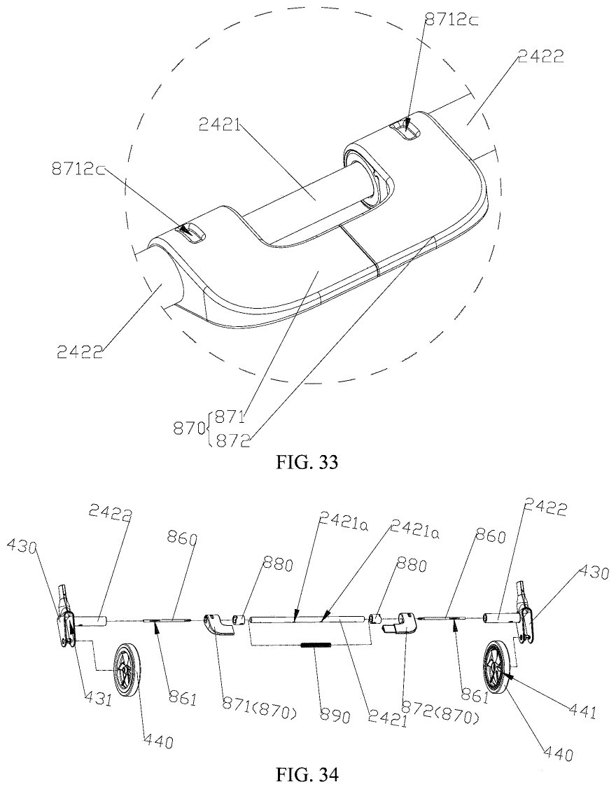

Further, the braking mechanism 800 is arranged between the frame 200 and the wheel assembly 400, and has a braking state (as shown in FIG. 1 and FIG. 31) where rotation of the wheel assembly 400 is prevented and an unbraking state (as shown in FIG. 32 and FIG. 33) where rotation of the wheel assembly 400 is allowed. In this embodiment, the braking mechanism 800 is arranged between the second connecting assembly 242 and the two rear wheel assemblies 400. Certainly, in other embodiments, the braking mechanism 800 may alternatively be arranged between the first connecting assembly 232 and the two front wheel assemblies 400, or the braking mechanism 800 may be arranged between the first connecting assembly 232 and the two front wheel assemblies 400 and between the second connecting assembly 242 and the two rear wheel assemblies 400, or the braking mechanism 800 is arranged between the second connecting assembly 242 and one of the rear wheel assemblies 400 or one of the front wheel assemblies 400.

Specifically, as shown in FIG. 34, the braking mechanism 800 includes a brake rod 860, a brake operating member 870, a brake pushing member 880, and a third reset member 890.

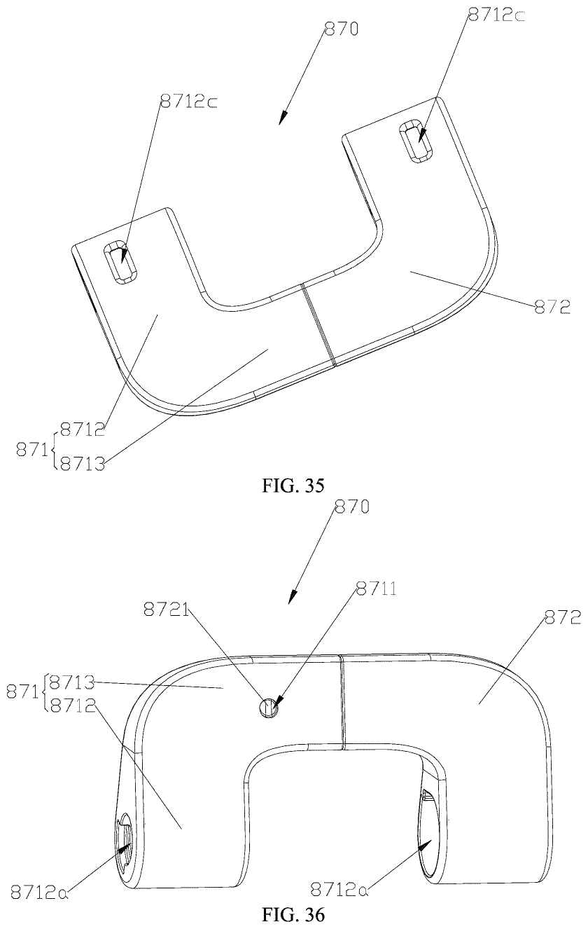

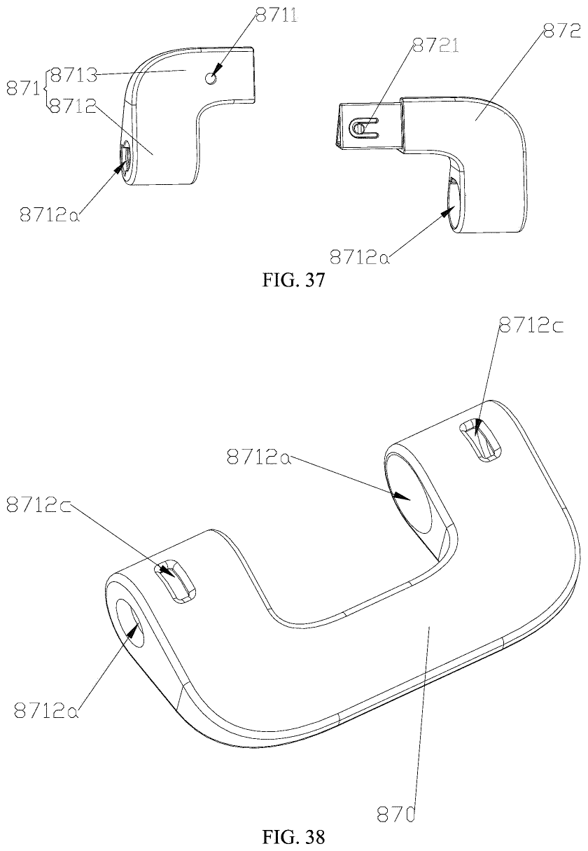

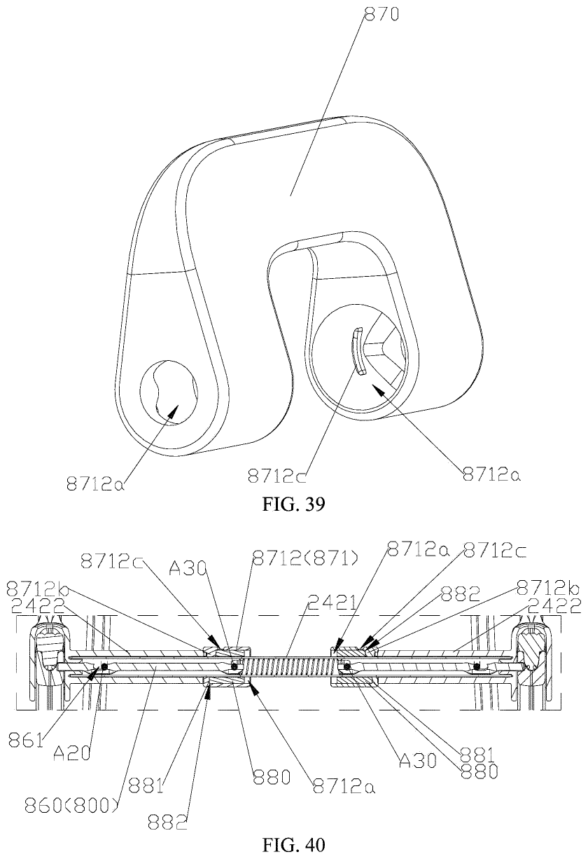

As shown in FIG. 34, two brake rods 860 are provided and are respectively movably arranged in the connecting rod 2421. The brake operating member 870 is a brake pedal, and includes a first pedal 871 and a second pedal 872 connected to each other. In this embodiment, as shown in FIG. 35 to FIG. 37, the first pedal 871 is provided with a fixed hole 8711, and the second pedal 872 is provided with an elastic finger 8721. The connection between the first pedal 871 and the second pedal 872 can be realized by engagement of the elastic finger 8721 with the fixed hole 8711. Certainly, in other embodiments, the first pedal 871 and the second pedal 872 may alternatively be connected in other manners, or the brake operating member 870 may be integrally formed, as shown in FIG. 38 and FIG. 39. Two brake pushing members 880 are provided and respectively sleeve the connecting rod 2421. At the same time, the first pedal 871 and the second pedal 872 sleeve the two brake pushing members 880 respectively. The two brake rods 860 are fixedly connected to the two brake pushing members 880 respectively. In this embodiment, the third reset member 890 is a spring. The third reset member 890 is arranged in the connecting rod 2421 and abuts against the two brake pushing members 880 respectively.

An overall structure of the braking mechanism 800 is a substantially symmetrical structure bounded by a junction between the first pedal 871 and the second pedal 872. A structure on one side of the first pedal 871 is taken as an example below to describe the specific structure of the braking mechanism 800.

As shown in FIG. 40, the brake rod 860 is arranged close to one end of the connecting rod 2421, that is, close to a connecting sleeve 2422 on a corresponding side. The brake rod 860 is provided with a first strip hole 861, and the first strip hole 861 extends along a length direction of the connecting rod 2421. A first pin A20 passes through the connecting rod 2421 and the connecting sleeve 2422 and is arranged through the first strip hole 861 of the brake rod 860. In this way, through interaction between the first pin A20 and the first strip hole 861, the movement of the brake rod 860 along the length direction of the connecting rod 2421 can be limited, and a movement stroke thereof can be limited.

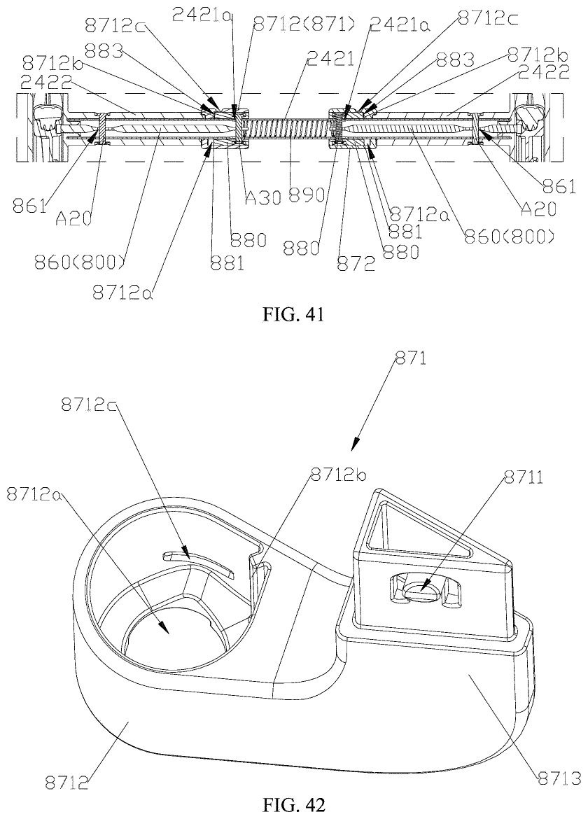

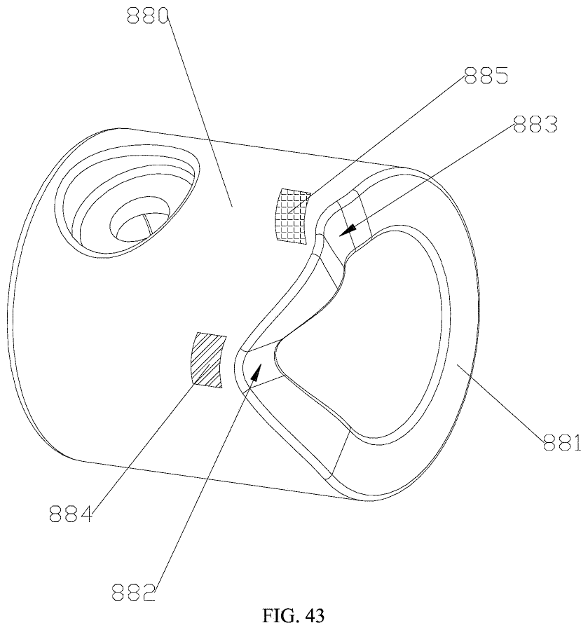

Further, as shown in FIG. 34, the wheel body 440 is circumferentially provided with a plurality of first brake holes 441 that can fit the brake rod 860, and the wheel mounting frame 430 is provided with a communication hole 431 that can be opposite to and in communication with one of the plurality of first brake holes 441. The connecting sleeve 2422 is fastened to the wheel mounting frame 430 and can be in communication with one of the plurality of first brake holes 441 through the communication hole 431 in the wheel mounting frame 430. The brake rod 860 has a third lock position and a third unlock position. When the brake rod 860 is at the third lock position, as shown in FIG. 40, the brake rod 860 can pass through the communication hole 431 and be inserted into and engaged with one of the plurality of first brake holes 441, thereby preventing rotation of the wheel body 440. When the brake rod 860 is at the third unlock position, as shown in FIG. 41, the brake rod 860 can pass through the communication hole 431 and be disengaged from the one of the plurality of first brake holes 441, thereby allowing rotation of the wheel body 440.

Further, as shown in FIG. 35, the first pedal 871 has a roughly L-shaped structure and includes a sleeving portion 8712 and a pedaling portion 8713 connected to each other. In this embodiment, the first pedal 871 has an integrally formed structure. Certainly, in other embodiments, the first pedal 871 may alternatively be formed by connecting the sleeving portion 8712 and the pedaling portion 8713 independent of each other by welding or the like. As shown in FIG. 72, the sleeving portion 8712 is provided with a cylindrical mounting cavity 8712a, and a first engaging portion is arranged in the mounting cavity 8712a. In this embodiment, the first engaging portion is a pushing rib 8712b. The sleeving portion 8712 is further provided with a display window 8712c that can be in communication with the mounting cavity 8712a. The pedaling portion 8713 is configured for the user to pedal. In this embodiment, the first pedal 871 and the second pedal 872 have a roughly U-shaped structure after being engaged and connected.

Further, as shown in FIG. 43, the brake pushing member 880 has a roughly cylindrical structure, and one end of the brake pushing member 880 is an engaging end 881. The engaging end 881 is provided with a second engaging portion and a third engaging portion that can fit the first engaging portion. In this embodiment, the second engaging portion and the third engaging portion are respectively a braking groove 882 and a positioning groove 883 that can fit the pushing rib 8712b. The braking groove 882 is deeper than the positioning groove 883. That is, a base of the braking groove 882 is away from an outer edge of the engaging end 881 relative to a base of the positioning groove 883. An outer wall of the brake pushing member 880 is also provided with a first identifier 884 and a second identifier 885. The first identifier 884 is arranged close to the braking groove 882, and the second identifier 885 is arranged close to the positioning groove 883. The first identifier 884 may be, for example, a red identifier, indicating that the wheel assembly 400 is in the braking state. The second identifier 885 may be, for example, a green identifier, indicating that the wheel assembly 400 is in the unbraking state. Certainly, in other embodiments, the first identifier 884 and the second identifier 885 may alternatively be in other forms, as long as they can be easily distinguished.

Further, as shown in FIG. 40 and FIG. 41, the brake pushing member 880 sleeves the connecting rod 2421, and the engaging end 881 of the brake pushing member 880 faces the wheel body 440 on the corresponding side. That is, a base of the braking groove 882 is away from the wheel body 440 on the corresponding side relative to a base of the positioning groove 883. The connecting rod 2421 is provided with a second strip hole 2421a, and a second pin A30 is arranged through the brake pushing member 880, the second strip hole 2421a, and the brake rod 860, thereby fixedly connected the brake rod 860 to the brake pushing member 880, and at the same time, the brake pushing member 880 and the brake rod 860 as a whole can move along the length direction of the connecting rod 2421 relative to the connecting rod 2421. In this embodiment, the second strip hole 2421a has a same size as the first strip hole 861. Therefore, the first pin A20 and the second pin A30 can move synchronously with the brake rod 860. The sleeving portion 8712 of the first pedal 871 rotatably sleeves the brake pushing member 880. In other words, the brake pushing member 880 is arranged in the mounting cavity 8712a. The pushing rib 8712b in the mounting cavity 8712a is arranged opposite to the engaging end 881 of the brake pushing member 880, and is located on a side of the engaging end 881 close to the wheel assembly 400.

Further, the first pedal 871 or the brake operating member 870 is rotatable relative to the first connecting assembly 232. The first pedal 871 has a first rotate position and a second rotate position. When the first pedal 871 rotates to the first rotate position, as shown in FIG. 40, the first engaging portion is engaged with the second engaging portion, that is, the pushing rib 8712b is inserted into and engaged with the braking groove 882, the brake pushing member 880 moves until the brake rod 860 is at the third lock position, that is, the brake rod 860 moves to a position relatively close to the wheel body 440 and is inserted into one of the first brake holes 441, thereby causing the braking mechanism 800 to be in the braking state where rotation of the wheel body 440 is prevented. In this case, the first identifier 884 is exactly opposite to the display window 8712c, thereby prompting the user that the infant carrier has braked. When the second pedal 872 rotates to the second rotate position, as shown in FIG. 41, the first engaging portion is engaged with the third engaging portion, that is, the pushing rib 8712b is inserted into and engaged with the positioning groove 883, the brake pushing member 880 moves until the brake rod 860 is at the third unlock position, that is, the brake rod 860 moves to a position relatively away from the wheel body 440 and exits the one of the first brake holes 441, thereby causing the braking mechanism 800 to be in the unbraking state where rotation of the wheel body 440 is allowed. In this case, the second identifier 885 is exactly opposite to the display window 8712c, thereby prompting the user that the infant carrier has not braked.

Further, as shown in FIG. 40 and FIG. 41, the third reset member 890 is arranged in the connecting rod 2421 and abuts against the brake pushing member 880, and the third reset member 890 constantly causes the brake rod 860 to move towards the third lock position. In this embodiment, the third reset member 890 is a spring. The third reset member 890 is located in a substantially middle portion of the connecting rod 2421, with two ends abutting against the two brake pushing members 880 respectively.

An operating principle of the braking mechanism 800 is specifically described below.

When there is a need to release the braking, as shown in FIG. 1 and FIG. 31, the user may lift up the pedaling portion 8713 of the first pedal 871. Since the first pedal 871 and the second pedal 872 are connected, the pedaling portions 8713 of the first pedal 871 and the second pedal 872 are actually lifted up at the same time, so that the first pedal 871 rotates from the first rotate position to the second rotate position, as shown in FIG. 32 and FIG. 33. The pushing rib 8712b on the first pedal 871 is switched from fitting with the braking groove 882 of the brake pushing member 880 to fitting with the positioning groove 883, as shown in FIG. 41. Since the depth of the positioning groove 883 is less than that of the braking groove 882 and a position of the first pedal 871 in an extension direction of the connecting rod 2421 is fixed, the brake pushing member 880 moves in a direction away from the wheel body 440 and drives the brake rod 860 connected thereto to move from the third lock position to the third unlock position, the brake rod 860 exits one of the first brake holes 441, the braking mechanism 800 is in the unbraking state, and the wheel body 440 is rotatable. In this case, since the two brake pushing members 880 actually move towards each other, the third reset member 890 abutting between the two brake pushing members 880 is compressed and deformed. In this case, the second identifier 885 is aligned with the display window 8712c, thereby prompting the user that the infant carrier has not braked.

When braking is required, the process is reversed, and the user may pedal the pedaling portion 8713 of the first pedal 871 down, so that the first pedal 871 rotates from the second rotate position to the first rotate position, as shown in FIG. 1 and FIG. 31, the pushing rib 8712b on the first pedal 871 is switched from fitting with the positioning groove 883 of the brake pushing member 880 to fitting with the braking groove 882, and at the same time, the brake pushing member 880 moves towards the wheel body 440 under an elastic force of the third reset member 890, as shown in FIG. 40. At the same time, the brake pushing member 880 drives the brake rod 860 connected thereto to move from the third unlock position to the third lock position, the brake rod 860 is re-inserted into one of the first brake holes 441, the braking mechanism 800 is in the braking state, and the wheel body 440 cannot rotate.

The above infant carrier has at least the following technical effects.

In the infant carrier, the seat assembly 100 is mounted on the frame 200, and the frame 200 can be switched between the unfolded state and the folded state through the switching mechanism 600, thereby enabling the infant carrier to switch between usage modes such as in baby stroller and a safety seat, which has a simple structure and is easy to operate.

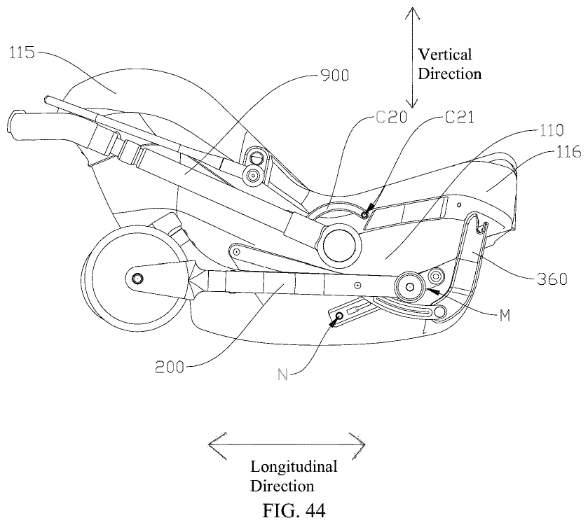

As shown in FIG. 44 to FIG. 47, another embodiment of the present disclosure provides an infant carrier. The infant carrier may include a carrying body 110, a movable assembly 900, and a frame 200. When the infant carrier is switched between usage modes, a switching structure of the movable assembly 900 thereof is simple and easy to operate.

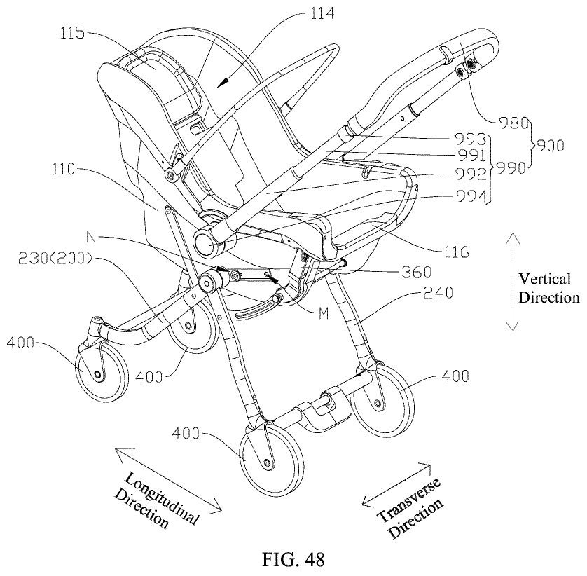

As shown in FIG. 48, the carrying body 110 has a carrying cavity 114 configured to carry an infant. Two ends of the carrying body 110 in a longitudinal direction are respectively a headrest portion 115 and a legrest portion 116. The movable assembly 900 has a roughly U-shaped rod structure, including a handle body 980 and two handle levers 990 connected to two ends of the handle body 980. Ends of the two handle levers 990 away from the handle body 980 are respectively pivotally connected to two sides of the carrying body 110 in a transverse direction and are telescopic. Pivot points of the two handle levers 990 and the carrying body 110 are located between the headrest portion 115 and the legrest portion 116.

As shown in FIG. 48, the frame 200 is movably pivotally connected to the carrying body 110. A pivot point of the frame 200 and the carrying body 110 is slidable between a third position M and a fourth position N. In this embodiment, the third position M is close to the legrest portion 116 of the carrying body 110, and the fourth position N is close to the headrest portion 115 of the carrying body 110. The frame 200 includes a first support frame 230 and a second support frame 240 pivotally connected to each other. The first support frame 230 and the second support frame 240 both have a roughly inverted U-shaped frame structure. Two upper ends of the first support frame 230 and two upper ends of the second support frame 240 are movably pivotally connected to the carrying body 110 respectively. Two lower ends of the first support frame 230 and two lower ends of the second support frame 240 are respectively connected to the wheel assemblies 400.

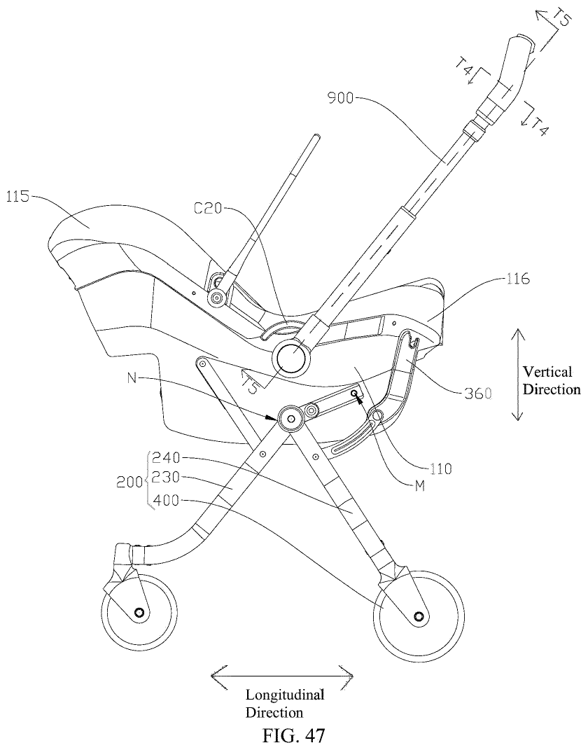

Further, the frame 200 is switchable between the unfolded state and the folded state. As shown in FIG. 44 to FIG. 46, when the frame 200 is in the folded state, the pivot point of the frame 200 and the carrying body 110 is at the third position M, and the infant carrier may be in the baby rocker mode, the carry cot mode, or the safety seat mode. When the frame 200 is in the folded state, the first support frame 230 and the second support frame 240 of the frame 200 overlap with each other, and the wheel assemblies 400 connected to the first support frame 230 and the second support frame 240 overlap correspondingly. As shown in FIG. 47, when the frame 200 is in the unfolded state, the two lower ends of the first support frame 230 and the two lower ends of the second support frame 240 are away from each other, the pivot point of the frame 200 and the carrying body 110 is at the fourth position N, and the infant carrier may be in the stroller mode.

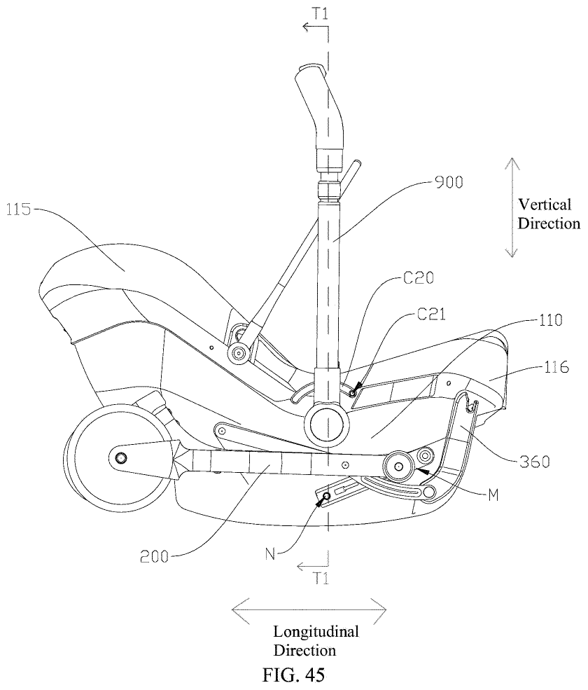

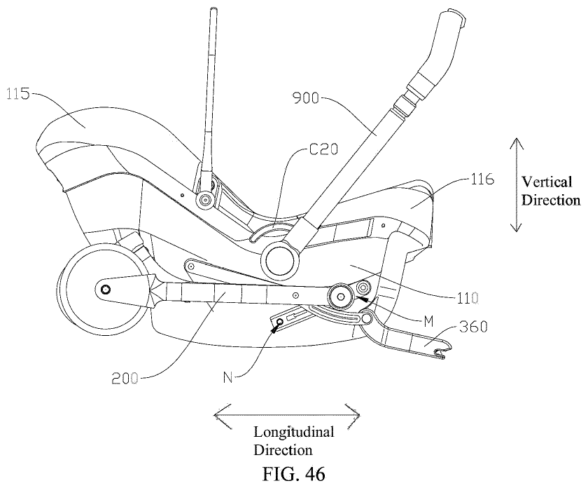

As shown in FIG. 44, when the frame 200 is in the folded state and the movable assembly 900 is in a contracted state and rotates until the handle body 980 is located on a side of the headrest portion 115 away from the legrest portion 116, that is, a rear position of the headrest portion 115, the infant carrier is in the baby rocker mode. In this case, the movable assembly 900 is not telescopic but is pivotable relative to the carrying body 110. As shown in FIG. 45, when the frame 200 is in the folded state and the movable assembly 900 is in the contracted state and rotates to a vertically upward state, the infant carrier is in the mode of the carrier. In this case, the movable assembly 900 is not telescopic either but is pivotable relative to the carrying body 110. As shown in FIG. 46, when the frame 200 is in the folded state and the movable assembly 900 is in the contracted state and rotates until the handle body 980 is located on a side of the legrest portion 116 away from the headrest portion 115, that is, the front of the legrest portion 116, the infant carrier is in the mode of the safety seat. In this case, the movable assembly 900 is telescopic and is pivotable relative to the carrying body 110. In this case, the movable assembly 900 may be used as a push rod of the safety seat. The carrying body 110 may be provided with a pivotable ISOFIX connector 360. When the infant carrier is in the mode of the safety seat, the ISOFIX connector 360 may extend out to be fastened to the safety seat. When the infant carrier is in the other usage modes, the ISOFIX connector 360 may retract to prevent unnecessary obstruction. As shown in FIG. 47, when the frame 200 is in the unfolded state, the pivot point of the frame 200 and the carrying body 110 is at the fourth position N, and the infant carrier may be in the stroller mode. In this case, the movable assembly 900 is in an extended state and rotates until the handle body 980 is located on the side of the legrest portion 116 away from the headrest portion 115, that is, the front of the legrest portion 116. In this case, the movable assembly 900 is used as a push rod of the stroller, and the movable assembly 900 is telescopic but is not pivotable relative to the carrying body 110.

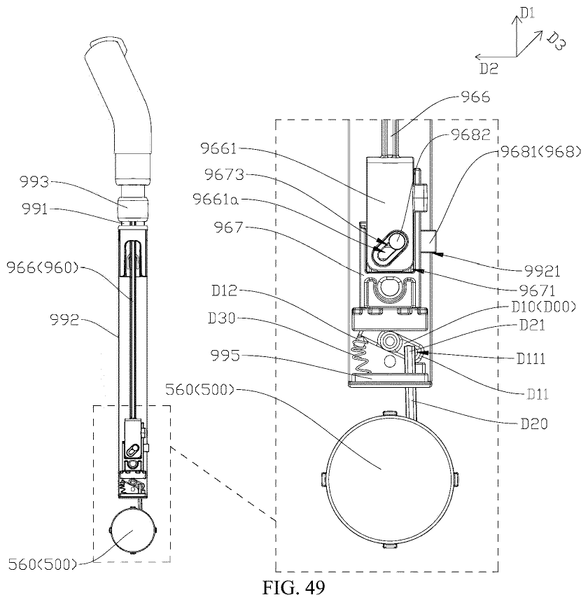

As shown in FIG. 49 to FIG. 52, the infant carrier further includes a length adjustment mechanism 960, a first limiting mechanism C00, an angle adjustment mechanism 500, and a second limiting mechanism D00. The length adjustment mechanism 960 is configured to adjust extension and contraction of the movable assembly 900, so that the movable assembly 900 is switchable between the extended state and the contracted state. When the movable assembly 900 is in the contracted state and is rotatable relative to the carrying body 110, the first limiting mechanism C00 locks the length adjustment mechanism 960, to limit extension and contraction of the movable assembly 900. When the movable assembly 900 rotates to a preset angle, the first limiting mechanism C00 unlocks the length adjustment mechanism 960, so that the movable assembly 900 is switchable between the extended state and the contracted state. The angle adjustment mechanism 500 is configured to adjust pivoting of the movable assembly 900 relative to the carrying body 110. When the movable assembly 900 is switched to the extended state, the second limiting mechanism D00 locks the angle adjustment mechanism 500 to limit the pivoting of the movable assembly 900. When the movable assembly 900 is switched to the contracted state, the second limiting mechanism D00 unlocks the angle adjustment mechanism 500, and the movable assembly 900 is pivotable.

In this embodiment, the two handle levers 990 both have a hollow rod structure, hollow inner cavities of the two handle levers 990 are both provided with the length adjustment mechanism 960 and the angle adjustment mechanism 500, and the first limiting mechanism C00 and the second limiting mechanism D00 are arranged between the two handle levers 990 and the two sides of the carrying body 110 in the transverse direction. The handle lever 990, the length adjustment mechanism 960, the angle adjustment mechanism 500, the first limiting mechanism C00, and the second limiting mechanism D00 on one side are taken as an example below to specifically describe structures and functions thereof.

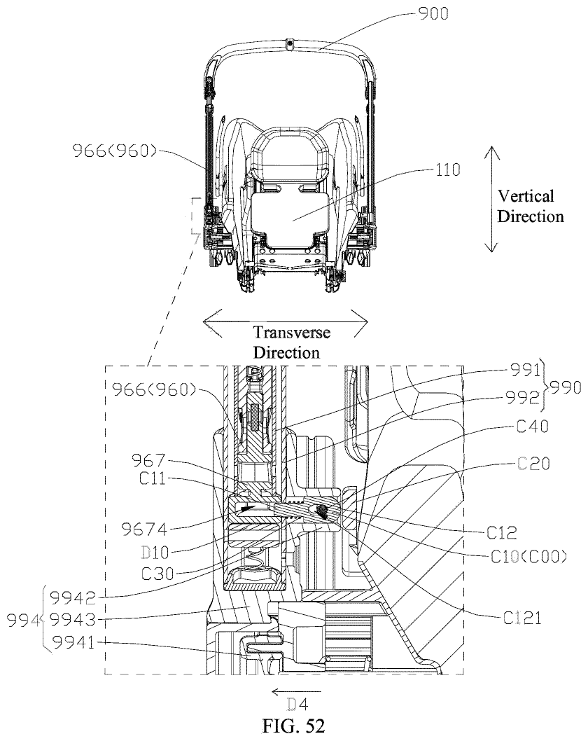

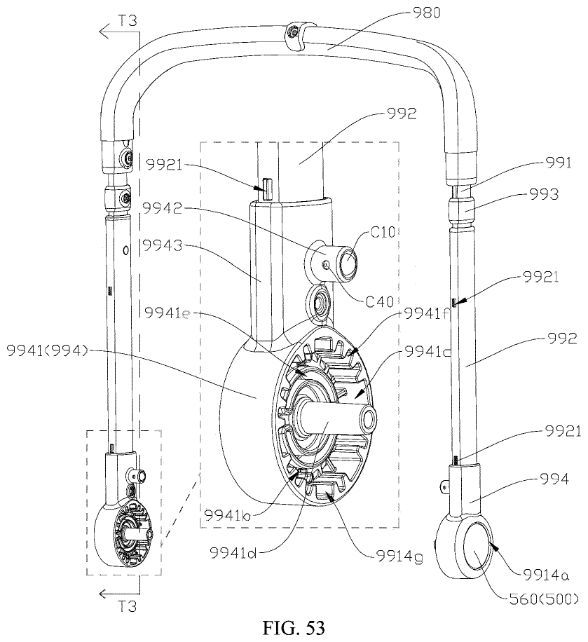

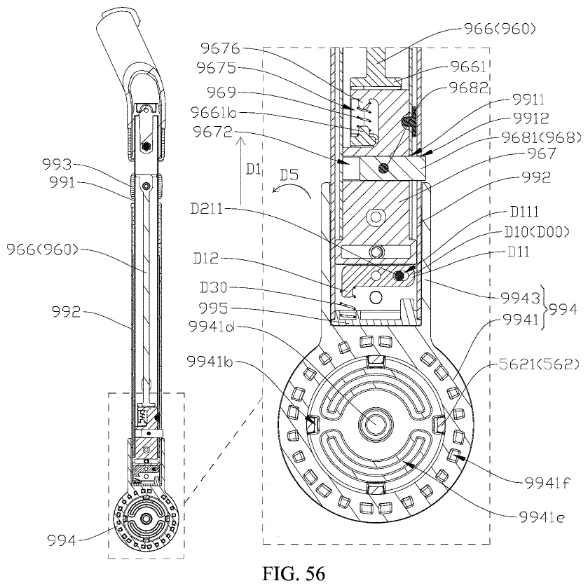

Specifically, as shown in FIG. 49 to FIG. 52, the handle lever 990 includes a first handle 991 and a second handle 992 sleeving the first handle 991. The first handle 991 is slidable relative to the second handle 992. One of the first handle 991 and the second handle 992 is provided with at least one first locating hole 9911 (see FIG. 56), and the other of the first handle 991 and the second handle 992 is provided with at least two second locating holes 9921. In this embodiment, the first handle 991 is provided with one first locating hole 9911, and the second handle 992 is provided with a plurality of second locating holes 9921 with different heights. That is, the second handle 992 is provided with the plurality of second locating holes 9921 spaced apart along a length extension direction thereof. In this embodiment, at least part of the first handle 991 is located above the second handle 992. The movable assembly 900 further includes an adjustment sliding member 993. The adjustment sliding member 993 sleeves the first handle 991 and is slidable along the first handle 991. As shown in FIG. 52 and FIG. 53, an end of the second handle 992 away from the first handle 991, i.e., a lower end of the second handle 992, is connected to a handle joint 994 configured to be pivotally connected to the carrying body 110. In this embodiment, the lower end of the second handle 992 is inserted into a connecting sleeve 9943 (see details below) of the handle joint 994.

As shown in FIG. 49 to FIG. 51, the length adjustment mechanism 960 is arranged in a hollow inner cavity of the first handle 991 and specifically includes a length adjustment pull handle 966, a driving block 967, a positioning block 968, and a length reset member 969 (see FIG. 56).

As shown in FIG. 49, the length adjustment pull handle 966 has a roughly long rod-shaped structure and is arranged in the hollow inner cavity of the first handle 991. One end of the length adjustment pull handle 966 is connected to the adjustment sliding member 993, and the other end of the length adjustment pull handle 966 is a sliding block 9661 and is connected to the driving block 967.

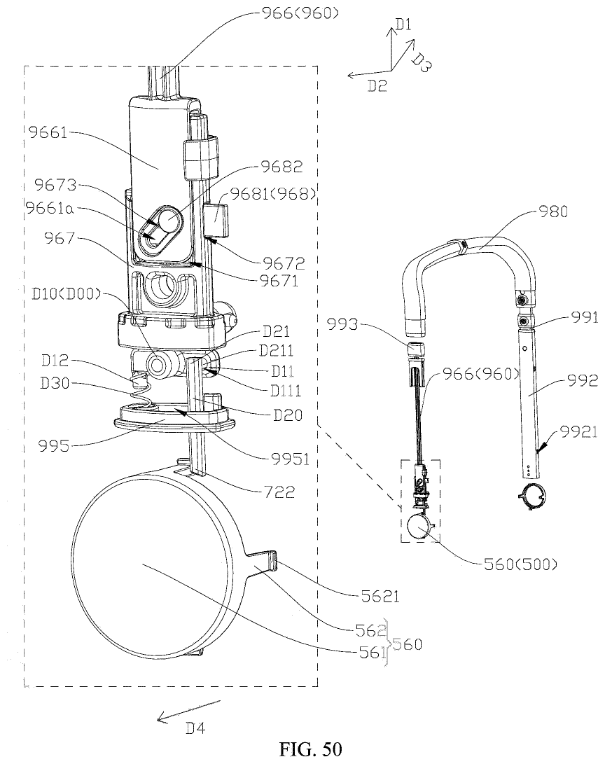

As shown in FIG. 49 and FIG. 50, the driving block 967 has a mounting groove 9671 extending along a length direction (i.e., a first direction D1) of the length adjustment pull handle 966, and the sliding block 9661 at least partially sleeves the driving block 967 and is movable along the mounting groove 9671. The driving block 967 is fastened to the hollow inner cavity of the first handle 991. The driving block 967 has a roughly cuboid structure. The driving block 967 is provided with a through groove 9672. The through groove 9672 passes through two sides of the driving block 967 along a second direction D2. Certainly, the through groove 9672 may alternatively pass through only one side of the driving block 967 along the second direction D2. In this embodiment, the second direction D2 is substantially perpendicular to the first direction D1. At least one of another two sides of the driving block 967 is provided with a first guide groove 9673. The first guide groove 9673 is in communication with the through groove 9672 and extends along the second direction D2. The sliding block 9661 is provided with a second sliding groove 9661a. The second sliding groove 9661a extends along a third direction D3 and is in communication with both the through groove 9672 and the first guide groove 9673. The third direction D3 intersects with and is not perpendicular to both the first direction DI and the second direction D2.

As shown in FIG. 49 and FIG. 50, the positioning block 968 is movably arranged on the driving block 967, and the positioning block 968 is configured to position the movable assembly 900 in the extended state or the contracted state. Specifically, the positioning block 968 is movably arranged in the through groove 9672 of the driving block 967, and the positioning block 968 has a positioning end 9681. A first sliding pin 9682 protrudes from one or two sides of the positioning block 968. The first sliding pin 9682 is arranged through the first guide groove 9673 and the second sliding groove 9661a.

Referring to FIG. 56 together, the length reset member 969 is configured to bias the length adjustment pull handle 966 to cause the length adjustment pull handle 966 to drive the positioning block 968 to move in a direction of extension out of the through groove 9672. In this embodiment, the length reset member 969 is a spring. Specifically, the driving block 967 is provided with a reset groove 9675, an upper side groove wall of the reset groove 9675 is provided with a first sleeving column 9676, the sliding block 9661 of the length adjustment pull handle 966 has a second sleeving column 9661b extending into the reset groove 9675, and the second sleeving column 9661b is located on a lower side of the first sleeving column 9676. That is, the first sleeving column 9676 is located in the first direction D1 of the second sleeving column 9661b. The length reset member 969 is arranged in the reset groove 9675, two ends of the length reset member 969 sleeve the first sleeving column 9676 and the second sleeving column 9661b respectively, and the two ends of the length reset member 969 abut against the driving block 967 and the sliding block 9661 respectively.

As shown in FIG. 49, FIG. 50, and FIG. 56, the positioning block 968 can extend out of the through groove 9672 and be inserted into one of the first locating holes 9911 and one of the second locating holes 9921 so that the first handle 991 and the second handle 992 are relatively fixed, thereby positioning the movable assembly 900 in the extended state, the contracted state, or a state between the extended state and the contracted state. That is, the movable assembly 900 is positioned at a certain height position. When the adjustment sliding member 993 is operated and moves along the first direction D1, the adjustment sliding member 993 drives the length adjustment pull handle 966 to move along the first direction D1, the first sliding pin 9682 slides in the first guide groove 9673 and the second sliding groove 9661a and simultaneously drives the positioning block 968 to move along the second direction D2 and retract into the through groove 9672 to release the positioning of the movable assembly 900, and the first handle 991 and the second handle 992 can slide relative to each other to be switchable between the extended state and the contracted state. When the first handle 991 and the second handle 992 slide to a required position, an external force applied to the adjustment sliding member 993 may be canceled, the sliding block 9661 of the length adjustment pull handle 966 may drive, under the action of the length reset member 969, the length adjustment pull handle 966 to move along a direction opposite to the first direction D1, and the first sliding pin 9682 slides in the first guide groove 9673 and the second sliding groove 9661a and simultaneously drives the positioning block 968 to move along a direction opposite to the second direction D2 and extend out of the through groove 9672, so that the positioning end 9681 of the positioning block 968 is inserted into another first locating hole 9911 and another second locating hole 9921 to cause the first handle 991 and the second handle 992 to be relatively fixed, and the movable assembly 900 is positioned at another height position.

Specifically, as shown in FIG. 44, FIG. 45, and FIG. 52, the first limiting mechanism C00 includes a fourth locking member C10, a first driving member C20, a first elastic member C30, and a limiting pin C40.

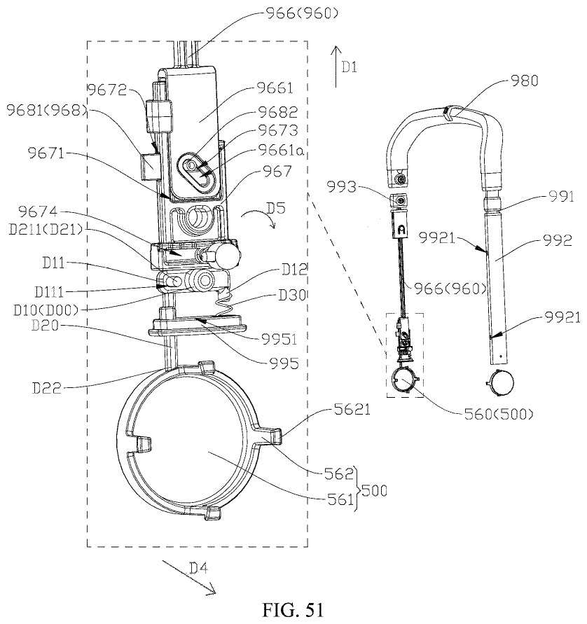

As shown in FIG. 51 and FIG. 52, a side of the driving block 967 facing the carrying body 110 is provided with a limiting groove 9674. In this embodiment, the limiting groove 9674 extends roughly along a fourth direction D4 and is located below the first guide groove 9673. In this embodiment, the fourth direction D4 is perpendicular to both the first direction DI and the second direction D2. The fourth locking member C10 selectively locks the length adjustment mechanism 960 or unlocks the length adjustment mechanism 960. Specifically, the handle joint 994 includes a joint body 8841, a connecting sleeve 9943 protruding above the joint body 8841, and a mounting member 9942 fastened to a side of the connecting sleeve 9943 facing the carrying body 110. The fourth locking member C10 is movably arranged on the mounting member 9942 and can move along the fourth direction D4 or a direction opposite to the fourth direction D4, to be close to or away from the driving block 967. In this embodiment, the fourth locking member C10 is a limiting post, and the limiting post is provided with a locking end C11 and an abutting end C12. The locking end C11 is selectively locked in the limiting groove 9674 to lock the length adjustment mechanism 960 or unlock the length adjustment mechanism 960. The abutting end C12 is provided with a stroke groove C121 extending along the fourth direction D4. The limiting pin C40 has one end connected to the mounting member 9942 and the other end inserted into the stroke groove C121. With the arrangement of the limiting pin C40 and the stroke groove C121, a sliding stroke of the abutting end C12 or the fourth locking member C10 can be limited.

Further, as shown in FIG. 44, FIG. 45, and FIG. 52, at least part of the first driving member C20 can drive the fourth locking member C10 to move to lock the length adjustment mechanism 960, and the fourth locking member C10 can fit a limitation releasing portion C21 to unlock the length adjustment mechanism 960. Specifically, the first driving member C20 is a pushing rib arranged on the carrying body 110 and protruding towards one side of the movable assembly 900. In this embodiment, the pushing rib is an arc-shaped rib, and an arc-shaped direction of the arc-shaped rib is consistent with an arc-shaped direction in which the movable assembly 900 pivots. The first driving member C20 includes the limitation releasing portion C21. In this embodiment, the limitation releasing portion C21 is a releasing groove arranged on an end of the pushing rib close to the legrest portion 116.

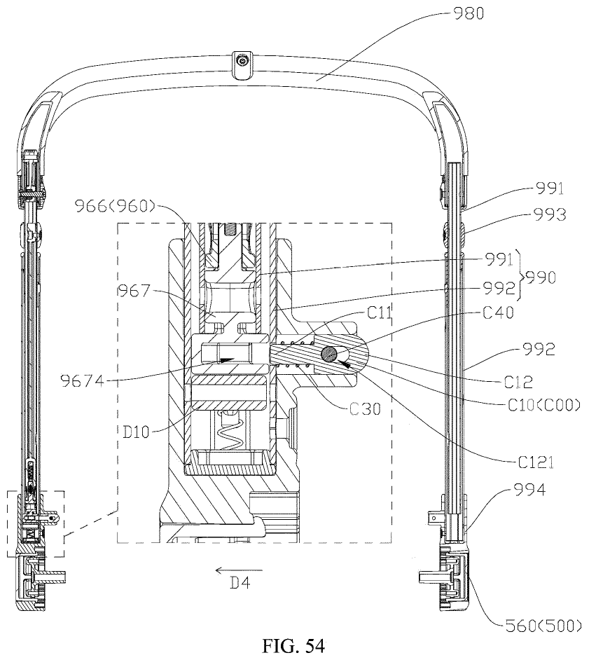

As shown in FIG. 52, when the movable assembly 900 rotates relative to the carrying body 110, the first driving member C20 drives the fourth locking member C10 to move in the transverse direction of the carrying body 110, that is, the fourth direction D4, and lock the length adjustment mechanism 960. Specifically, when the movable assembly 900 rotates relative to the carrying body 110, the pushing rib pushes against the abutting end C12 to drive the locking end C11 to move towards the limiting groove 9674 and be inserted into the limiting groove 9674 to lock the length adjustment mechanism 960. As shown in FIG. 44, FIG. 45, and FIG. 54, when the movable assembly 900 rotates to the preset angle, the abutting end C12 is located in the limitation releasing portion C21, the locking end C11 is disengaged from the limiting groove 9674, the length adjustment mechanism 960 is unlocked, and the movable assembly 900 is switchable between the contracted state and the extended state.

In this embodiment, as shown in FIG. 52, the first elastic member C30 is a spring and biases the fourth locking member C10 in the direction opposite to the fourth direction D4. Specifically, the first elastic member C30 sleeves the locking end C11 of the fourth locking member C10, with two ends abutting against the abutting end C12 of the first limiting member and an outer wall of the first handle 991 respectively. When the movable assembly 900 rotates to the preset angle, an elastic restoring force of the first elastic member C30 drives the locking end C11 to move away from the limiting groove 9674 to drive the abutting end C12 to be accommodated in the limitation releasing portion C21, the length adjustment mechanism 960 is unlocked, and the movable assembly 900 is switchable between the contracted state and the extended state.

In this way, as shown in FIG. 44, FIG. 45, and FIG. 52, when the infant carrier is in the baby rocker mode or the carry cot mode, since the movable assembly 900 rotates until the handle body 980 is located on the side of the headrest portion 115 away from the legrest portion 116 or the movable assembly 900 is in the vertically upward state, the first driving member C20 pushes against the abutting end C12 of the fourth locking member C10, so that the locking end C11 of the first driving member C20 is inserted into the limiting groove 9674 of the driving block 967. Since the driving block 967 is fastened to the hollow inner cavity of the first handle 991, the first handle 991 cannot move relative to the second handle 992, the length adjustment mechanism 960 is locked, and the movable assembly 900 is not telescopic. Such an arrangement can facilitate the movement of the infant carrier, especially when the infant carrier is in the mode of the carrier, which can facilitate the carrying of the carrier and can also prevent, for example, a risk of falling of the infant caused by accidental extending of the movable assembly 900 due to misoperation, thereby greatly improving safety performance.

As shown in FIG. 46, FIG. 47, and FIG. 54, when the infant carrier is in mode of the safety seat or the stroller, since the movable assembly 900 rotates until the handle body 980 is located on the side of the legrest portion 116 away from the headrest portion 115, that is, the movable assembly 900 rotates to the preset angle as mentioned above, the fourth locking member C10 is opposite to the limitation releasing portion C21, the elastic restoring force of the first elastic member C30 drives the locking end C11 to move in the direction opposite to the fourth direction D4 and be detached from the limiting groove 9674 to drive the abutting end C12 to be accommodated in the limitation releasing portion C21, the length adjustment mechanism 960 is unlocked, and the movable assembly 900 is switchable between the contracted state and the extended state. In this way, when the infant carrier is in the mode of the safety seat or the stroller, a length of the movable assembly 900 thereof may be adjusted as required.

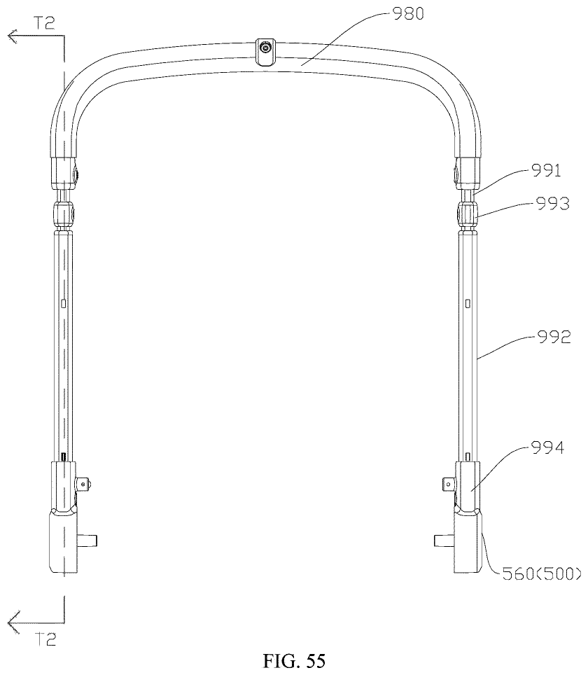

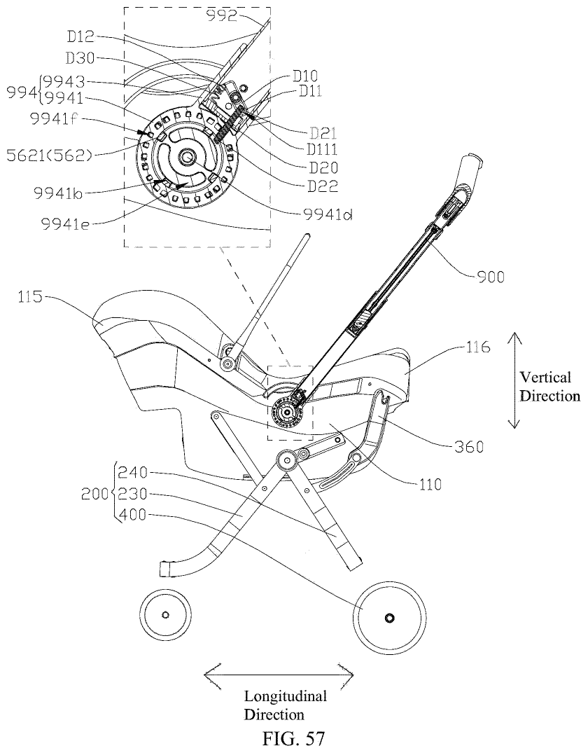

Specifically, as shown in FIG. 55 to FIG. 58, the angle adjustment mechanism 500 includes a pivot button 560, an angle locking member 570, and an angle reset member 580.

As shown in FIG. 50 and FIG. 51, the pivot button 560 includes a substantially circular sheet-shaped button body 561 and four button projections 562 protruding from one side of the button body 561. The four button projections 562 are evenly arranged along a circumferential direction of the button body 561. Certainly, in other embodiments, a number and arrangement positions of the button projections 562 may alternatively be adjusted as required. The pivot button 560 may move along the fourth direction D4 or the direction opposite to the fourth direction D4.

Specifically, as shown in FIG. 53 and FIG. 56, the joint body 8841 of the handle joint 994 has a roughly disk-shaped structure. A side of the joint body 8841 facing away from the carrying body 110 is provided with a button mounting groove 8841a configured to mount the pivot button 560. The bottom of the button mounting groove 8841a is provided with four penetrating holes 9941b. The four penetrating holes 9941b are arranged at positions corresponding to the four button projections 562. The button body 561 is movably arranged in the button mounting groove 8841a, and the four button projections 562 may pass through the four penetrating holes 9941b respectively. The four button projections 562 are all provided with a limiting hook 5621 at an end away from the button body 561. The limiting hook 5621 is configured to abut against a side of the joint body 8841 facing the carrying body 110 to prevent falling of the pivot button 560 from the handle joint 994. As shown in FIG. 53, the side of the joint body 8841 facing the carrying body 110 is provided with a first receiving groove 9941c. In this embodiment, the first receiving groove 9941c is roughly a cylindrical groove. A first pivot shaft 9941d protrudes from the middle of the bottom of the first receiving groove 9941c. The bottom of the first receiving groove 9941c is provided with at least one arc-shaped angle limiting groove 9941e. A groove wall of the first receiving groove 9941c is annularly provided with a plurality of first angle adjustment grooves 9941f and a plurality of second angle adjustment grooves 9941g. In this embodiment, each of the first angle adjustment grooves 9941f is a toothed groove. A plurality of toothed grooves are provided and are annularly arranged on the groove wall of the first receiving groove 9941c. Each of the second angle adjustment grooves 9941g is roughly a square groove. Four square grooves are provided and are circumferentially evenly arranged on the groove wall of the first receiving groove 9941c. That is, the groove wall of the first receiving groove 9941c located between each two square grooves is roughly an arc-shaped wall with a central angle of 90 degrees. In other embodiments, shapes and numbers of the first angle adjustment grooves 9941f and the second angle adjustment grooves 9941g may alternatively be adjusted as required.

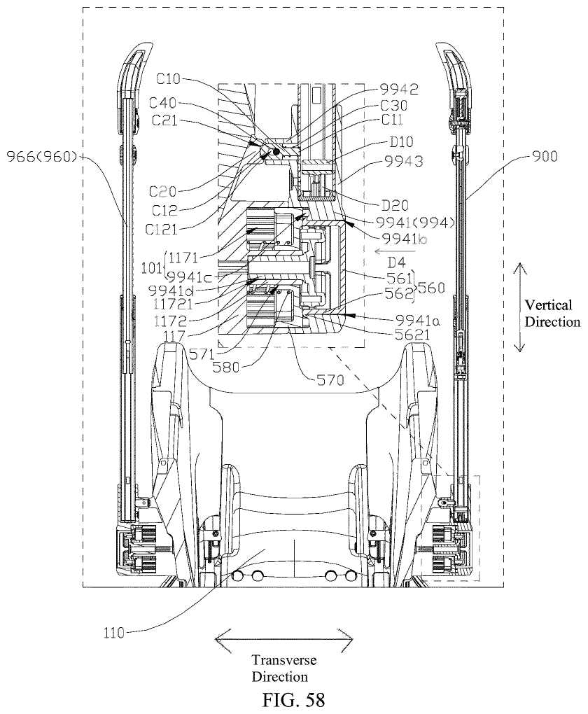

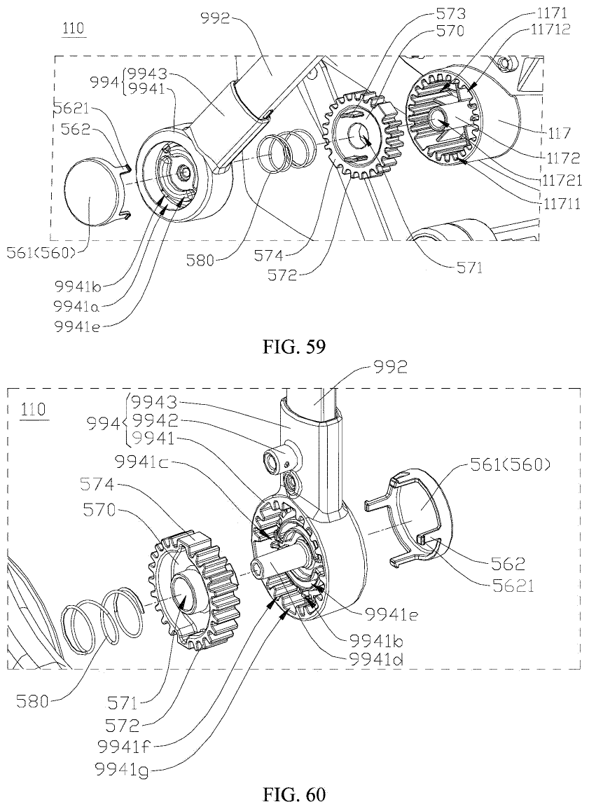

Further, as shown in FIG. 58, a side of the carrying body 110 is provided with a pivot joint 117. The pivot joint 117 has a second receiving groove 1171. The second receiving groove 1171 is a cylindrical groove whose shape is roughly the same as that of the first receiving groove 9941c. A second pivot shaft 1172 protrudes from the middle of the bottom of the second receiving groove 1171. The second pivot shaft 1172 is provided with a pivot groove 11721 extending along a length direction thereof. The handle joint 994 can be inserted into the pivot groove 11721 of the second pivot shaft 1172 through the first pivot shaft 9941d thereof to realize pivoting with the carrying body 110, and in this case, the first receiving groove 9941c and the second receiving groove 1171 form a first receiving cavity 101 together. The angle locking member 570 and the angle reset member 580 are both arranged in the first receiving cavity 101. The angle locking member 570 has a roughly cylindrical structure. A pivot hole 571 is arranged in a substantially middle portion of the angle locking member 570. The angle locking member 570 sleeves the second pivot shaft 1172 through the pivot hole 571 so as to move along an extension direction of the second pivot shaft 1172. In this embodiment, as shown in FIG. 59, a groove wall of the second receiving groove 1171 is provided with a first pivot limiting groove 11711 and a second pivot limiting groove 11712 configured to limit rotation of the angle locking member 570. In this embodiment, the first pivot limiting groove 11711 is a toothed groove. A plurality of toothed grooves are provided and are annularly arranged on the groove wall of the first receiving groove 9941c. The second pivot limiting groove 11712 is roughly a square groove. Two square grooves are provided and are circumferentially evenly arranged on the groove wall of the first receiving groove 9941c. That is, the groove wall of the first receiving groove 9941c located between the two square grooves is roughly an arc-shaped wall with a central angle of 180 degrees. In other embodiments, shapes and numbers of the first pivot limiting groove 11711 and the second pivot limiting groove 11712 may alternatively be adjusted as required.

The angle locking member 570 is switchable between the first lock position and the first unlock position. A first angle adjustment protrusion 572 and a second angle adjustment protrusion 574 are arranged on a periphery of the angle locking member 570. Shapes and numbers of the first angle adjustment protrusion 572 and the second angle adjustment protrusion 574 correspond to the shapes and the numbers of the first pivot limiting groove 11711 and the second pivot limiting groove 11712 respectively. That is, a plurality of first angle adjustment protrusions 572 are provided and are all toothed protrusions, and two second adjustment protrusions 624 are provided and are both square protrusions. In this embodiment, at least part of the angle locking member 570 is always located in the first receiving groove 9941c, and the first angle adjustment protrusion 572 and the second angle adjustment protrusion 574 of the angle locking member 570 always correspondingly fit the first pivot limiting groove 11711 and the second pivot limiting groove 11712 to prevent pivoting of the angle locking member 570 relative to the pivot joint 117. That is, movement of the angle locking member 570 always along the extension direction of the second pivot shaft 1172 is ensured.

As shown in FIG. 58 to FIG. 60, when the angle locking member 570 is at the first lock position, the angle locking member 570 is located in both of the first receiving groove 9941c and the second receiving groove 1171, at least one first angle adjustment protrusion 572 can be inserted into any first angle adjustment groove 9941f, and at least one second angle adjustment protrusion 574 can be inserted into any second angle adjustment groove 9941g to fix the handle joint 994 to an angle position relative to the carrying body 110. In this embodiment, since two second angle adjustment protrusions 574 are provided and are arranged opposite to each other and four second angle adjustment grooves 9941g are provided and are circumferentially evenly arranged on the groove wall of the first receiving groove 9941c, the handle joint 994 has four angle pivot positions relative to the pivot joint 117. Certainly, in other embodiments, a number of the angle pivot positions of the handle joint 994 relative to the pivot joint 117 may alternatively be changed by adjusting positions and numbers of the second angle adjustment protrusion 574 and the second angle adjustment groove 9941g. A side of the angle locking member 570 facing away from the carrying body 110 is further provided with at least one angle limiting protrusion 573. The at least one angle limiting protrusion 573 can be inserted into at least one arc-shaped angle limiting groove 9941e to limit a rotation angle of the handle joint 994. In this embodiment, two angle limiting protrusions 573 and two angle limiting grooves 9941e are provided. When the angle locking member 570 is at the first unlock position, the angle locking member 570 is located only in the second receiving groove 1171, the first angle adjustment protrusion 572 of the angle locking member 570 is disengaged from the corresponding first angle adjustment groove 9941f, the second angle adjustment protrusion 574 of the angle locking member 570 is disengaged from the corresponding second angle adjustment groove 9941g, the angle adjustment mechanism 500 is unlocked, and the handle joint 994 may rotate relative to the pivot joint 117. That is, the inclination angle of the movable assembly 900 is adjustable.

In this embodiment, as shown in FIG. 58 to FIG. 60, the angle reset member 580 is a spring and is configured to bias the angle locking member 570 towards the first lock position. Specifically, the angle reset member 580 may sleeve the second pivot shaft 1172, and two ends of the angle reset member 580 are respectively configured to abut against the bottom of the second receiving groove 1171 and the angle locking member 570.

When there is a need to adjust the inclination angle of the movable assembly 900, as shown in FIG. 58, the pivot button 560 may be pressed in the fourth direction D4, so that the pivot button 560 pushes against, through the button projection 562 thereof, the angle locking member 570 to move from the first lock position to the first unlock position, the angle adjustment protrusion 622 of the angle locking member 570 is disengaged from the angle adjustment groove 2241f, and the angle adjustment mechanism 500 is unlocked. In this case, the movable assembly 900 can be rotated, so that the handle joint 994 rotates relative to the pivot joint 117 to a required angle position. Then, a pressing force applied to the pivot button 560 may be canceled, so that the angle locking member 570 moves to the first lock position in the direction opposite to the fourth direction D4 under an elastic restoring force of the angle reset member 580, and each angle adjustment protrusion 622 is re-inserted into a new angle adjustment groove 2241f. That is, the movable assembly 900 is locked at a required angle position. In this embodiment, the angle adjustment groove 2241f is a tooth groove, and the angle locking member 570 has a gear-like structure.

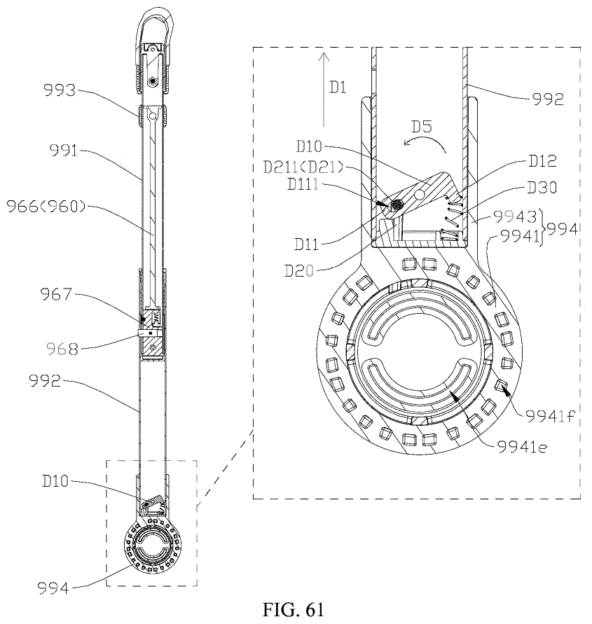

Specifically, as shown in FIG. 61 to FIG. 63, the second limiting mechanism D00 is arranged in a hollow inner cavity of the second handle 992. The second limiting mechanism D00 includes a second driving member D10, a fifth locking member D20, and a fourth reset member D30.

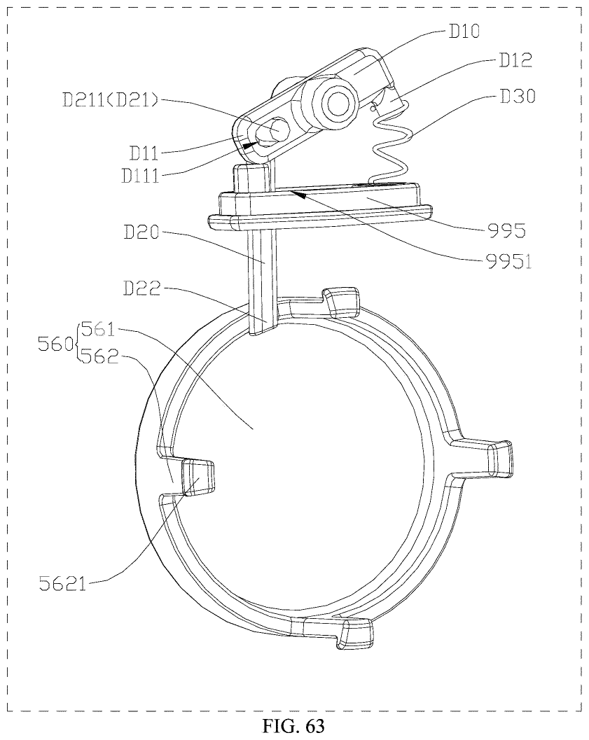

As shown in FIG. 61 to FIG. 63, the second driving member D10 has a roughly rod shape, and a substantially middle portion of the second driving member D10 is pivotally connected to a cavity wall of the hollow inner cavity of the second handle 992 to form a structure similar to a seesaw. The second driving member D10 is provided with a first connecting end D11 on one side of the pivot point, and the second driving member D10 is provided with a sleeving protrusion D12 on another side of the pivot point. The fifth locking member D20 has a substantially rod-shaped structure and is provided with a catching end D21 catching the first connecting end D11 of the second driving member D10 and a stop end D22 that prevents pivoting of the angle adjustment mechanism 500. Specifically, the first connecting end D11 of the second driving member D10 is provided with a fastening hole D111, the catching end D21 of the fifth locking member D20 is provided with a hook D211, and the hook D211 catches on the fastening hole D111. When pivoting, the second driving member D10 drives the fifth locking member D20 to move between a second lock position and a second unlock position. When the second driving member D10 moves to the second lock position, as shown in FIG. 63, the stop end D22 moves to a pressing path of the pivot button 560, that is, between the pivot button 560 and the angle locking member 570, to prevent the pressing of the pivot button 560 and lock the angle adjustment of the movable assembly 900 by the angle adjustment mechanism 500. As shown in FIG. 51, when the second driving member D10 moves to the second unlock position, the stop end D22 moves out of the pressing path of the pivot button 560, the pivot button 560 may be pressed, the angle adjustment mechanism 500 is unlocked, and the inclination angle of the movable assembly 900 is adjustable.

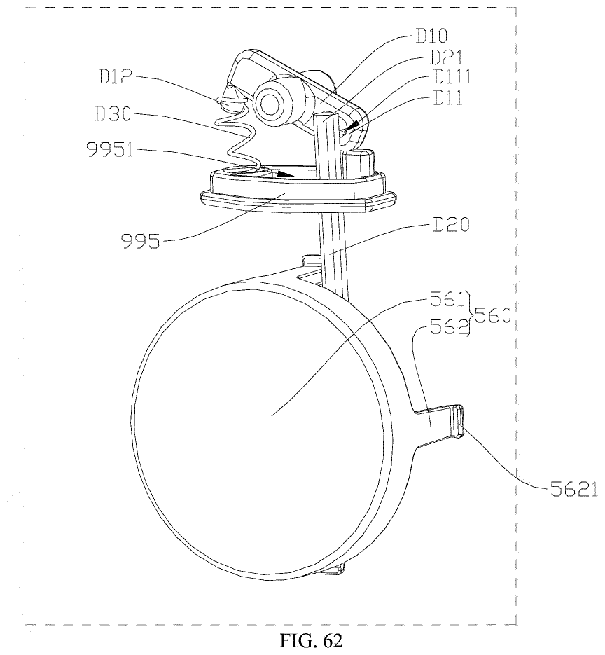

In this embodiment, as shown in FIG. 62 and FIG. 63, the fourth reset member D30 is a spring, and the fourth reset member D30 is configured to bias the second driving member D10 to pivot until the fifth locking member D20 moves to the second lock position. Specifically, a holder 995 is fixed in the hollow inner cavity of the second handle 992. One end of the fourth reset member D30 sleeves the sleeving protrusion D12 of the second driving member D10 and abuts against at least part of the second driving member D10, and the other end of the fourth reset member D30 is fastened to the holder 995. The holder 995 is provided with a through hole 9951, and the stop end D22 of the fifth locking member D20 can pass through the through hole 9951 and be inserted into the pressing path of the pivot button 560.

Further, as shown in FIG. 51 and FIG. 61, the second driving member D10 selectively abuts against or is separated from the length adjustment mechanism 960. Specifically, as shown in FIG. 51, when the movable assembly 900 is in the contracted state, the first handle 991 moves in the direction opposite to the first direction DI relative to the second handle 992 until the driving block 967 abuts against the second driving member D10, and the second driving member D10 pivots towards a fifth direction D5 and drives the fifth locking member D20 to move towards the first direction D1, so that the fifth locking member D20 moves in a direction away from the pivot button 560 to exit the pressing path of the pivot button 560. In this case, the fourth reset member D30 is compressed. The pivot button 560 may be pressed, the angle adjustment mechanism 500 is unlocked, and the inclination angle of the movable assembly 900 is adjustable. As shown in FIG. 61, when the movable assembly 900 is adjusted to a non-compressed state, that is, when the movable assembly 900 is in the extended state or in the state between the extended state and the contracted state, the driving block 967 arranged in the first handle 991 no longer abuts against the second driving member D10, and the second driving member D10 pivots in a direction opposite to the fifth direction D5 under an elastic restoring force of the fourth reset member D30, so that the fifth locking member D20 moves to the second lock position in the direction opposite to the first direction D1, that is, the stop end D22 of the fifth locking member D20 is inserted into the pressing path of the pivot button 560 to prevent the pressing of the pivot button 560 and lock the angle adjustment of the movable assembly 900 by the angle adjustment mechanism 500, and the movable assembly 900 cannot rotate relative to the carrying body 110.

As shown in FIG. 47 and FIG. 61 to FIG. 63, when the infant carrier is in the stroller mode, since the movable assembly 900 is generally in the extended state or in the state between the extended state and the contracted state, the driving block 967 arranged in the first handle 991 no longer abuts against the second driving member D10, so that the second driving member D10 pivots under an elastic force of the fourth reset member D30 until the fifth locking member D20 is at the second lock position, the stop end D22 of the fifth locking member D20 is inserted into the pressing path of the pivot button 560, thereby preventing the pressing of the pivot button 560 and locking the angle adjustment of the movable assembly 900 by the angle adjustment mechanism 500, and the movable assembly 900 cannot rotate relative to the carrying body 110. In this way, when the user is pushing the stroller, the inclination angle of the movable assembly 900 may not be changed by an accidental pivot of the movable assembly 900 due to misoperation, which facilitates the pushing of the stroller and prevents potential safety hazards.

As shown in FIG. 44 to FIG. 46, FIG. 50, and FIG. 51, when the infant carrier is in the baby rocker mode, the carry cot mode, or the safety seat mode, since the movable assembly 900 is generally in the contracted state, the driving block 967 arranged in the first handle 991 may abut against the second driving member D10, so that the second driving member D10 pivots until the fifth locking member D20 is at the second unlock position, the fifth locking member D20 exits the pressing path of the pivot button 560, the pivot button 560 may be pressed, the angle adjustment mechanism 500 is unlocked, and the inclination angle of the movable assembly 900 is adjustable. In this way, when the infant carrier is in the baby rocker mode, the carry cot mode, or the safety seat mode, the inclination angle of the movable assembly 900 relative to the carrying body 110 may be adjusted as required.

It is to be noted that, in other embodiments, the infant carrier in the present disclosure may alternatively include only one of the first limiting mechanism C00 and the second limiting mechanism D00.

The above infant carrier has at least the following technical effects.

In the above infant carrier, the movable assembly 900 is pivotally connected to the carrying body 110 and is telescopic, and the movable assembly 900 is provided with a length adjustment mechanism 960 and an angle adjustment mechanism 500. When the movable assembly 900 is in the contracted state and is rotatable relative to the carrying body 110, the first limiting mechanism C00 may lock the length adjustment mechanism 960 to limit contraction of the movable assembly 900. In this way, when the infant carrier is in the baby rocker mode or the carry cot mode, the movable assembly 900 is not extendable, which facilitates the carrying of the carrier and prevents potential safety hazards such as falling of the baby from the carrying body 110 caused by extension of the movable assembly 900 due to misoperation. When the movable assembly 900 rotates to the preset angle, the first limiting mechanism C00 unlocks the length adjustment mechanism 960, so that the movable assembly 900 is switchable between the extended state and the contracted state. In this way, when the infant carrier is in the stroller mode or the safety seat mode, the length of the movable assembly 900 may be adjusted as required. When the movable assembly 900 is switched to the extended state, the second limiting mechanism D00 locks the angle adjustment mechanism 500 to limit pivoting of the movable assembly 900. In this way, when the infant carrier is in the stroller mode, the movable assembly 900 cannot pivot, the inclination angle of the movable assembly 900 of the stroller is fixed, to facilitate the user's pushing. When the movable assembly 900 is switched to the contracted state, the second limiting mechanism D00 unlocks the angle adjustment mechanism 500, and the movable assembly 900 is pivotable. In this way, when the infant carrier is in the baby rocker mode, the carry cot mode, or the safety seat mode, the movable assembly 900 may pivot to a required angle. A switching structure of the movable assembly 900 is simple, which is easy to operate.

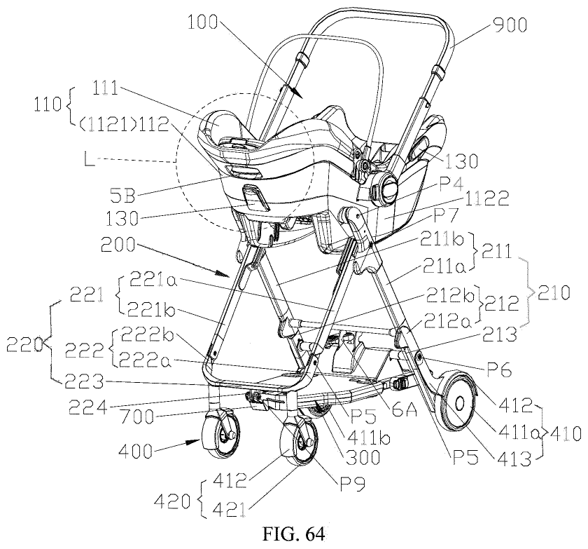

According to a yet another embodiment of the present disclosure, an infant carrier is provided. As shown in FIG. 64, the infant carrier includes a seat assembly 100, a frame 200, and a base 300. The frame 200 is switchable between an unfolded state and a folded state, and the frame 200 is connected to the seat assembly 100. The base 300 may be connected to the frame 200, and may move with unfolding and folding of the frame 200. When the frame 200 is in the unfolded state, the infant carrier is suitable for use as a stroller. When the frame 200 is in the folded state, the infant carrier is suitable for use as a safety seat, and the infant carrier may be placed directly on a vehicle seat built in a vehicle and fastened to the vehicle seat through at least one of a seat belt and ISOFIX. The base 300 is adapted to move towards the seat assembly 100 when the frame 200 is switched from the unfolded state to the folded state. Specifically, when the frame 200 switches between the unfolded state and the folded state, an angle between the seat assembly 100 and the base 300 remains constant. More specifically, when the frame 200 switches between the unfolded state and the folded state, the seat assembly 100 always maintains an angle parallel to the ground, so that the infant carrier is smooth during the switching. Even if the infant is not taken out of the stroller, the switching from the mode of the stroller to the safety seat mode can be safely and conveniently realized. The infant carrier in this embodiment can switch between the stroller and the safety seat through folding and unfolding of the frame 200, which has a simple structure and good stability and is easy to operate. In addition, the infant carrier can also save as much space as possible when the infant carrier is used as a safety seat, which is easy to carry and mount.

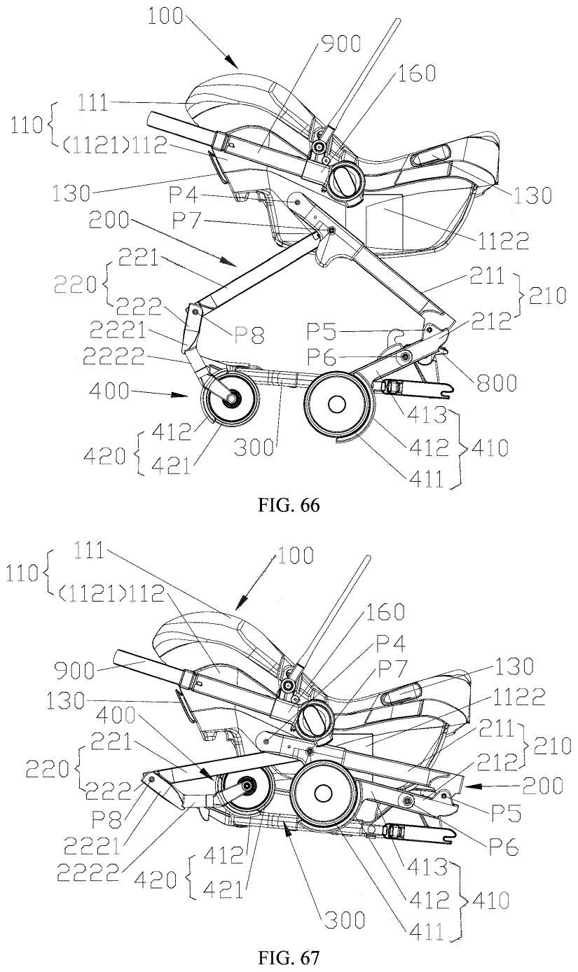

In an embodiment, as shown in FIG. 64 to FIG. 67, the frame 200 includes a rear bracket 210 and a front bracket 220. The rear bracket 210 includes an upper rear leg 211, a lower rear leg 212, and a first connecting rod 213. The upper rear leg 211 is pivotably connected to the seat assembly 100, and their pivot point is a fourth pivot point P4. The upper rear leg 211 is pivotably connected to the lower rear leg 212, and their pivot point is a fifth pivot point P5. The upper rear leg 211 includes a first upper rear leg 211a and a second upper rear leg 211b. The first upper rear leg 211a and the second upper rear leg 211b are pivotably connected to two sides of the seat assembly 100 respectively. The lower rear leg 212 includes a first lower rear leg 212a and a second lower rear leg 212b. The first lower rear leg 212a is pivotably connected to the first upper rear leg 211a, and the second lower rear leg 212b is pivotably connected to the second upper rear leg 211b. Two ends of the first connecting rod 213 are connected to the first lower rear leg 212a and the second lower rear leg 212b respectively. The base 300 is pivotably connected to the lower rear leg 212 through the first connecting rod 213, and a pivot connection point between the base 300 and the lower rear leg 212 is a sixth pivot point P6. Specifically, the first connecting rod 213 is fixedly connected to the first lower rear leg 212a and the second lower rear leg 212b. At least part of the base 300 is located between the first lower rear leg 212a and the second lower rear leg 212b, the first connecting rod 213 is arranged through this part of the base 300, and the base 300 is pivotably connected to the first connecting rod 213. In this embodiment, when the frame 200 is in the unfolded state, the fifth pivot point P5 deviates from a line connecting the fourth pivot point P4 and the sixth pivot point P6, and in a vertical direction, the fifth pivot point P5 is located between the fourth pivot point P4 and the sixth pivot point P6, so that, when the frame 200 is in the folded state, a distance between an end of the lower rear leg 212 away from the fifth pivot point P5 and the upper rear leg 211 is smaller. When the frame 200 is in the folded state, in a horizontal direction, the sixth pivot point P6 is located between the fourth pivot point P4 and the fifth pivot point P5. It is to be noted that orientation-related terms such as “upper”, “lower”, “left”, “right”, “front”, “back”, “vertical”, and “horizontal” used in this embodiment are described with reference to the infant carrier in FIG. 64 used as the stroller.

As shown in FIG. 64 to FIG. 67, the front bracket 220 includes an upper front leg 221 and a lower front leg 222, the upper front leg 221 and the upper rear leg 211 are pivotably connected, and their pivot point is a seventh pivot point P7. In the horizontal direction, the seventh pivot point P7 is located between the fourth pivot point P4 and the fifth pivot point P5. The upper front leg 221 is pivotably connected to the lower front leg 222, and their pivot point is an eighth pivot point P8. The lower front leg 222 is pivotably connected to the base 300, and their pivot point is a ninth pivot point P9. The upper front leg 221 includes a first upper front leg 221a and a second upper front leg 221b, and the lower front leg 222 includes a first lower front leg 222a and a second lower front leg 222b. Two ends of the first upper front leg 221a are pivotably connected to the first upper rear leg 211a and the first lower front leg 222a respectively. Two ends of the second upper front leg 221b are pivotably connected to the second upper rear leg 211b and the second lower front leg 222b respectively. The front bracket 220 further includes a second connecting rod 223. Two ends of the second connecting rod 223 are connected to the first lower front leg 222a and the second lower front leg 222b respectively. The base 30 is pivotably connected to the second connecting rod 223. More specifically, a pivot portion 224 is arranged in the middle of the second connecting rod 223, and the base 300 is pivotably connected to the pivot portion 224. When the frame 200 is in the unfolded state, in the vertical direction, the eighth pivot point P8 is located between the seventh pivot point P7 and the ninth pivot point P9. When the frame 200 is in the folded state, in the horizontal direction, the ninth pivot point P9 is located between the eighth pivot point P8 and the seventh pivot point P7.

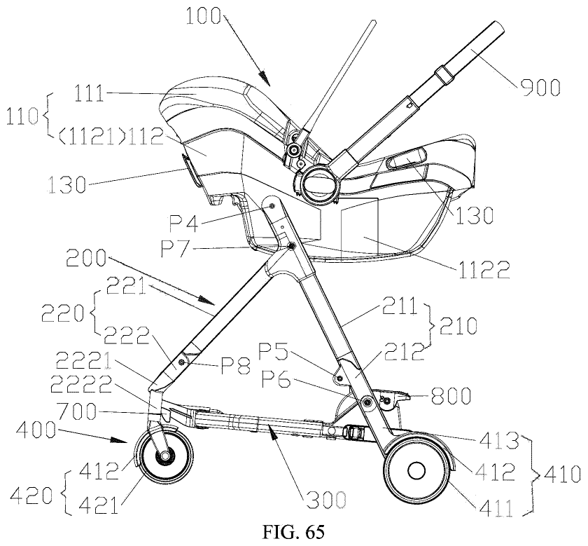

According to the infant carrier in this embodiment, referring to FIG. 65 to FIG. 67, when the frame 200 is switched from the unfolded state to the folded state, the upper front leg 221 and the upper rear leg 211 pivot outwards from each other. That is, the eighth pivot point P8 and the fifth pivot point P5 are away from each other. The lower front leg 222 and the lower rear leg 212 are folded inwards. That is, an end of the lower front leg 222 away from the eighth pivot point P8 and an end of the lower rear leg 212 away from the fifth pivot point P5 are close to each other. The process in which the frame 200 is switched from the folded state to the unfolded state is exactly opposite to the above process in which the frame 200 is switched from the unfolded state to the folded state. In this embodiment, any one or more of the lower front leg 222, the lower rear leg 212, the upper front leg 221, and the upper rear leg 211 can drive the other components to pivot at the same time under an external force, thereby realizing the switching of the frame 200 between the unfolded state and the folded state through multi-component linkage.

In this embodiment, referring to FIG. 65 to FIG. 67, the lower front leg 222 includes a first connecting section 2221 and a second connecting section 2222, and the first connecting section 2221 and the second connecting section 2222 are arranged at an angle, so that, when the frame 200 is in the folded state, an end of the second connecting section 2222 can be closer to the upper front leg 221, thereby reducing an overall volume of the infant carrier when used as the safety seat, to facilitate carrying and mounting.

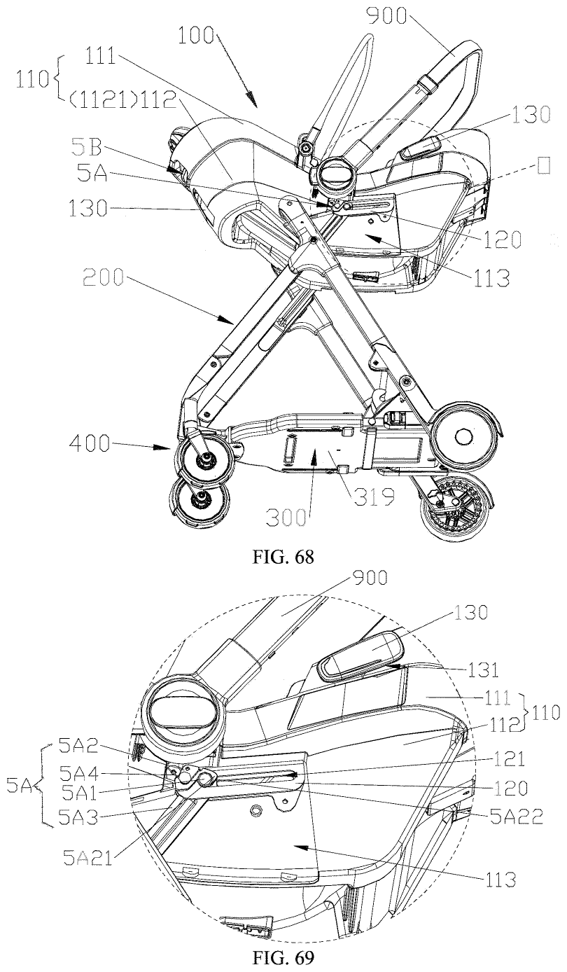

In an embodiment, as shown in FIG. 64 to FIG. 67, the infant carrier further includes a plurality of wheel assemblies 400, and the plurality of wheel assemblies 400 are connected to the frame 200 respectively. The plurality of wheel assemblies 400 include two front wheel assemblies 420 and two rear wheel assemblies 410. The two rear wheel assemblies 410 are connected to two lower rear legs 212 respectively, and the two front wheel assemblies 420 are connected to two lower front legs 222 respectively. The plurality of wheel assemblies 400 include wheels 411 and 421 and a mudguard 412. The wheels 411 and 421 are pivotably connected to the lower rear leg 212 and the lower front leg 222 respectively. When the frame 200 is in the folded state, lowest points of the wheels 411 and 421 are all higher than a bottom surface of the base 300 In this way, when the infant carrier is used as the safety seat, the bottom surface of the base 300 can directly contact the vehicle seat, so that the safety seat can be placed on the vehicle seat more stably, which also prevents soiling of the vehicle seat by the wheels 411 and 421. In this embodiment, the bottom surface 319 of the base 300 is generally a plane (see FIG. 68), so that the base 300 can be placed stably on the vehicle seat, thereby improving safety of the infant carrier when used as the safety seat. The mudguard 412 is in a shape of an arc. The mudguard 412 is arranged around part of peripheries of the wheels 411 and 421 and is spaced apart from the wheels 411 and 421. The rear wheel assemblies 410 each further include a baffle connecting member 413, and the mudguard 412 is connected to the lower rear leg 212 through the baffle connecting member 413. In this embodiment, the mudguard 412 is integrally formed with the baffle connecting member 413. In other embodiments, the mudguard 412 and the baffle connecting member 413 may be separate components. In addition, the mudguard 412 in the front wheel assembly 420 may be directly connected to the lower front leg 222. When the frame 200 is in the folded state, the mudguard 412 is located below the wheel 411, and the lowest point of the mudguard 412 is as high as or higher than the bottom surface of the base 300. In this way, when the infant carrier used as the safety seat is mounted on the vehicle seat, the wheel 411 can be separated from a surface of the seat by the mudguard 412, thereby preventing direct contact of the wheel 411 with the vehicle seat and preventing soiling of the vehicle seat by the wheel 411.

In an embodiment, as shown in FIG. 64, FIG. 68, and FIG. 69, the seat assembly 100 includes a seat 110, the seat 110 includes a seat body 111 and a seat housing 112, and the seat body 111 and the seat housing 112 define a first accommodating cavity 113. The seat housing 112 includes a first seat housing 1121 and a second seat housing 1122. The second seat housing 1122 is connected to the first seat housing 1121 or the seat body 111.

Still referring to FIG. 64, FIG. 68, and FIG. 69, the seat assembly 100 further includes a seat belt positioning device 130, and the seat belt positioning device 130 has a seat belt slot 131. When the infant carrier is in a form of a safety seat, a seat belt at the vehicle seat is adapted to pass through the seat belt slot 131 to fix the infant carrier (safety seat) to the vehicle seat. At least two seat belt slots 131 are provided, and the at least two seat belt slots 131 are arranged respectively on one side of left and right sides and a front side of the seat 110. In this embodiment, three seat belt slots 131 are provided, and the three seat belt slots 131 are located on the left and right sides and the front side of the seat 110 respectively. The seat belt passes through the seat belt slot 131 on the left or right side, and passes through the seat belt slot 131 on the front side to fix the infant carrier used as a safety seat to the vehicle seat. With the arrangement of the seat belt positioning device 130, the infant carrier can be conveniently and firmly fastened to the vehicle seat.

In an embodiment, as shown in FIG. 68 and FIG. 69, the infant carrier further includes an unfold locking mechanism 5A. In this embodiment, at least part of the unfold locking mechanism 5A is accommodated in the first accommodating cavity 113, two unfold locking mechanisms 5A are provided, and the two unfold locking mechanisms 5A are arranged on two sides of the seat assembly 100 respectively. In other embodiments, the unfold locking mechanism 5A may alternatively be arranged on only one side of the seat assembly 100, which is not limited in the present disclosure. For ease of description, the unfold locking mechanism 5A on one side of the seat assembly 100 is taken as an example below for description.

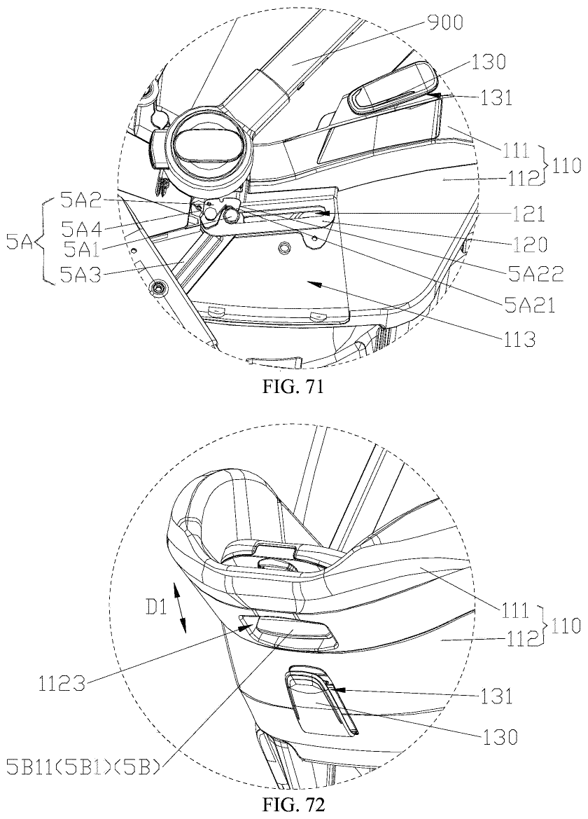

Referring to FIG. 69 and FIG. 71, the unfold locking mechanism 5A includes a first sliding pin 5A1, a first stopper 5A2, a first connecting member 5A3 and an unfold locking mechanism elastic member 5A4. The first connecting member 5A3 has one end fixedly connected to the upper front leg 221 and the other end accommodated in the first accommodating cavity 113 and connected to the first sliding pin 5A1. The first sliding pin 5A1 is fixedly connected to the upper front leg 221 through the first connecting member 5A3 and is slidably arranged on the seat assembly 100. Specifically, the first sliding pin 5A1 is slidably accommodated in the first accommodating cavity 113. The first sliding pin 5A1, when sliding relative to the seat assembly 100, may drive, through the first connecting member 5A3, the upper front leg 221 to pivot relative to the upper rear leg 211, thereby causing the frame 200 to switch between the unfolded state and the folded state. In this embodiment, a connecting sheet 120 is accommodated in the first accommodating cavity 113 and connected to the seat body 111. The connecting sheet 120 is provided with a strip groove 121, and the first sliding pin 5A1 is inserted into the strip groove 121 and is slidable along the strip groove 121. In other embodiments, alternatively, the seat body 111 is provided with the strip groove 121, and the first sliding pin 5A1 is inserted into the strip groove 121 and is slidable along the strip groove 121.

Further, the first stopper 5A2 is pivotably connected to the seat assembly 100. Specifically, the first stopper 5A2 is accommodated in the first accommodating cavity 113, and the first stopper 5A2 is pivotably connected to the seat body 111. The first stopper 5A2 has a first stopper hook portion 5A21. The first stopper hook portion 5A21 is adapted to be engaged with the first sliding pin 5A1 to prevent sliding of the first sliding pin 5A1 relative to the seat assembly 100, so that pivoting of the upper front leg 221 relative to the seat assembly 100 is inhibited and the frame 200 is locked in the unfolded state. That is, the unfold locking mechanism 5A is in the locked state. The unfold locking mechanism elastic member 5A4 is accommodated in the first accommodating cavity 113 and arranged between the first stopper 5A2 and the seat body 111. The unfold locking mechanism elastic member 5A4 includes a torsional spring. The unfold locking mechanism elastic member 5A4 is adapted to bias the first stopper 5A2 to pivot towards the first sliding pin 5A1, so that the first stopper hook portion 5A21 is engaged with the first sliding pin 5A1, thereby locking the frame 200 in the unfolded state, to prevent accidental folding of the frame 200 when the infant carrier is used as a stroller. In this embodiment, referring to FIG. 69 and FIG. 71, the first stopper hook portion 5A21 is provided with a first wedge surface 5A22. The first wedge surface 5A22 is adapted to be pushed by the first sliding pin 5A1, so that the first stopper 5A2 can be operated without any external force, and the first sliding pin 5A1 can enter the first stopper hook portion 5A21 and engage with the first stopper hook portion 5A21 by pushing against the first wedge surface 5A22. Referring to FIG. 64 and FIG. 68, the second seat housing 1122 is located at the unfold locking mechanism 5A to facilitate assembly of the unfold locking mechanism 5A.

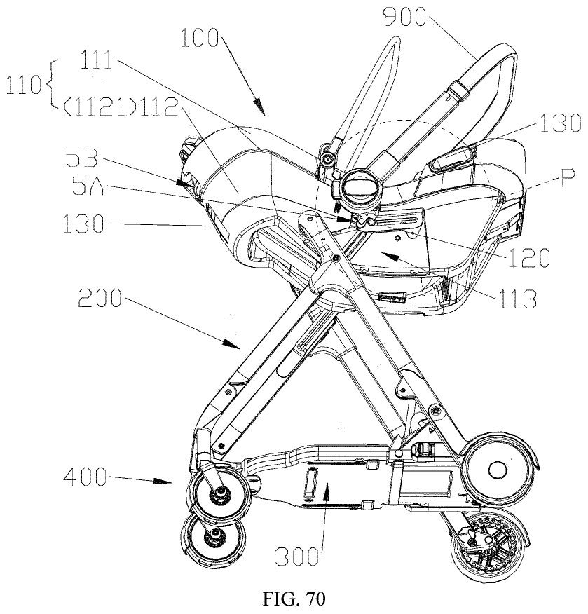

In an embodiment, as shown in FIG. 68, FIG. 70 and FIG. 72, the infant carrier further includes an unfold unlocking mechanism 5B. The unfold unlocking mechanism 5B is adapted to drive the first stopper 5A2 to pivot in a direction away from the first sliding pin 5A1, to disengage the first stopper hook portion 5A21 from the first sliding pin 5A1. The unfold unlocking mechanism 5B includes a first operating member 5B1 and two first traction members (not shown). The first operating member 5B1 is connected to the first stopper 5A2. Specifically, the first operating member 5B1 is respectively connected to the first stopper 5A2 located on two sides of the seat assembly 100 through the two first traction members (not shown). The first operating member 5B1 is operably arranged on the seat assembly 100. The first operating member 5B1 is adapted to drive the first stopper 5A2 to pivot in a direction away from the first sliding pin 5A1 when operated, to disengage the first stopper hook portion 5A21 from the first sliding pin 5A1, thereby enabling the frame 200 to switch from the unfolded state to the folded state. Referring to FIG. 72, the first seat housing 1121 is provided with a first concave portion 1123, and the first concave portion 1123 is arranged on a front side or a rear side of the seat body 111. In this embodiment, the first concave portion 1123 is arranged on the front side of the seat body 111. The first concave portion 1123 is provided with a first opening (not shown), and the first opening (not shown) is arranged through the first seat housing 1121. The first operating member 5B1 includes a first connecting portion (not shown) and a first operating portion 5B11 connected to the first connecting portion (not shown), and the first connecting portion (not shown) is inserted into the first accommodating cavity 113 and connected to the first traction members. At least part of the first operating portion 5B11 passes through the first opening (not shown) and is movable along the first opening (not shown). The first operating portion 5B11 as a whole does not exceed an outer surface of the first seat housing 1121. Referring to FIG. 72, the first operating member 5B1 may move back and forth in a direction shown by D1. That is, the first operating member 5B1 may generally move along an up-down direction, or the first operating member 5B1 may at least have a movable component that moves along the up-down direction. An end portion of the first opening (not shown) is adapted to abut against the first operating portion 5B11 to limit a movement stroke of the first operating member 5B1.

In this embodiment, the first traction member (not shown) is a traction rope, and the traction rope has one end connected to the first operating member 5B1 and the other end connected to the first stopper 5A2. The traction rope may be, for example, a hemp rope, a nylon rope, a steel wire rope, or a carbon fiber rope. The first traction member (not shown) is accommodated in the first accommodating cavity 113, so that an appearance of the infant carrier simpler.

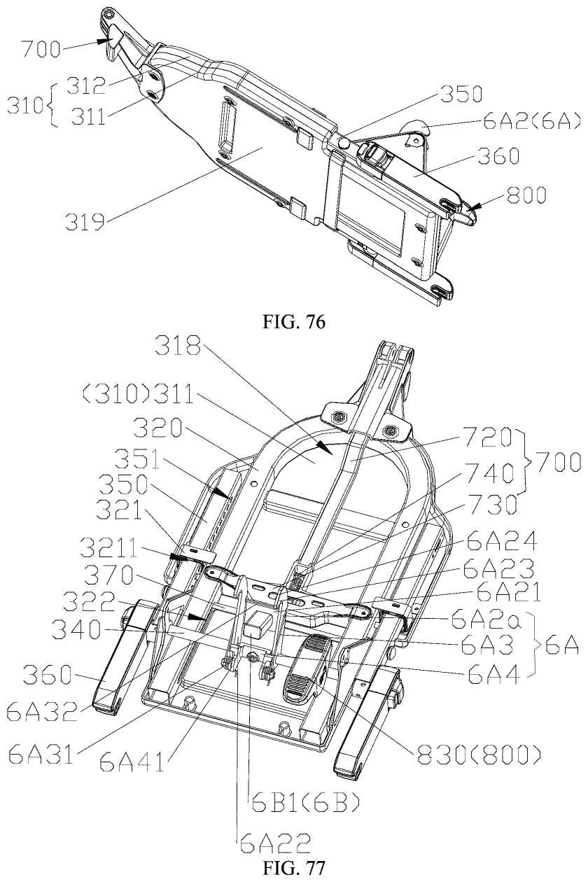

In an embodiment, as shown in FIG. 75 to FIG. 77, the base 300 includes a base body 310 and a base bracket 320. The base body 310 includes a first housing 311 and a second housing 312. The first housing 311 and the second housing 312 define a fourth accommodating cavity 318. The base bracket 320 is accommodated in the fourth accommodating cavity 318 and connected to the first housing 311.

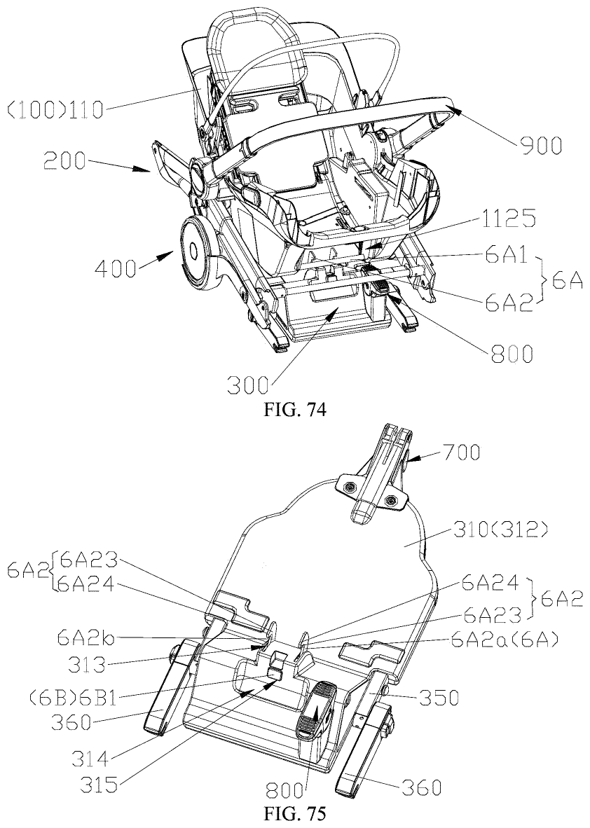

Referring to FIG. 74 to FIG. 77 together, the infant carrier further includes a fold locking mechanism 6A. The fold locking mechanism 6A is adapted to lock the frame 200 in the folded state. The fold locking mechanism 6A includes a fixed rod 6A1, a locking member 6A2, a fold locking mechanism elastic member 6A3, and a fixed member 6A4. The fixed rod 6A1 is connected to the seat assembly 100. Specifically, the fixed rod 6A1 is connected to the seat housing 112. The seat housing 112 has a second concave portion 1125, and the fixed rod 6A1 is arranged at the second concave portion 1125.

As shown in FIG. 75 to FIG. 77, the locking member 6A2 is pivotably connected to the base 300, and the locking member 6A2 has a locking member hook portion 6A23. The locking member hook portion 6A23 is adapted to be engaged with the fixed rod 6A1 (refer to FIG. 74) to lock the frame 200 in the folded state. The locking member 6A2 includes a fourth locking member 6A2a, a fifth locking member 6A2b, and a second connecting member 6A21 located between the fourth locking member 6A2a and the fifth locking member 6A2b. Two ends of the second connecting member 6A21 are respectively connected to the fourth locking member 6A2a and the fifth locking member 6A2b. The second connecting member 6A21 is in a shape of a plate to increase a mounting area. The fourth locking member 6A2a and the fifth locking member 6A2b have a same structure. The fourth locking member 6A2a is taken as an example for description. The fourth locking member 6A2a includes a locking member connecting portion 6A22 and a locking member hook portion 6A23, the locking member connecting portion 6A22 is connected to the locking member hook portion 6A23, and the second connecting member 6A21 is connected to the locking member connecting portion 6A22. The second housing 312 is provided with a second opening 313. The second opening 313 is arranged through the second housing 312. In this embodiment, the second opening 313 is in a shape of a strip. Two second openings 313 are provided, and the two second openings 313 allow the fourth locking member 6A2a and the fifth locking member 6A2b to pass through respectively. An end portion of each second opening 313 is adapted to abut against the locking member 6A2 to limit a stroke of the locking member 6A2. The base body 310 is provided with a locking member pivot shaft 340. Specifically, the locking member pivot shaft 340 is fixedly connected to the first housing 311 and accommodated in the fourth accommodating cavity 318. In this embodiment, the locking member pivot shaft 340 is not coaxially arranged with the first connecting rod 213. In other embodiments, the locking member pivot shaft 340 may be coaxially arranged with the first connecting rod 213. The locking member connecting portion 6A22 is pivotably connected to the locking member pivot shaft 340 and accommodated in the fourth accommodating cavity 318. The locking member hook portion 6A23 passes through the second opening 313 and extends out of the fourth accommodating cavity 318.

Referring to FIG. 75 and FIG. 77, the locking member hook portion 6A23 is provided with a second wedge surface 6A24. The second wedge surface 6A24 is adapted to be pushed by the fixed rod 6A1 (refer to FIG. 74). As a result, when the frame 200 is folded until the locking member 6A2 contacts the fixed rod 6A1, the locking member 6A2 can be operated without any external force, and the fixed rod 6A1 can push against the second wedge surface 6A24 and enters the locking member hook portion 6A23 for engagement therewith.

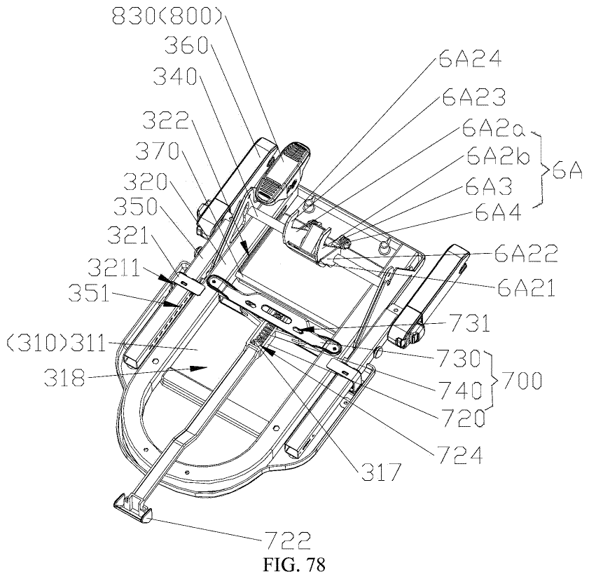

As shown in FIG. 77 and FIG. 78, the fixed member 6A4 is fixedly connected to the locking member pivot shaft 340. The fold locking mechanism elastic member 6A3 is arranged between the fixed member 6A4 and the locking member 6A2, and the fold locking mechanism elastic member 6A3 is adapted to bias the locking member 6A2 to pivot towards the fixed rod 6A1, so that the locking member hook portion 6A23 is engaged with the fixed rod 6A1. In this embodiment, the fold locking mechanism elastic member 6A3 is based on a double torsional spring structure. The fold locking mechanism elastic member 6A3 includes two spring portions 6A31 and a U-shaped connecting portion 6A32 connecting the two spring portions 6A31. The fixed member 6A4 has two spring mounting portions 6A41. The two spring portions 6A31 are respectively fastened to the spring mounting portions 6A41. The U-shaped connecting portion 6A32 abuts against the fourth locking member 6A2a and the fifth locking member 6A2b respectively. In this way, the fold locking mechanism elastic member 6A3 can be easily disassembled and assembled. In other embodiments not shown, the fold locking mechanism elastic member 6A3 may alternatively have other structures, as long as the structures can bias the locking member 6A2 to pivot towards the fixed rod 6A1 so that the locking member hook portion 6A23 is engaged with the fixed rod 6A1. For example, the fold locking mechanism elastic member 6A3 is a single torsional spring. The single torsional spring is arranged on the fixed member 6A4 or the locking member pivot shaft 340 and abuts against the locking member 6A2.

In an embodiment, as shown in FIG. 75 and FIG. 77, the infant carrier further includes a fold unlocking mechanism 6B. The fold unlocking mechanism 6B is adapted to drive the locking member 6A2 to pivot in a direction away from the fixed rod 6A1, to disengage the locking member hook portion 6A23 from the fixed rod 6A1 (refer to FIG. 74). The fold unlocking mechanism 6B includes a second operating member 6B1, the second operating member 6B1 is connected to the locking member 6A2, and the second operating member 6B1 is adapted to, when operated, drive the locking member 6A2 to pivot in the direction away from the fixed rod 6A1, to disengage the locking member hook portion 6A23 from the fixed rod 6A1. The second operating member 6B1 is operably arranged on the base 300. In this embodiment, the second housing 312 has a third concave portion 314, the third concave portion 314 is provided with a third opening 315, and the third opening 315 is arranged through the second housing 312. The second operating member 6B1 has one end accommodated in the fourth accommodating cavity 318 and connected to the second connecting member 6A21 and the other end passing through the third opening 315 and extending out of the fourth accommodating cavity 318, to facilitate operating the second operating member 6B1.

The infant carrier in this embodiment is switched from the stroller to the safety seat (i.e., the frame 200 of the infant carrier is switched from the unfolded state to the folded state) based on the following principle.

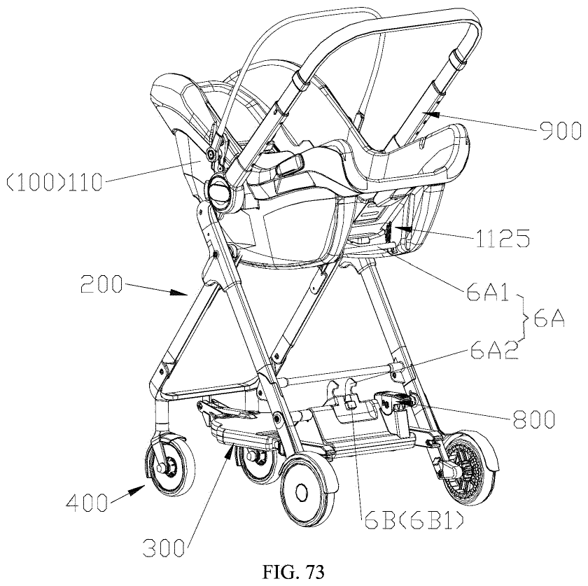

As shown in FIG. 71 and FIG. 72, the first operating member 5B1 is pressed to move under an external force, and the first operating member 5B1 drives the first stopper 5A2 to pivot through the first traction member (not shown), so that the first stopper hook portion 5A21 is disengaged from the first sliding pin 5A1, thereby enabling the first sliding pin 5A1 to slide in the strip groove 121. That is, the upper front leg 221 is pivotable. In this case, by pushing the front wheel assembly 420 or the rear wheel assembly 410 inwards, the lower front leg 222 or the lower rear leg 212 is forced to fold inwards, causing the upper front leg 221 to slide relative to the seat 110 and also causing the upper rear leg 211 to pivot relative to the seat 110, thereby folding the frame 200, as shown in FIG. 73 to FIG. 74. Alternatively, after the first stopper hook portion 5A21 is disengaged from the first sliding pin 5A1, only the front wheel 421 or the rear wheel 411 is put on the ground (which may be one or two front wheels 421 on a same side, or one or two rear wheels 411 on a same side), and at the same time, a downward pressing force towards the ground is applied, so that the lower front leg 222 or the lower rear leg 212 is forced to fold inwards, causing the upper front leg 221 to slide relative to the seat 110 and also causing the upper rear leg 211 to pivot relative to the seat 110, thereby folding the frame 200. When the frame 200 is fully folded, as shown in FIG. 74 and FIG. 75, the fixed rod 6A1 pushes against the second wedge surface 6A24 and causes the locking member 6A2 to pivot, so that the fixed rod 6A1 enters the locking member hook portion 6A23 of the locking member 6A2 and engages therewith, thereby locking the frame 200 in the folded state. In this case, the infant carrier may be used as the safety seat.

The infant carrier is switched from the safety seat to the stroller (i.e., the frame 200 of the infant carrier is switched from the folded state to the unfolded state) based on the following principle.

As shown in FIG. 75 and FIG. 77, the second operating member 6B1 is pressed to move under an external force, and the second operating member 6B1 drives the locking member 6A2 to pivot, causing the locking member hook portion 6A23 to be disengaged from the fixed rod 6A1, so that the seat assembly 100 can move relative to the base 300. That is, the frame 200 can switch from the folded state to the unfolded state, as shown in FIG. 74 to FIG. 73. In this case, the seat assembly 100 is lifted, and a force is applied to the front bracket 220 or the rear bracket 210 of the frame 200 (the force may include gravity of the frame 200 and the base 300, and may also include other forces acting on the frame 200), thereby causing the frame 200 to switch from the folded state to the unfolded state. When the frame 200 is fully unfolded, as shown in FIG. 69, the first sliding pin 5A1 pushes against the first wedge surface 5A22 to cause the first stopper 5A2 to pivot, so that the first sliding pin 5A1 enters the first stopper hook portion 5A21 and engages therewith, thereby locking the frame 200 in the unfolded state. In this case, the infant carrier may be used as the stroller.

In an embodiment, as shown in FIG. 75 and FIG. 77, the base 300 further includes two sliding rods 350, two ISOFIX connectors 360 on two sides of the base bracket 320, and a linkage rod 370 connected to the two sliding rods 350. The two ISOFIX connectors 360 are both adapted to be attached to an ISOFIX interface in the vehicle. Part of each of the two sliding rods 350 is accommodated in the fourth accommodating cavity 318. Each of the sliding rods 350 has one end connected to one of the two ISOFIX connectors 360 and the other end slidably connected to the base bracket 320. Specifically, the base bracket 320 further includes two sliding sleeves 321 located on two opposite sides of the base bracket 320, each of the two sliding sleeves 321 is provided with a third through hole 3211, and one end of the corresponding sliding rod 350 passes through the third through hole 3211 and is slidably connected to the base bracket 320. The base bracket 320 is provided with two strip-shaped first guide holes 322. Two ends of the linkage rod 370 respectively pass through the first guide holes 322 and are connected to the two sliding rods 350. The linkage rod 370 can move along the first guide holes 322, thereby realizing linkage of the two sliding rods 350.

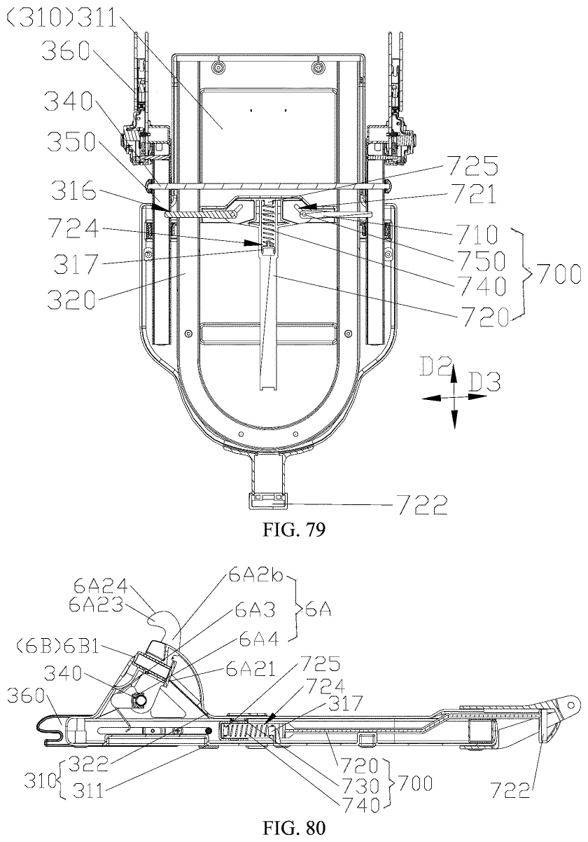

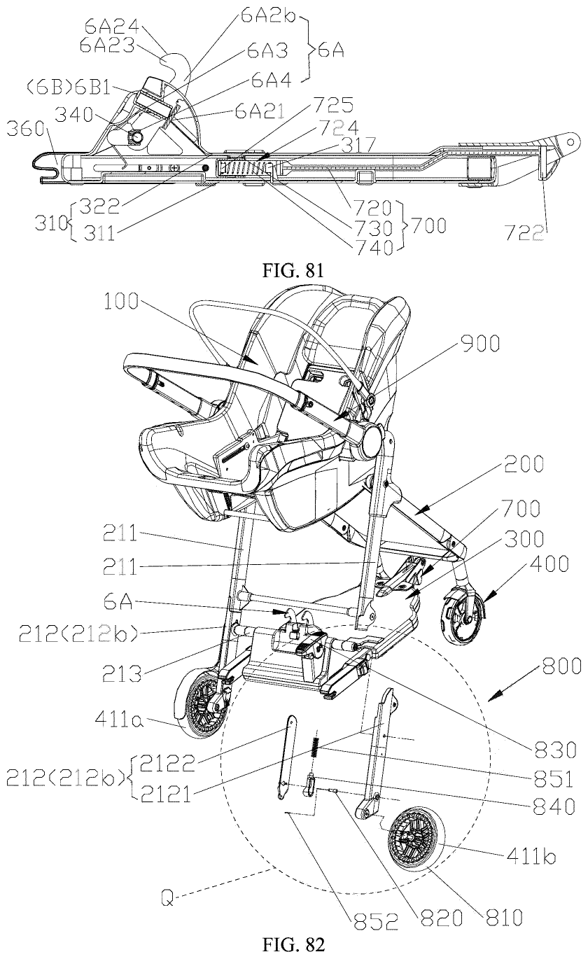

As shown in FIG. 77, FIG. 79, and FIG. 81, the infant carrier further includes an adjustment device 700. The adjustment device 700 is adapted to releasably lock the sliding rods 350 to the base bracket 320. The adjustment device 700 may be releasably connected to only one of the sliding rods 350 or releasably connected to both the two sliding rods 350. In this embodiment, the adjustment device 700 is releasably connected to both the two sliding rods 350. The ISOFIX connectors 360 are slidably connected to the base body 310 through the two sliding rods 350, and the sliding rods 350 are releasably locked at required positions through the adjustment device 700, so that relative positions between the ISOFIX connectors 360 and the base body 310 can be adjusted conveniently. As a result, when the infant carrier is used as the safety seat, the ISOFIX connectors 360 may be easily moved and fixed at required positions to facilitate connecting the ISOFIX connectors 360 to the ISOFIX interface, and a distance between the base 300 and the ISOFIX interface may be adjusted as required. When the infant carrier is used as the stroller, the ISOFIX connectors 360 may be retracted to prevent bumping or blocking of a trolley operator caused by excessive extension of the ISOFIX connectors 360 beyond the frame 200.

Further, as shown in FIG. 77 and FIG. 79 to FIG. 81, the adjustment device 700 includes a second stopper 710, a third operating member 720, a holder 730, and an adjustment device elastic member 740. In this embodiment, two second stoppers 710 are provided, and the two second stoppers 710 are movably connected to the third operating member 720 respectively. Moreover, the two second stoppers 710 are movably arranged on the base 300, and are adapted to releasably lock the two sliding rods 350 to the base bracket 320. Each of the two sliding rods 350 is provided with a plurality of adjustment holes 351. The base bracket 320 is provided with two stop holes 316 at positions corresponding to the two second stoppers 710 respectively, to respectively allow the two second stoppers 710 to pass through. The two second stoppers 710 each are in a shape of a rod. One end of each of the two second stoppers 710 is accommodated in the fourth accommodating cavity 318 and connected to the third operating member 720, and the other end of each of the two second stoppers 710 is adapted to pass through the corresponding stop hole 316 and be inserted into one of the adjustment holes 351 in the corresponding sliding rod 350, to releasably lock the corresponding sliding rod 350 to the base bracket 320.

As shown in FIG. 79 to FIG. 81, the third operating member 720 is operably arranged on the base 300 and is connected to the two second stoppers 710. The third operating member 720 is adapted to drive the two second stoppers 710 to move synchronously to lock the two sliding rods 350 to the base bracket 320 or to unlock the two sliding rods 350 from the base bracket 320. The third operating member 720 is partially accommodated in the fourth accommodating cavity 318 and is provided with two first driving grooves 721. The other end of each of the second stoppers 710 is provided with a first driving pin 750. The first driving pin 750 is inserted into and engaged with the corresponding first driving groove 721 and is movable along the first driving groove 721. The first driving groove 721 has a first position and a second position. When the first driving pin 750 is at the first position in the first driving groove 721, the two sliding rods 350 are locked to the base bracket 320. When the first driving pin 750 is at the second position in the first driving groove 721, the two sliding rods 350 are unlocked from the base bracket 320. A movement direction D2 of the third operating member 720 forms an angle with a movement direction of the second stopper 710. In this embodiment, the movement direction D2 of the third operating member 720 and the movement direction D3 of the second stopper 710 generally form an angle of 90°. An extension direction of the first driving groove 721 intersects with and is not perpendicular to the movement direction D3 of the second stopper 710. Referring to FIG. 78 and FIG. 79, the third operating member 720 has an operating hook portion 722, and the operating hook portion 722 is located outside the fourth accommodating cavity 318 to facilitate operating the third operating member 720. The third operating member 720 further has a receiving groove 724. The receiving groove 724 is located between the two first driving grooves 721. An end portion of the receiving groove 724 is provided with a first projection 725. The base 300 is correspondingly provided with a second projection 317. The second projection 317 is accommodated in the fourth accommodating cavity 318 and arranged on the first housing 311. The second projection 317 is arranged opposite to the first projection 725.

As shown in FIG. 78 to FIG. 81, the adjustment device elastic member 740 includes a spring, and two ends of the adjustment device elastic member 740 are connected to the first projection 725 and the second projection 317 respectively. The adjustment device elastic member 740 is adapted to bias the third operating member 720 to cause the third operating member 720 to be at an initial position when not operated.

As shown in FIG. 77 and FIG. 78, the holder 730 is connected to the base 300, the holder 730 is provided with a third guide groove 731, the third guide groove 731 is configured to guide movement of the second stopper 710, and the first driving pin 750 is inserted into and engaged with the third guide groove 731 and is movable along the third guide groove 731. Through the third guide groove 731, the second stopper 710 can be guided to move in a predetermined direction, and amplitude of deflection of the third operating member 720 in a left-right direction during the movement can be further reduced. An end portion of the third guide groove 731 is adapted to abut against the first driving pin 750 to limit a movement stroke of the second stopper 710. Two ends of the holder 730 are connected to the base bracket 320 respectively, and the third operating member 720 is located between the holder 730 and the first housing 311, which can reduce amplitude of deflection of the third operating member 720 in an up-down direction during the movement.

In this embodiment, a position adjustment process of the ISOFIX connector 360 is as follows.

As shown in FIG. 78 and FIG. 79, the third operating member 720 is pulled under an external force, and the two first driving grooves 721 of the third operating member 720 drive the first driving pin 750 to move along the third guide groove 731, so that the first driving pin 750 moves from the first position of the first driving groove 721 to the second position and drives the two second stoppers 710 to move towards each other at the same time, thereby disengaging the two second stoppers 710 from the adjustment holes 351. That is, the sliding rod 350 is movable relative to the base body 310. In this case, the position of the ISOFIX connector 360 can be adjusted by moving the sliding rod 350. When the position of the ISOFIX connector 360 is adjusted to a required position, an external force applied to the third operating member 720 is canceled, and the adjustment device elastic member 740 biases the first projection 725, so that the third operating member 720 returns to the initial position and drives the first driving pin 750 to move from the second position of the first driving groove 721 to the first position, thereby engaging the second stopper 710 with the adjustment hole 351 to lock the sliding rod 350 to the base bracket 320.

In an embodiment, as shown in FIG. 82 to FIG. 85, the infant carrier further includes a braking mechanism 800. The braking mechanism 800 is switchable between a locked state and an unlocked state. When the braking mechanism 800 is in the locked state, at least one predetermined wheel 810 in the wheels cannot rotate. When the braking mechanism 800 is in the unlocked state, the wheels 411 and 421 including the predetermined wheel 810 can rotate. The predetermined wheel 810 includes a first rear wheel 411a arranged on the first lower rear leg 212a and a second rear wheel 411b arranged on the second lower rear leg 212b. The predetermined wheel 810 is circumferentially provided with a plurality of second brake holes 813 along a hub 811 thereof. Specifically, the hub 811 of the predetermined wheel 810 is provided with a plurality of posts 812, and an end of each post 812 facing the frame 200 is provided with a second brake hole 813.

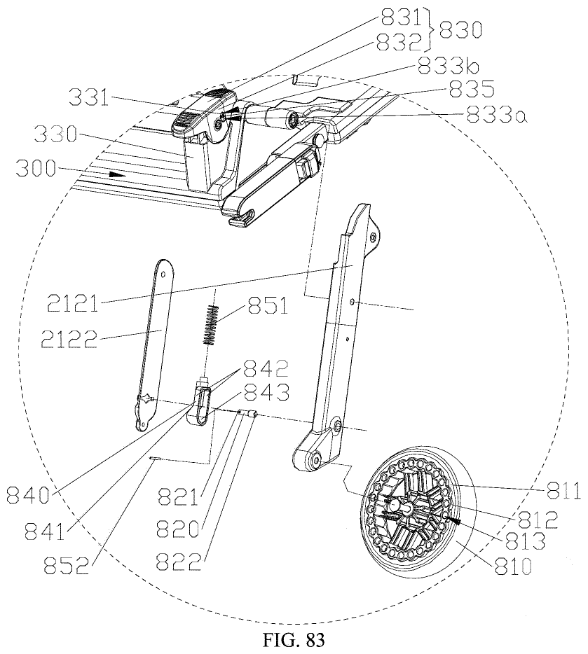

As shown in FIG. 83 to FIG. 85, the braking mechanism 800 includes a locking pin 820, a pedal member 830, a third driving member 840, a second traction member (not shown), a first braking mechanism elastic member 851, and a second braking mechanism elastic member 853. At least two locking pins 820, at least two third driving members 840, at least two first braking mechanism elastic members 851, at least two second braking mechanism elastic members 853, and at least two second traction members are provided, and one pedal member 830 is provided. The at least two locking pins 820 are arranged in one-to-one correspondence to the at least two third driving members 840 respectively, and the at least two third driving members 840 are respectively connected to a same pedal member 830 through the second traction members (not shown), so that the locking pins 820 can be driven to move together through one pedal member 830. In other embodiments, a number of the pedal member 830 may alternatively correspond to that of the locking pin 820, so as to drive the corresponding locking pins 820 to operate through different pedal members 830 respectively.

Two locking pins 820 are provided, and the two locking pins 820 are movably arranged on the frame 200 respectively. In this embodiment, the two locking pins 820 are movably arranged on the first lower rear leg 212a and the second lower rear leg 212b respectively. The locking pin 820 arranged on the second lower rear leg 212b is taken as an example below for description.

As shown in FIG. 83 to FIG. 85, the locking pin 820 is movable between an unlock position and a lock position. The locking pin 820 has a second connecting end 821 and a locking end 822. The second lower rear leg 212b includes a first leg housing 2121 and a second leg housing 2122. The first leg housing 2121 and the second leg housing 2122 define a third accommodating cavity 2123. Specifically, to facilitate disassembly and assembly, the second leg housing 2122 is detachably connected to the first leg housing 2121. The second connecting end 821 is accommodated in the third accommodating cavity 2123 and is movable in the third accommodating cavity 2123. When the locking pin 820 is at the lock position, the locking end 822 extends from the frame 200 and is engaged with one of the plurality of second brake holes 813. When the locking pin 820 is at the unlock position, the locking end 822 is located in the frame 200 and is disengaged from the one of the plurality of second brake holes 813. The second lower rear leg 212b is provided with a guide portion 2124 and a second guide hole 2125. The guide portion 2124 is accommodated in the third accommodating cavity 2123 and arranged on the first leg housing 2121, and the second guide hole 2125 is arranged in the guide portion 2124 and through the guide portion 2124 and the first leg housing 2121 and is communication with the third accommodating cavity 2123. The locking pin 820 is inserted into the second guide hole 2125 and is movable along the second guide hole 2125. The second guide hole 2125 is adapted to guide the locking pin 820 to move along a predetermined direction (e.g., a direction D5). The second connecting end 821 of the locking pin 820 extends out of the second guide hole 2125 to be drivingly connected to the third driving member 840.

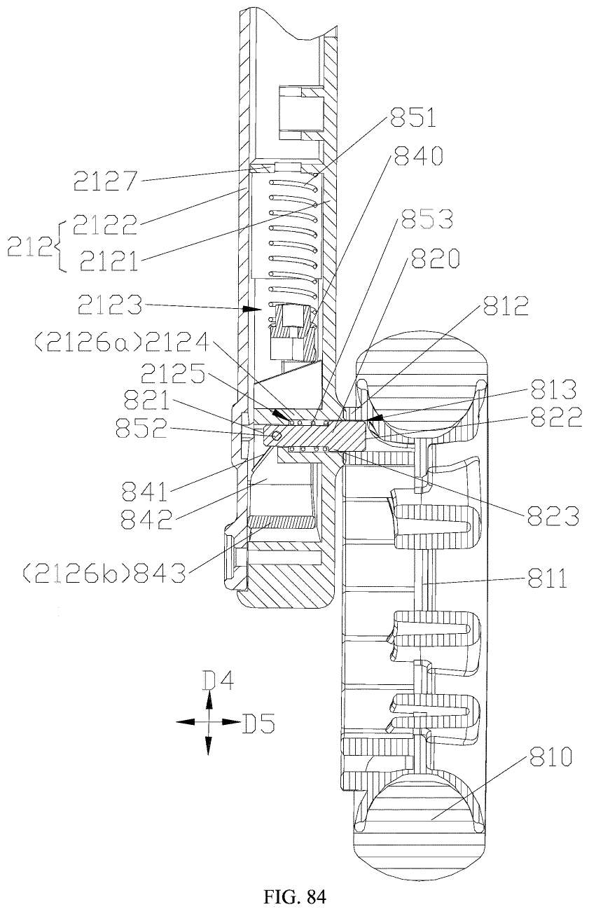

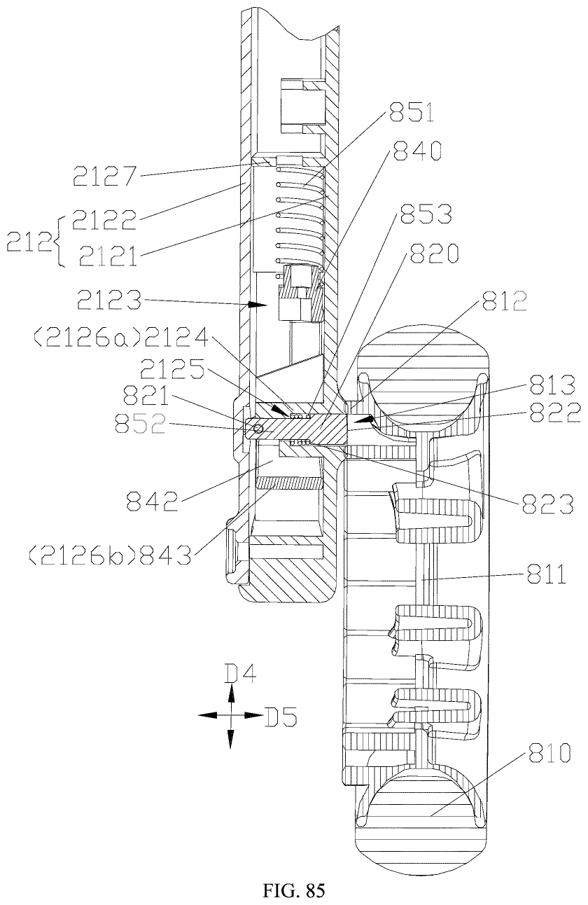

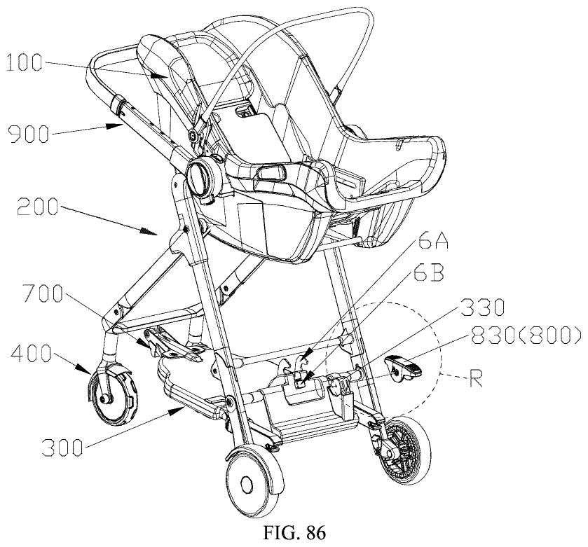

As shown in FIG. 83, FIG. 84, and FIG. 86, the third driving member 840 is movably arranged in the frame 200. Specifically, the third driving member 840 is accommodated in the third accommodating cavity 2123. The third driving member 840 is movably connected to the locking pin 820 to drive the locking pin 820 to move. Referring to FIG. 84 and FIG. 85, a movement direction D4 of the third driving member 840 intersects with a movement direction D5 of the locking pin 820, and the pedal member 830 is connected to the third driving member 840 to drive the third driving member 840 to move. The third driving member 840 has a driving surface 841. The second connecting end 821 of the locking pin 820 is provided with a second driving pin 852. The second driving pin 852 abuts against the driving surface 841. When the driving surface 841 is configured such that when the third driving member 840 moves, the driving surface 841 causes the second driving pin 852 to move to drive the locking pin 820 to move. The driving surface 841 may be an inclined surface or a curved surface. The third driving member 840 includes two first side plates 842 arranged opposite to each other and a first connecting plate 843 connected between the two first side plates 842. The two first side plates 842 are both provided with the driving surface 841. The guide portion 2124 is located between the two first side plates 842. The guide portion 2124 is formed as a first movement limiting portion 2126a. When the third driving member 840 moves upwards along the direction D4, the first movement limiting portion 2126a is adapted to abut against an inner side of the first connecting plate 843 to limit a movement stroke of the third driving member 840, thereby preventing slipping of the second driving pin 852 from the driving surface 841 caused by excessive movement of the third driving member 840. A bottom wall of the third accommodating cavity 2123 is formed as a second movement limiting portion 2126b. When the third driving member 840 moves downwards along the direction D4, the second movement limiting portion 2126b is adapted to abut against an outer surface of the first connecting plate 843 to limit the movement stroke of the third driving member 840.

In this embodiment, the first braking mechanism elastic member 851 is arranged between the third driving member 840 and the frame 200. The first braking mechanism elastic member 851 is adapted to bias the third driving member 840, so that the locking pin 820 can move to the lock position. The first braking mechanism elastic member 851 includes a spring. One end of the first braking mechanism elastic member 851 abuts against the third driving member 840. The other end of the first braking mechanism elastic member 851 abuts against an abutting portion 2127 protruding from a side wall of the third accommodating cavity 2123.

The second braking mechanism elastic member 853 is arranged between the frame 200 and the locking pin 820. The second braking mechanism elastic member 853 is adapted to bias the locking pin 820 to move towards the lock position. The second braking mechanism elastic member 853 includes a spring. The second braking mechanism elastic member 853 is accommodated in the second guide hole 2125. The locking pin 820 has a convex portion 823, the second braking mechanism elastic member 853 sleeves the locking pin 820, and the second braking mechanism elastic member 853 has one end abutting against a bottom wall of the second guide hole 2125 and the other end abutting against the convex portion 823 (refer to FIG. 84).

As shown in FIG. 82 and FIG. 83, the pedal member 830 is pivotably arranged on the base 300, and the pedal member 830 is pivotable between a travel position and a stop position. When the pedal member 830 pivots from the travel position to the stop position, the pedal member 830 is adapted to drive the locking pin 820 to move from the unlock position to the lock position. When the pedal member 830 pivots from the stop position to the travel position, the pedal member 830 is adapted to drive the locking pin 820 to move from the lock position to the unlock position.

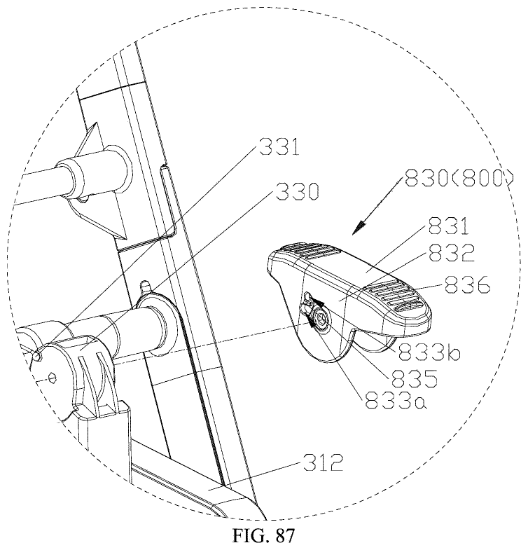

Further, as shown in FIG. 86 to FIG. 87, the base 300 is provided with a brake connecting portion 330, and the brake connecting portion 330 is arranged on the second housing 312. The pedal member 830 is pivotably connected to the brake connecting portion 330. The pedal member 830 includes a footrest portion 831 and two lug portions 832 respectively connected to the footrest portion 831. An upper surface of the footrest portion 831 is provided with a skidproof stripe 836. The skidproof stripe 836 includes a plurality of mutually parallel transverse stripes to increase friction when the footrest portion 831 is operated. Referring to FIG. 87, the two lug portions 832 are arranged opposite to each other. The two lug portions 832 are respectively provided with at least two engaging recesses 833a and 833b in communication with each other. The brake connecting portion 330 is located between the two lug portions 832 and is pivotably connected to the two lug portions 832. The brake connecting portion 330 is provided with an engaging protrusion 331. The engaging protrusion 331 is arranged on two sides of the brake connecting portion 330 facing the two lug portions 832 respectively. The engaging protrusion 331 can be engaged with any one of the engaging recesses 833a and 833b. An elastic sheet 835 that can lock the engaging protrusion 331 in any one of the engaging recesses 833a and 833b is arranged between two adjacent engaging recesses 833a and 833b, to lock the pedal member 830 at the travel position or the stop position. The pedal member 830 is operable to overcome an elastic force of the elastic sheet 835, so that the engaging protrusion 331 is engaged with different engaging recesses 833a and 833b. In this embodiment, the at least two engaging recesses 833a and 833b include a first engaging recess 833a and a second engaging recess 833b. The second engaging recess 833b is located above the first engaging recess 833a. That is, the second engaging recess 833b is closer to the footrest portion 831 relative to the first engaging recess 833a. When the engaging protrusion 331 is engaged with the first engaging recess 833a, the pedal member 830 is at the travel position. When the engaging protrusion 331 is engaged with the second engaging recess 833b, the pedal member 830 is at the stop position.

In other embodiments not shown, similarly, the brake connecting portion 330 is provided with the elastic sheet 835 and two engaging recesses 833a and 833b, and the lug portions 832 are correspondingly provided with the engaging protrusion 331. Specifically, the brake connecting portion 330 is located between the two lug portions 832 and is pivotably connected to the two lug portions 832. Two sides of the brake connecting portion 330 facing the two lug portions 832 are respectively provided with at least two engaging recesses 833a and 833b in communication with each other. A side of each of the lug portions 832 facing the brake connecting portion 330 is correspondingly provided with the engaging protrusion 331, so that the engaging protrusion 331 can be engaged with any one of the engaging recesses 833a and 833b. An elastic sheet 835 that can lock the engaging protrusion 331 in any one of the engaging recesses 833a and 833b is arranged between two adjacent engaging recesses 833a and 833b, to lock the pedal member 830 at the travel position or the stop position. The pedal member 830 is operable to cause the engaging protrusion 331 to overcome the elastic force of the elastic sheet 835, so that the engaging protrusion 331 is engaged with different engaging recesses 833a and 833b. The at least two engaging recesses 833a and 833b include a first engaging recess 833a and a second engaging recess 833b. The second engaging recess 833b is located above the first engaging recess 833a. That is, the second engaging recess 833b is closer to the footrest portion 831 relative to the first engaging recess 833a. When the engaging protrusion 331 is engaged with the second engaging recess 833b, the pedal member 830 is at the travel position. When the engaging protrusion 331 is engaged with the first engaging recess 833a, the pedal member 830 is at the stop position.

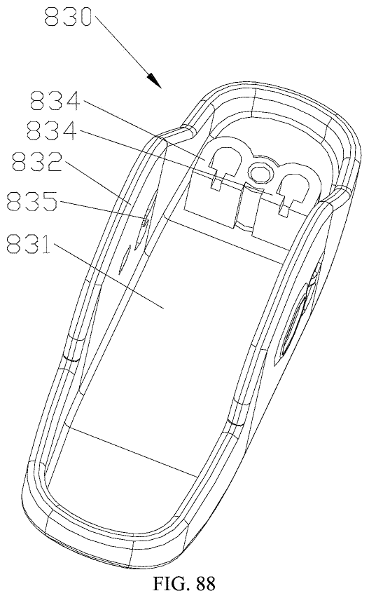

Further, the second traction member (not shown) includes a traction rope. One end of the second traction member (not shown) is connected to the pedal member 830, and the other end of the second traction member (not shown) is connected to the third driving member 840. Specifically, referring to FIG. 88, the pedal member 830 further has a traction connecting portion 834, and two traction connecting portions 834 are provided and are arranged on a lower surface of the footrest portion 831. Two second traction members (not shown) are connected to two traction connecting portions 834 respectively, thereby driving the two locking pins 820 to move together through one pedal member 830.

An operating principle of the braking mechanism 800 in this embodiment is specifically described below.

When the infant carrier serving as the stroller is in the braking state and is required to travel, as shown in FIG. 87, the pedal member 870 is pressed down and rotated, under an external force, the engaging protrusion 331 overcomes the elastic force of the elastic sheet 835 and is switched from the second engaging recess 833b to the first engaging recess 833a, and the pedal member 830 is switched from the stop position and is locked at the travel position. In this case, the pedal member 830 tightens the two second traction members (not shown), thereby driving the two third driving members 840 respectively located in the first lower rear leg 212a and the second lower rear leg 212b to simultaneously move upwards along the direction D4, as shown in FIG. 83 to FIG. 85. Then, the two third driving members 840, through the driving surface 841 thereon, drive the second driving pins 852 to move along the driving surface 841, thereby driving the locking ends 822 of the two locking pins 820 to exit the second brake holes on the two predetermined wheels 810 respectively and locking the two locking pins 820 at the unlock position, so that the wheels 411 and 412 including two predetermined wheels 810 can rotate relative to the first lower rear leg 212a and the second lower rear leg 212b, thereby enabling the infant carrier to travel.

When the infant carrier serving as the stroller is in a traveling state and is required to brake, as shown in FIG. 87, the pedal member 870 is pressed up and rotated, under an external force, the engaging protrusion 331 overcomes the elastic force of the elastic sheet 835 and is switched from the first engaging recess 833a to the second engaging recess 833b, and the pedal member 830 is switched from the travel position and is locked at the stop position. In this case, the pedal member 830 no longer tightens the two second traction members (not shown), and at least one third driving member 840 moves downwards along the direction D4 under an elastic restoring force of at least one first braking mechanism elastic member 851, as shown in FIG. 83 to FIG. 85. In this case, a pushing force of the driving surface 841 on the second driving pin 852 is eliminated, and the two locking pins 820 move towards the lock position along the direction D5 under an elastic restoring force of the second braking mechanism elastic member 853, so that the locking ends 822 of the two locking pins 820 are respectively engaged with one of the second brake holes 813 on the two predetermined wheels 810 and the two locking pins 820 are locked at the lock position. As a result, the two predetermined wheels 810 cannot rotate relative to the first lower rear leg 212a and the second lower rear leg 212b, thereby realizing the braking.

In an embodiment, referring to FIG. 64 and FIG. 89 to FIG. 90 together, the infant carrier further includes a movable assembly 900. The movable assembly 900 includes two connecting arms 910, a U-shaped handle body 920, a length adjustment mechanism 960, two pivot bases 940, and two pivot adjustment assemblies 950. The two pivot bases 940 are pivotably connected to two sides of the seat 110 respectively, and the two pivot adjustment assemblies 950 are adapted to releasably lock the pivot bases 940 at an angle. The pivot bases 940 each include a disc-shaped portion 941 and a pivot connecting portion 942 connected to a periphery of the disc-shaped portion 941. The pivot connecting portions 942 are connected to the connecting arms 910. A second receiving cavity 943 is formed on a side of the disc-shaped portion 941 facing the seat 110 (i.e., an inner side). The pivot adjustment assemblies 950 include a pivot operating member 952 and a pivot fixing member 951. The pivot operating member 952 is operably arranged on a side wall of the second receiving cavity 943 and is partially accommodated in the second receiving cavity 943. Specifically, an inner side of the pivot base 940 is provided with a third guide groove 944, one end of the third guide groove 944 is arrange through the side wall of the second receiving cavity 943, and the pivot operating member 952 is inserted into the third guide groove 944 and can move along the third guide groove 944. The pivot operating member 952 has an operation limiting portion 9522 and a pivot engaging protrusion 9521. The operation limiting portion 9522 is spaced apart from the side wall of the second receiving cavity 943 (i.e., the other end of the third guide groove 944), so that the pivot operating member 952 has a movement stroke along the third guide groove 944. An outer surface of the operation limiting portion 9522 is arc-shaped to better fit the side wall of the second accommodating cavity 943. The seat 110 is correspondingly provided with a plurality of pivot engaging recesses that can engage with the pivot engaging protrusion 9521 (not shown). The pivot engaging protrusion 9521 releasably is engaged with one of the pivot engaging recesses to lock the pivot base 940 at a required angle. An elastic reset member (not shown) is arranged between the pivot operating member 952 and the pivot base 940. The elastic reset member includes a spring. The elastic reset member is adapted to bias the pivot operating member 952 to cause the pivot engaging protrusion 9521 to be engaged with at least one of the plurality of pivot engaging recesses, so that the pivot base 940 is releasably locked at a required angle. The pivot fixing member 951 is arranged on one side of the disc-shaped portion 941 away from the receiving cavity 943 (i.e., an outer side).

When there is a need to adjust an angle of the pivot base 940, the pivot operating member 952 is operated to cause the pivot engaging protrusion 9521 to be disengaged from the engaging recess, and then the pivot base 940 is pivoted to a required angle and the pivot operating member 952 is released. In this case, the pivot base 940 moves under a restoring force of the elastic reset member, so that the pivot engaging protrusion 9521 is re-engaged with one of the plurality of pivot engaging recesses, thereby realizing angle adjustment of the pivot 940 and adjusting an angle between the movable assembly 900 and the seat 110, to meet use requirements of different scenarios.

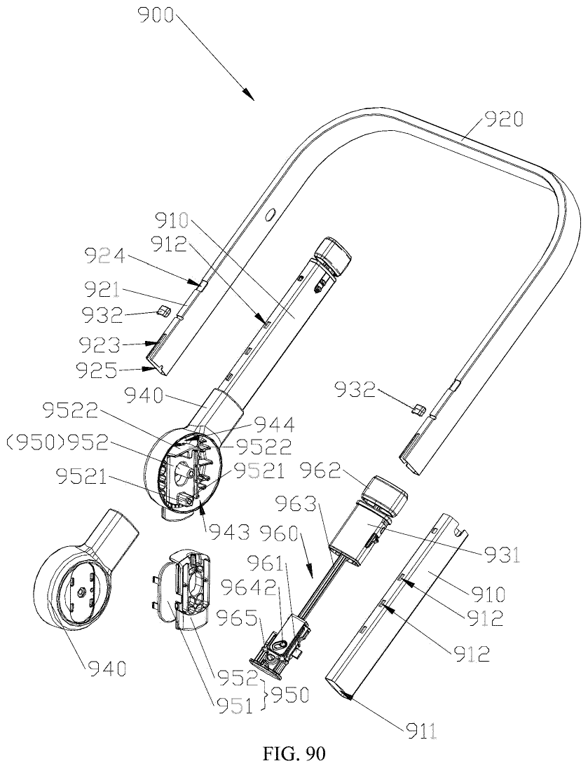

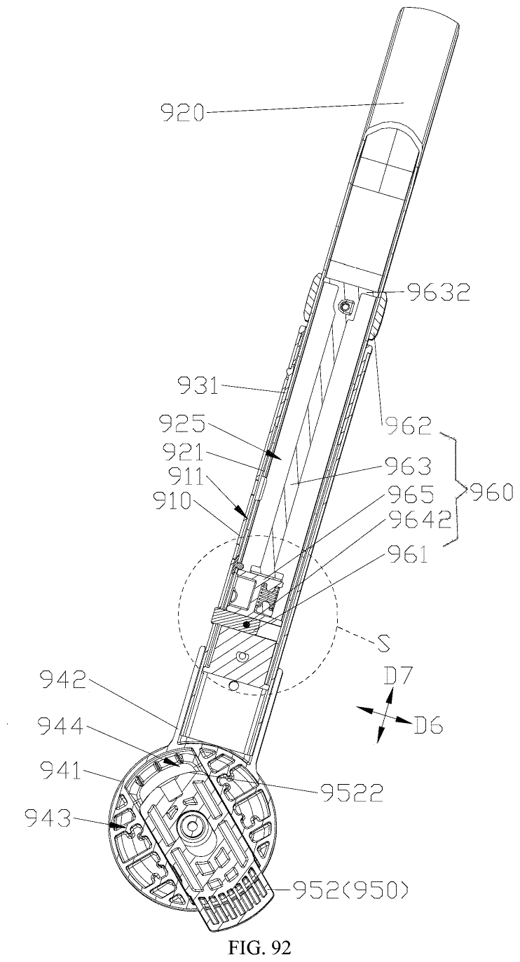

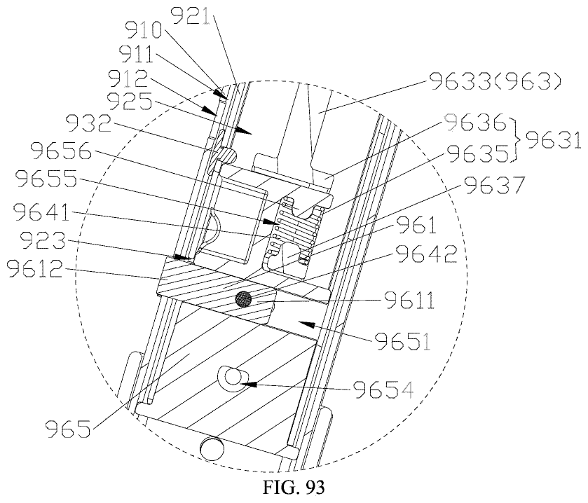

In an embodiment, as shown in FIG. 90, FIG. 92, and FIG. 93, the handle body 920 is provided with adjustment portions 921 at two ends respectively, and the two adjustment portions 921 are movably connected to the two connecting arms 910 respectively. The length adjustment mechanism 960 is switchable between the locked state and the unlocked state. When the length adjustment mechanism 960 is in the unlocked state, the adjusting portion 921 is movable relative to the connecting arm 910, so that the movable assembly 900 can be extended or contracted. When the length adjustment mechanism 960 is in the locked state, the adjusting portion 921 and the connecting arm 910 are relatively fixed.

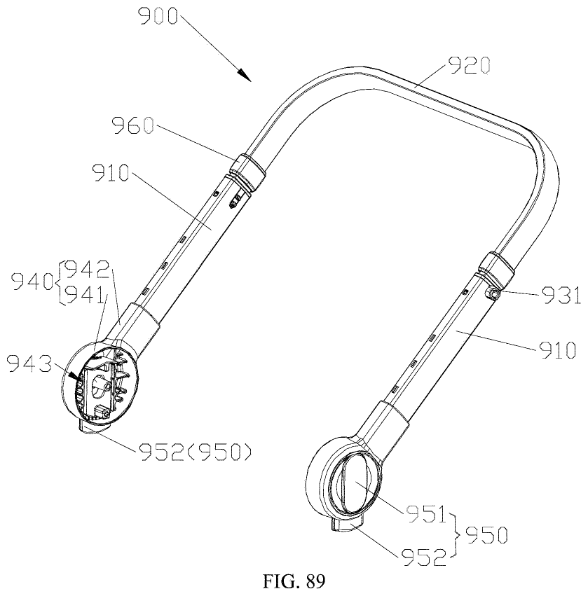

Referring to FIG. 89, FIG. 90, and FIG. 92, each of the connecting arms 910 is provided with a first hollow cavity 911 configured to accommodate the adjustment portion 921, and the first hollow cavity 911 is arranged through two ends of the connecting arm 910. Each of the two connecting arms 910 is provided with a plurality of positioning holes 912. The positioning holes 912 are arranged through a side wall of the first hollow cavity 911. For example, 2, 3, 4, 6, or 9 positioning holes 912 are provided. The movable assembly 900 further includes a handle holder 931. The handle holder 931 is fixedly connected to a tail end of the connecting arm 910, and at least part of the handle holder 931 is inserted into the first hollow cavity 911. The adjustment portion 921 passes through the handle holder 931 and is slidably connected to the connecting arm 910.

The two adjustment portions 921 are respectively inserted into the two connecting arms 910 and are slidable in the two connecting arms 910. The two adjustment portions 921 are accommodated in the first hollow cavities 911. The adjustment portions 921 are each provided with a second hollow cavity 925. The adjustment portions 921 are each provided with a limiting member 932. The limiting member 932 is configured to prevent complete removal of the handle body 920 from the connecting arm 910. The limiting member 932 is inserted into a side wall of the second hollow cavity 925. The limiting member 932 is accommodated in the first hollow cavity 911, and part of the limiting member 932 is located between the adjustment portion 921 and the connecting arm 910. The limiting member 932 is adapted to abut against the handle holder 931 to prevent complete sliding of the handle body 920 out of the connecting arm 910.

In an embodiment, as shown in FIG. 89 and FIG. 90, two length adjustment mechanisms 960 are provided, and the two length adjustment mechanisms 960 are located on the two sides of the seat 110 respectively. When there is a need to adjust the movable assembly 900, the two length adjustment mechanisms 960 of the seat 110 may be adjusted at the same time. For ease of description, one of the length adjustment mechanisms 960 is taken as an example below for description.

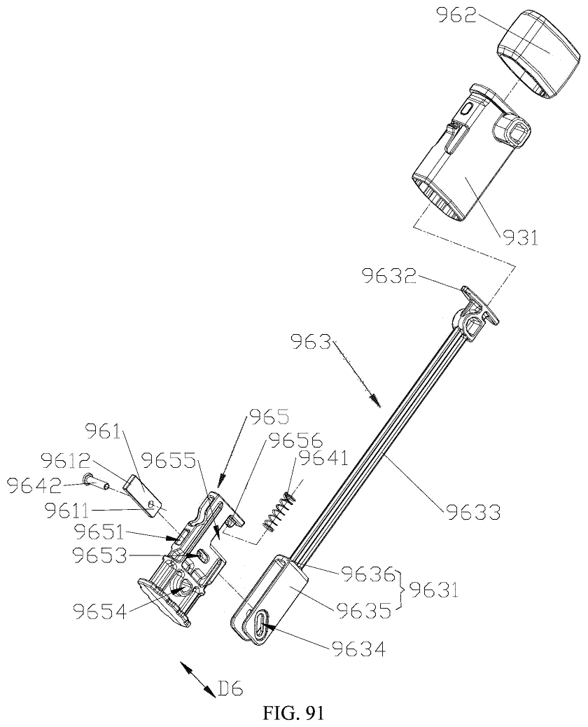

Further, referring to FIG. 91 to FIG. 93, the length adjustment mechanism 960 includes a positioning member 961, a pull handle 962, a pull rod 963, a length adjustment mechanism elastic member 9641, and a guide base 965. The positioning member 961 is connected to the pull handle 962 through the pull rod 963. The positioning member 961 is movably arranged in the adjustment portion 921 on the corresponding side and is switchable between an extend position and a retract position. When the positioning member 961 is at the extend position, the positioning member 961 is engaged with one or more of a plurality of positioning holes 912. When the positioning member 961 is at the retract position, the positioning member 961 is disengaged from the one or more positioning holes 912. That is, the positioning member 961 exits the one or more positioning holes 912, so that the adjustment portion 921 can slide relative to the connecting arm 910 on the corresponding side. In this embodiment, the positioning member 961 includes a movable connecting portion 9611 and a positioning portion 9612. The movable connecting portion 9611 is accommodated in the second hollow cavity 925 and is drivingly connected to the pull rod 963. The adjustment portion 921 has a first perforation 923 arranged through the side wall of the second hollow cavity 925. The positioning portion 9612 is adapted to pass through the first perforation 923 and be engaged with one of the plurality of positioning holes 912.

As shown in FIG. 91 and FIG. 93, the pull rod 963 includes a driving connecting portion 9631, an operation connecting portion 9632, and a connecting rod portion 9633 connected between the driving connecting portion 9631 and the operation connecting portion 9632. In this embodiment, the driving connecting portion 9631 is accommodated in the second hollow cavity 925 and is movably connected to the positioning member 961. Specifically, the driving connecting portion 9631 is U-shaped, the driving connecting portion 9631 includes two second side plates 9635 arranged opposite to each other and a second connecting plate 9636 connected between the two second side plates 9635, and the connecting rod portion 9633 has one end connected to the second connecting plate 9636 and the other end connected to the operation connecting portion 9632. The driving connecting portion 9631 is provided with a second driving groove 9634. Specifically, the two second side plates 9635 are each provided with the second driving groove 9634. The movable connecting portion 9611 of the positioning member 961 is provided with a third driving pin 9642, the third driving pin 9642 is inserted into and engaged with both the two second driving grooves 9634 and is movable along the second driving grooves 9634, an extension direction of each of the second driving grooves 9634 intersects with and is not perpendicular to a movement direction of the positioning member 961, and the extension direction of each of the second driving grooves 9634 intersects with and is not perpendicular to a movement direction of the pull rod 963. In other embodiments, alternatively, the movable connecting portion 9611 of the positioning member 961 is provided with a second driving groove 9634, the driving connecting portion 9631 is provided with a third driving pin 9642, the third driving pin 9642 is inserted into and engaged with the second driving groove 9634 and is movable along the second driving groove 9634, an extension direction of the second driving groove 9634 intersects with and is not perpendicular to a movement direction of the positioning member 961, and the extension direction of the second driving groove 9634 intersects with and is not perpendicular to a movement direction of the pull rod 963.

Referring to FIG. 90 and FIG. 92, the adjustment portion 921 is provided with a third strip hole 924, and the third strip hole 924 is arranged through the side wall of the second hollow cavity 925. Part of the operation connecting portion 9632 passes through the third strip hole 924 and extends out of the second hollow cavity 925, to be connected to the pull handle 962. The pull handle 962 is arranged around at least part of the periphery of the adjustment portion 921 and is movable along the adjustment portion 921. The pull handle 962 is connected to the operation connecting portion 9632 to drive the pull rod 963 to move. Specifically, the pull handle 962 is a hollow sleeve, and the pull handle 962 is arranged around the periphery of the adjustment portion 921 and abuts against the operation connecting portion 9632. The operation connecting portion 9632 is movable in the third strip hole 924. An end portion of the third strip hole 924 is adapted to abut against the operation connecting portion 9632 to limit a movement stroke of the pull rod 963, thereby limiting a movement stroke of the pull handle 962.

As shown in FIG. 92 and FIG. 93, the guide base 965 is arranged at a tail end of the handle body 920 and is inserted into the second hollow cavity 925. The guide base 965 is provided with a fixed hole 9654. The guide base 965 is fastened to the second hollow cavity 925 through a bolt connecting member arranged through the fixed hole 9654. The guide base 965 is provided with a third sliding groove 9651 and a fourth strip hole 9653. The third sliding groove 9651 is arranged transversely through the guide base 965. Referring to FIG. 91 to FIG. 93, an extension direction of the fourth strip hole 9653 is parallel to that of the third sliding groove 9651, both of which are along a direction D6. The positioning member 961 is movably arranged in the third sliding groove 9651 and is movable along the third sliding groove 9651. The third driving pin 9642 is connected to the positioning member 961, and passes through the fourth strip hole 9653 and is inserted into the second driving groove 9634, so that the pull rod 963 can drive, through the third driving pin 9642, the positioning member 961 to move. Specifically, when the pull rod 963 moves along a direction D7, the third driving pin 9642 is driven to move along the direction D6 through insert-fit between the second driving groove 9634 and the third driving pin 9642, thereby driving the positioning member 961 to move along the third sliding groove 9651 (i.e., the direction D6).

As shown in FIG. 91, the length adjustment mechanism elastic member 9641 is arranged between the guide base 965 and the pull rod 963, and the length adjustment mechanism elastic member 9641 is adapted to bias the pull rod 963, so that the positioning member 961 is held at the extend position. The length adjustment mechanism elastic member 9641 may be an elastic member such as a spring or an elastic sheet. In this embodiment, the length adjustment mechanism elastic member 9641 is a spring. The guide base 965 is provided with an accommodating groove 9655. Referring to FIG. 93 together, the pull rod 963 has an abutting portion 9637, and the abutting portion 9637 is arranged between the two second side plates 9635 and is connected to the two second side plates 9635. The abutting portion 9637 is arranged opposite to the second connecting plate 9636. The second connecting plate 9636 is located outside the accommodating groove 9655, and the abutting portion 9637 is at least partially accommodated in the accommodating groove 9655 to connect the length adjustment mechanism elastic member 9641. A groove wall of the accommodating groove 9655 is provided with a third protrusion 9656. The third protrusion 9656 is arranged opposite to the abutting portion 9637. The length adjustment mechanism elastic member 9641 has one end abutting against the abutting portion 9637 and the other end abutting against the third protrusion 9656.

A length adjustment process of the movable assembly 900 in this embodiment is specifically described below.

When there is a need to adjust a length of the movable assembly 900, as shown in FIG. 92, the pull handle 962 is pulled upwards along the direction D7, the pull handle 962 simultaneously drives the pull rod 963 to move upwards along the direction D7, and the length adjustment mechanism elastic member 9641 is compressed. Referring to FIG. 90 and FIG. 91 together, next, the pull rod 963 drives the positioning member 961 to move right along the D6 direction through the fit between the second driving groove 9634 and the third driving pin 9642. When the positioning member 961 moves until the positioning portion 9612 is disengaged from one positioning hole 912, the length adjustment mechanism 960 is unlocked, and the adjustment portion 921 is movable relative to the connecting arm 910. In this case, an overall length of the movable assembly 900 may be adjusted by moving the adjustment portion 921 relative to the connecting arm 910.

When the adjustment portion 921 moves to be opposite to another positioning hole 912 as required, a pressing force on the pull handle 962 can be canceled, and pull rod 963 moves downwards along the direction D7 under an elastic force of the length adjustment mechanism elastic member 9641. At the same time, through the fit between the second driving groove 9634 and the third driving pin 9642, the pull rod 963 causes the positioning member 961 to move left along the direction D6 until the positioning portion 9612 is reinserted into another positioning hole 912, so that the adjustment portion 921 is re-locked with the connecting arm 910. At the same time, the pull rod 963 also drives the pull handle 962 to move downwards the direction D7 and be reset.

The infant carrier in this embodiment has at least the following beneficial effects.

Through the switching of the frame 200 between the folded state and the unfolded state, the infant carrier can switch between the stroller and the safety seat, and which has a simple switching structure and is easy to operate. When the infant carrier is switched from the stroller to the safety seat, an angle between the seat 110 and the base 300 remains unchanged, so that the seat 110 can approach the base 300 smoothly and has good stability. Moreover, when the frame 200 is in the folded state, the infant carrier as a whole may be used as the safety seat without removing the seat assembly 100, which is simple to operate and easy to carry.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and the description thereof is specific and detailed, but cannot therefore be understood as a limitation on the patent scope of the invention. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

1. An infant carrier, comprising:
a seat assembly;
a frame having an unfolded state and a folded state, the frame being attached to the seat assembly; and
a switching mechanism arranged between the seat assembly and the frame and enabling the frame to switch between the unfolded state and the folded state,
wherein when the frame is in the unfolded state, the infant carrier is suitable for use as a baby stroller, and when the frame is in the folded state, the infant carrier is suitable for use as a safety seat, a carry cot, or a baby rocker.

2. The infant carrier of claim 1, wherein the switching mechanism comprises:
a linkage assembly connected between the frame and the seat assembly; and
a locking assembly operable to switch between a locked state and an unlocked state, wherein when the locking assembly is in the locked state, the frame is locked in the unfolded state, and when the locking assembly is in the unlocked state, the frame is linked to switch from the unfolded state to the folded state through the linkage assembly.

3. The infant carrier of claim 1, wherein the frame comprises a first support frame and a second support frame pivotally connected to each other, and the switching mechanism comprises a linkage assembly, the linkage assembly comprising a first linkage rod and a second linkage rod, two ends of the first linkage rod being pivotally connected to the first support frame and the seat assembly respectively, and two ends of the second linkage rod being pivotally connected to the second support frame and the seat assembly respectively.

4. The infant carrier of claim 1, wherein the switching mechanism comprises a locking assembly, the locking assembly comprising:
a first locking member movably connected to one of the seat assembly and the frame and configured to lock the frame in the unfolded state; and
a fold button connected to the other of the seat assembly and the frame and operable to drive the first locking member to unlock the frame.

5. The infant carrier of claim 4, wherein the frame comprises:
a first support frame comprising two first support rods; and
a second support frame comprising two second support rods,
wherein the two first support rods are pivotally connected to the two second support rods respectively, each of the first support rods is pivotally connected to each of the second support rods at a first pivot point, the first pivot point is slidably connected to the seat assembly, and the fold button is attached to the first pivot point.

6. The infant carrier of claim 4, wherein the locking assembly further comprises a holder fastened to the seat assembly, the holder having a second accommodating cavity and an open groove in communication with the second accommodating cavity, the first locking member has a locking protrusion, the first locking member is at least partially movably arranged in the second accommodating cavity, and the locking protrusion is capable of extending out of the second accommodating cavity through the open groove to be engaged and locked with the fold button to lock the frame in the unfolded state.

7. The infant carrier of claim 6, wherein the first locking member is pivotally connected to the holder at a second pivot point located in the second accommodating cavity.

8. The infant carrier of claim 7, wherein the first locking member further comprises an elastic arm, the locking protrusion and the elastic arm are located on two sides of the second pivot point respectively, and the elastic arm constantly causes the locking protrusion to pivot in a direction of extension out of the open groove.

9. The infant carrier of claim 1, wherein the frame comprises:
a first support frame comprising two first support rods; and
a second support frame comprising two second support rods;
wherein the two first support rods are pivotally connected to the two second support rods respectively.

10. The infant carrier of claim 9, further comprising:
a wheel body, the wheel body being rotatably attached to the first support frame and the second support frame respectively,
wherein each of the first support rods is pivotally connected to each of the second support rods at a first pivot point, and when the frame is in the folded state, a line connecting a center of the wheel body and the first pivot point is parallel to a horizontal reference plane, the horizontal reference plane being an imaginary horizontal section at the bottom of the seat assembly.

11. The infant carrier of claim 9, wherein each of the first support rods is pivotally connected to each of the second support rods at a first pivot point, when the frame is in the unfolded state, the first pivot point is at a first position of the seat assembly, and when the frame is in the folded state, the first pivot point is at a second position of the seat assembly.

12. The infant carrier of claim 11, wherein the first position is closer to a horizontal reference plane or a vertical reference plane than the second position, the horizontal reference plane being an imaginary horizontal section at the bottom of the seat assembly, the vertical reference plane being an imaginary vertical section at the front of the seat assembly.

13. The infant carrier of claim 1, wherein the seat assembly has a fold limiting part, and when the frame is in the folded state, the fold limiting part is engaged with the frame to lock the frame in the folded state.

14. The infant carrier of claim 1, further comprising a movable assembly mounted on the seat assembly, when the frame is in the unfolded state, the movable assembly serving as a handlebar, and when the frame is in the folded state, the movable assembly serving as a carrying handle.

15-16. (canceled)

17. The infant carrier of claim 14, further comprising an angle adjustment mechanism arranged between the seat assembly and the movable assembly, and configured to adjust an inclination angle of the movable assembly relative to the seat assembly.

18. The infant carrier of claim 17, wherein the angle adjustment mechanism comprises:
a movable connecting base fixedly connected to the movable assembly and having a first locking part;
a seat connecting base fixedly connected to the seat assembly and having a second locking part; and
a third locking part movably arranged between the movable connecting base and the seat connecting base, and having a second lock position and a second unlock position,
wherein the movable connecting base and the seat connecting base are pivotally connected to each other,
wherein when the third locking part is at the second lock position, the third locking part is locked and engaged with both the first locking part and the second locking part, so that the movable connecting base and the seat connecting base are fixed relative to each other, and
wherein when the third locking part is at the second unlock position, the third locking part is disengaged from one of the first locking part and the second locking part, so that the movable connecting base is rotatable relative to the seat connecting base.

19. The infant carrier of claim 1, further comprising:
a wheel assembly comprising a wheel mounting frame and a wheel body, the wheel mounting frame being connected to the frame, and the wheel body being rotatably mounted on the wheel mounting frame; and
a braking mechanism arranged between the frame and the wheel assembly and having a braking state where rotation of the wheel assembly is prevented and an unbraking state where rotation of the wheel assembly is allowed.

20. The infant carrier of claim 19, wherein the braking mechanism comprises:
a brake rod movably arranged on the frame and having a third lock position and a third unlock position,
wherein the wheel body is circumferentially provided with a plurality of first brake holes, when the brake rod is at the third lock position, the brake rod is capable of being inserted into and engaged with one of the plurality of first brake holes, and when the brake rod is at the third unlock position, the brake rod is disengaged from the one of the plurality of first brake holes.

21. The infant carrier of claim 20, wherein the braking mechanism further comprises:
a brake operating member movably arranged on the frame; and
a brake pushing member movably arranged on the frame and fixedly connected to the brake rod,
wherein the brake operating member is operable to drive the brake pushing member to drive the brake rod to move to the third unlock position.

22. The infant carrier of claim 21, wherein the frame comprises a first connecting assembly connected to the wheel mounting frame, the brake operating member being rotatably arranged on the first connecting assembly, and the brake pushing member is movably arranged on the first connecting assembly.

23-50. (canceled)
